(19) United States
(12) Patent Application Publication
(10) Pub. No.: US 2026/0317229 A1
(43) Pub. Date: Oct. 15, 2026

(54) STRENGTHENED GLASS PLATE, STRENGTHENED GLASS PLATE PRODUCTION METHOD, AND GLASS PLATE TO BE STRENGTHENED

(71) Applicant: NIPPON ELECTRIC GLASS CO., LTD., Shiga (JP)

(72) Inventors: Yuta NAGANO, Shiga (JP); Ken YUKI, Shiga (JP); Hikaru IKEDA, Shiga (JP); Satoshi ARAI, Shiga (JP); Yusuke SHIMIZU, Shiga (JP)

(21) Appl. No.: 19/101,331

(22) PCT Filed: Aug. 18, 2023
(86) PCT No.: PCT/JP2023/029900

§ 371 Date: Feb. 5, 2025

(30) Foreign Application Priority Data
Aug. 24, 2022 (JP) 2022-133307
Sep. 26, 2022 (JP) 2022-152060
Nov. 16, 2022 (JP) 2022-183100

(51) Int. Cl. C03C 21/00; C03C 3/085

(52) U.S. Cl. CPC C03C 21/002; C03C 3/085

(57) ABSTRACT

The present invention provides a tempered glass sheet including as a glass composition, in terms of mol %, 50% to 85% of SiO₂, 1% to 25% of Al₂O₃, 0% to 15% of B₂O₃, 0% to 20% of Li₂O, 0% to 25% of Na₂O, 0% to 20% of K₂O, 0% to 10% of ZnO, 0% to 15% of P₂O₅, 0% to 10% of ZrO₂, and 0% to 0.30% of SnO₂, having a value of [Li₂O]+[Na₂O] of from 1% to 30%, having a value of [Li₂O]+[MgO] of from 1% to 25%, and having a value of [MgO]+[CaO]+[SrO]+[BaO] of from 0.5% to 30%.

### TECHNICAL FIELD

The present invention relates to a tempered glass sheet and a method of manufacturing the same, and more particularly, to a tempered glass sheet suitable as a cover glass for a touch panel display of a cellular phone, a digital camera, a personal digital assistant (PDA), or the like, a method of manufacturing a tempered glass sheet, and a glass sheet to be tempered.

### BACKGROUND ART

In applications, such as a cellular phone (in particular, a smartphone), a digital camera, and a personal digital assistant (PDA), a tempered glass sheet obtained through ion exchange treatment is used as a cover glass for a touch panel display (see Patent Literature 1).

The cover glass is required to have, for example, the following characteristics: (1) high mechanical strength; (2) high transparency; and (3) low manufacturing costs. The mechanical strength refers to strength characteristics of glass determined by the mechanical characteristics and tempered characteristics of the glass. Here, the mechanical characteristics refer to characteristics related to the strength of glass determined mainly by glass composition, and an example thereof is a fracture toughness value. In addition, the tempered characteristics refer to characteristics related to the strength of glass imparted afterwards through ion exchange treatment of the glass after forming thereof, and an example thereof is a compressive stress value of a glass surface.

The tempered glass sheet obtained through ion exchange treatment has a compressive stress layer in a surface thereof, and is hence characterized in that the formation and propagation of cracks in the surface are easily suppressed (see Patent Literature 1).

However, the related-art tempered glass sheet as disclosed in Patent Literature 1 tends to have low mechanical characteristics such as fracture toughness, and thus the mechanical strength is hardly improved.

In addition, in recent years, use of crystallized glass subjected to ion exchange treatment as a cover glass has been investigated (see Patent Literature 2). The crystallized glass includes crystals and thus has high mechanical characteristics. Accordingly, tempered crystallized glass has high mechanical strength.

### CITATION LIST

Patent Literature 1: JP 2006-83045 A
Patent Literature 2: WO 2019/230889 A1

### SUMMARY OF INVENTION

### Technical Problem

However, crystallized glass includes crystals, and thus the transmittance thereof is more liable to be reduced than that of amorphous glass. When the crystallized glass is used as a cover glass, the visibility and color developability of a display may be degraded.

In addition, the crystallized glass requires heat treatment at high temperature and thus has a problem in that the manufacturing costs are liable to be increased.

The present invention has been made in view of the above-mentioned circumstances, and a technical object of the present invention is to provide: a tempered glass sheet, which has higher mechanical strength than that of the related-art amorphous tempered glass sheet even without crystallization treatment, that is, even when the tempered glass sheet is free of a crystalline material, and which has a higher transmittance than that of a crystallized and chemically tempered glass sheet; a method of manufacturing the tempered glass sheet at low manufacturing costs; and a glass sheet to be tempered.

### Solution to Problem

According to one embodiment of the present invention, there is provided a tempered glass sheet having a compressive stress layer in a surface thereof, the tempered glass sheet comprising as a glass composition, in terms of mol %, 50% to 80% of SiO₂, 1% to 25% of Al₂O₃, 0% to 15% of B₂O₃, 0% to 20% of Li₂O, 0% to 25% of Na₂O, 0% to 20% of K₂O, 0% to 10% of ZnO, 0% to 15% of P₂O₅, 0% to 10% of ZrO₂, and 0% to 0.30% of SnO₂, having a value of [Li₂O]+[Na₂O] of from 1% to 30%, having a value of [Li₂O]+[MgO] of from 1% to 25%, and having a value of [MgO]+[CaO]+[SrO]+[BaO] of from 0.5% to 30%. Herein, the “[Li₂O]+[Na₂O]” refers to the total content of Li₂O and Na₂O, the “[Li₂O]+[MgO]” refers to the total content of Li₂O and MgO, and the “[MgO]+[CaO]+[SrO]+[BaO]” refers to the total content of MgO, CaO, SrO, and BaO.

It is preferred that the tempered glass sheet according to the embodiment of the present invention be a tempered glass sheet having a compressive stress layer in a surface thereof, the tempered glass sheet comprising as a glass composition, in terms of mol %, 52% to 80% of SiO₂, 11.5% to 25% of Al₂O₃, 0% to 15% of B₂O₃, 7% to 20% of Li₂O, 0.5% to 25% of Na₂O, 0% to 20% of K₂O, 0% to 20% of MgO, 0% to 10% of CaO, 0% to 10% of SrO, 0% to 10% of BaO, 0% to 10% of ZnO, 0% to 15% of P₂O₅, 0% to 10% of ZrO₂, and 0% to 0.30% of SnO₂, and having a value of [MgO]+[CaO]+[SrO]+[BaO] of from 6.5% to 30%.

With the above-mentioned configuration, the strain point, Vickers hardness, Young's modulus, and fracture toughness of the tempered glass sheet are easily increased.

In addition, it is preferred that the tempered glass sheet according to the embodiment of the present invention comprise MgO as the glass composition and have a content of MgO of from 6.5 mol % to 20 mol %.

With the above-mentioned configuration, a viscosity at high temperature is reduced to improve meltability and formability, and the strain point, the Vickers hardness, the Young's modulus, and the fracture toughness are easily increased.

In addition, it is preferred that the tempered glass sheet according to the embodiment of the present invention have a molar ratio [RO]/[R₂O] of from 0.5 to 1.5. Herein, the “[RO]” refers to the total content of alkaline earth metal oxides ([MgO]+[CaO]+[SrO]+[BaO]), and the “[R₂O]” refers to the total content of alkali metal oxides ([Li₂O]+[Na₂O]+[K₂O]). Accordingly, the molar ratio “[RO]/[R₂O]” refers to a value obtained by dividing the total content of alkaline earth metal oxides by the total content of alkali metal oxides.

With the above-mentioned configuration, the formability, devitrification resistance, and mechanical characteristics are easily improved.

In addition, it is preferred that the tempered glass sheet according to the embodiment of the present invention be substantially free of crystals and have a transmittance of 85% or more at a wavelength of 400 nm in terms of a thickness of 0.6 mm. Herein, the phrase “substantially free of” refers to a state in which the content of crystals in the tempered glass sheet is 0.01 mass % or less.

With the above-mentioned configuration, glass having high visibility and high color developability is easily obtained.

In addition, it is preferred that the tempered glass sheet according to the embodiment of the present invention have a Young's modulus of 76 GPa or more.

With the above-mentioned configuration, when the thickness of the tempered glass sheet is small, a cover glass is less liable to be deflected.

In addition, it is preferred that the tempered glass sheet according to the embodiment of the present invention have a fracture toughness K1c of 0.78 MPa·m^{0.5} or more.

With the above-mentioned configuration, the tempered glass sheet which is less liable to undergo self-destruction or which is less liable to be pulverized explosively at the time of destruction can be obtained.

In addition, it is preferred that the tempered glass sheet according to the embodiment of the present invention have a sheet shape having a thickness of from 0.01 mm to 2.0 mm, a compressive stress value CS of the compressive stress layer on an outermost surface be from 200 MPa to 1,200 MPa, and a depth of compression DOC of the compressive stress layer be from 3 μm to 200 μm. Herein, the terms “compressive stress value on an outermost surface” and “depth of compression” each refer to, for example, a value measured from a retardation distribution curve observed with a scattered light photoelastic stress meter SLP-2000 (manufactured by Orihara Industrial Co., Ltd.) in the case where the compressive stress is attributed to a Na ion introduced through ion exchange, or a value measured from a retardation distribution curve observed with a surface stress meter FSM-6000 (manufactured by Orihara Industrial Co., Ltd.) in the case where the compressive stress is attributed to a K ion introduced through ion exchange. Moreover, the term “depth of compression” refers to a depth at which the stress value becomes zero. In calculation of the stress characteristics of each sample, a refractive index and a photoelastic constant were used. A value measured by a V-block method was used as the refractive index. A value measured by optical heterodyne interferometry was used as the photoelastic constant.

With the above-mentioned configuration, a tempered glass sheet having high strength is easily obtained.

In addition, it is preferred that the tempered glass sheet according to the embodiment of the present invention have a sheet shape having a thickness of from 0.35 mm to 2.0 mm, the depth of compression DOC of the compressive stress layer be from 50 μm to 170 μm, and a compressive stress value CS30 of the compressive stress layer at a depth of 30 μm from the outermost surface be from 25 MPa to 400 MPa.

With the above-mentioned configuration, a tempered glass sheet that is less liable to be broken at the time of dropping is obtained.

In addition, it is preferred that the tempered glass sheet according to the embodiment of the present invention have a temperature at a viscosity at high temperature of 10^{2.5} dPa·s of 1,680° C. or less. Herein, the “temperature at a viscosity at high temperature of 10^{2.5} dPa·s” may be measured, for example, by a platinum sphere pull up method.

With the above-mentioned configuration, molten glass is easily formed into a sheet shape.

In addition, it is preferred that the tempered glass sheet according to the embodiment of the present invention comprise Cl as the glass composition and have a content of Cl of 0.02 mol % or more.

With the above-mentioned configuration, a bubble diameter in molten glass is easily expanded, and a high fining effect is obtained.

In addition, it is preferred that the tempered glass sheet according to the embodiment of the present invention comprise MoO₃ as the glass composition and have a content of MoO₃ of 0.0001 mol % or more.

With the above-mentioned configuration, the tempered glass sheet easily absorbs UV light, and deterioration of an element in a device caused by UV light can be suppressed.

In addition, it is preferred that the tempered glass sheet according to the embodiment of the present invention be a tempered glass sheet having a compressive stress layer in a surface thereof, the tempered glass sheet comprising as a glass composition, in terms of mol %, 60% to 70% of SiO₂, 3% to 20% of Al₂O₃, 0% to 1% of B₂O₃, 0% to 10% of Li₂O, 10% to 25% of Na₂O, 0% to 5% of K₂O, 5% to 20% of MgO, 0% to 1% of CaO, 0% to 10% of SrO, 0% to 10% of BaO, 0% to 10% of ZnO, and 0% to 4.7% of P₂O₅, and having a value of [MgO]+[CaO]+[SrO]+[BaO] of from 5% to 30%.

With the above-mentioned configuration, reduction in liquidus viscosity of the tempered glass sheet is easily suppressed.

In addition, it is preferred that the tempered glass sheet according to the embodiment of the present invention be a tempered glass sheet having a compressive stress layer in a surface thereof, the tempered glass sheet comprising as a glass composition, in terms of mol %, 65% to 82% of SiO₂, 5% to 16% of Al₂O₃, 0% to 10% of B₂O₃, 0% to 10% of Li₂O, 5% to 25% of Na₂O, 0% to 5% of K₂O, 0% to 10% of MgO, 0% to 6% of CaO, 0% to 5% of SrO, 0% to 5% of BaO, 0% to 10% of ZnO, and 0% to 4.7% of P₂O₅, having a value of [Li₂O]+[Na₂O] of from 5% to 20%, and having a value of [MgO]+[CaO]+[SrO]+[BaO] of from 1% to 10%.

With the above-mentioned configuration, a tempered glass sheet having high acid resistance, in particular, high hydrofluoric acid resistance is easily obtained. In addition, with improved acid resistance, when a tempered glass sheet is subjected to chemical etching treatment, for example, a surface of the tempered glass sheet can be brought into a state in which fine irregularities are reduced. As a result, the strength of the tempered glass sheet can be increased.

In addition, according to one embodiment of the present invention, there is provided a method of manufacturing a tempered glass sheet, comprising: a preparation step of preparing a glass sheet to be tempered including as a glass composition, in terms of mol %, 50% to 80% of SiO₂, 1% to 25% of Al₂O₃, 0% to 15% of B₂O₃, 0% to 20% of Li₂O, 0% to 25% of Na₂O, 0% to 20% of K₂O, 0% to 10% of ZnO, 0% to 15% of P₂O₅, 0% to 10% of ZrO₂, and 0% to 0.30% of SnO₂, having a value of [Li₂O]+[Na₂O] of from 1% to 30%, having a value of [Li₂O]+[MgO] of from 1% to 25%, and having a value of [MgO]+[CaO]+[SrO]+[BaO] of from 0.5% to 30%; and an ion exchange step of subjecting the glass sheet to be tempered to ion exchange treatment to provide a tempered glass sheet having a compressive stress layer in a surface thereof.

In addition, according to one embodiment of the present invention, there is provided a glass sheet to be tempered, comprising as a glass composition, in terms of mol %, 50% to 80% of SiO₂, 1% to 25% of Al₂O₃, 0% to 15% of B₂O₃, 0% to 20% of Li₂O, 0% to 25% of Na₂O, 0% to 20% of K₂O, 0% to 10% of ZnO, 0% to 15% of P₂O₅, 0% to 10% of ZrO₂, and 0% to 0.30% of SnO₂, having a value of [Li₂O]+[Na₂O] of from 1% to 30%, having a value or [Li₂O]+[MgO] of from 1% to 25%, and having a value of [MgO]+[CaO]+[SrO]+[BaO] of from 0.5% to 30%.

### Advantageous Effects of Invention

According to the present invention, the tempered glass sheet, which has mechanical strength and transmittance suitable for a cover glass, the method of manufacturing a tempered glass sheet, and the glass sheet to be tempered can be provided.

### BRIEF DESCRIPTION OF DRAWINGS

FIG. 1 is a schematic view for illustrating a stress profile of a tempered glass sheet obtained through ion exchange between a Li ion and a Na ion in a molten salt (stress distribution of the glass sheet in a thickness direction).

### DESCRIPTION OF EMBODIMENTS

A tempered glass sheet and a glass sheet to be tempered of the present invention each comprise as a glass composition, in terms of mol %, 50% to 80% of SiO₂, 1 to 25% of Al₂O₃, 0% to 15% of B₂O₃, 0% to 20% of Li₂O, 0% to 25% of Na₂O, 0% to 20% of K₂O, 0% to 10% of ZnO, 0% to 15% of P₂O₅, 0% to 10% of ZrO₂, and 0% to 0.30% of SnO₂, have a value of [Li₂O]+[Na₂O] of from 1% to 30%, have a value of [Li₂O]+[MgO] of from 1% to 25%, and have a value of [MgO]+[CaO]+[SrO]+[BaO] of from 0.5% to 30%. Reasons why the content ranges of the components are restricted are described below. In the description of the content range of each component, the expression “%” means “mol %” unless otherwise specified.

SiO₂ is a component that forms a glass network. When the content of SiO₂ is too small, vitrification does not occur easily, and a thermal expansion coefficient becomes too high, with the result that thermal shock resistance is liable to be reduced. In addition, hydrofluoric acid resistance may be reduced. Accordingly, a suitable lower limit range of the content of SiO₂ is 50% or more, 52% or more, 55% or more, 57% or more, 58% or more, 58.5% or more, 59% or more, 60% or more, 61% or more, 62% or more, 62.5% or more, 63% or more, 63.5% or more, 64.0% or more, or 64.5% or more, particularly 65% or more. Meanwhile, when the content of SiO₂ is too large, meltability and formability are liable to be reduced. In addition, the thermal expansion coefficient is excessively reduced, with the result that it becomes difficult to match the thermal expansion coefficient with those of peripheral materials. Accordingly, a suitable upper limit range of the content of SiO₂ is 85% or less, 82% or less, 80% or less, 75% or less, 73% or less, 72% or less, 71% or less, 70.5% or less, 70% or less, 69.5% or less, 69% or less, 68.5% or less, 68% or less, 67.8% or less, 67.5% or less, or 67.2% or less, particularly 67% or less.

Al₂O₃ is a component that improves ion exchange performance, and is also a component that increases a strain point, a Young's modulus, fracture toughness, and a Vickers hardness. Accordingly, a suitable lower limit range of the content of Al₂O₃ is 1% or more, 3% or more, 5% or more, 7% or more, 7.2% or more, 7.5% or more, 7.8% or more, 8% or more, 8.2% or more, 8.5% or more, 9% or more, 9.2% or more, 9.4% or more, 9.5% or more, 9.8% or more, 10.0% or more, 10.3% or more, 10.5% or more, 10.8% or more, 11% or more, 11.2% or more, 11.4% or more, 11.5% or more, 11.6% or more, 11.7% or more, or 11.8% or more, particularly 12% or more. Meanwhile, when the content of Al₂O₃ is too large, a viscosity at high temperature is increased, with the result that the meltability and the formability are liable to be reduced. In addition, a devitrified crystal is liable to be precipitated in glass, and it becomes difficult to form the glass into a sheet shape by an overflow down-draw method or the like. Particularly when the glass is formed into a sheet shape by an overflow down-draw method involving using alumina-based refractory as forming body refractory, a devitrified crystal of spinel is liable to be precipitated at an interface with the alumina-based refractory. Further, acid resistance is reduced, with the result that it becomes difficult to subject the glass to an acid treatment step. Accordingly, a suitable upper limit range of the content of Al₂O₃ is 25% or less, 23% or less, 21% or less, 20.5% or less, 20% or less, 19.8% or less, 19.5% or less, 19.0% or less, 18.5% or less, 18% or less, 17.5% or less, 17% or less, 16.5% or less, 16% or less, 15.5% or less, 15.2% or less, 15% or less, 14.9% or less, 14.7% or less, 14.5% or less, 14.3% or less, 14% or less, or 13.5% or less, particularly 13% or less.

B₂O₃ is a component that reduces the viscosity at high temperature and a density, and stabilizes the glass to cause less precipitation of a crystal, to thereby reduce a liquidus temperature. Further, B₂O₃ is a component that increases an oxygen electron constraint force exhibited by a cation to reduce the basicity of the glass. When the content of B₂O₃ is too small, a depth of compression DOC obtained through ion exchange between a Li ion in the glass and a Na ion in a molten salt is excessively increased, with the result that a compressive stress value at a predetermined depth (from 5 μm to 50 μm) from the outermost surface is liable to be reduced. In addition, the glass may become unstable, and devitrification resistance may be reduced. In addition, the basicity of the glass is excessively increased, and the release amount of 02 through a reaction of a fining agent is reduced to reduce foamability, with the result that bubbles may remain in the glass when the glass is formed into a sheet shape. Accordingly, a suitable lower limit range of the content of B₂O₃ is 0% or more, 0.10% or more, 0.15% or more, 0.20% or more, 0.30% or more, 0.4% or more, 0.5% or more, 0.6% or more, 0.7% or more, 0.8% or more, 0.9% or more, 1% or more, 1.5% or more, 2% or more, 2.5% or more, 3% or more, 3.5%, or more, or 4% or more, particularly 4.5% or more. Meanwhile, when the content of B₂O₃ is too large, the efficiency of ion exchange between a Li ion in the glass and a Na ion in the molten salt is liable to be reduced, the diffusion of the Na ion is liable to be reduced, and the depth of compression may be reduced. In addition, the Young's modulus and the fracture toughness are reduced, and self-destruction or explosive pulverization at the time of destruction may be liable to occur. Accordingly, a suitable upper limit range of the content of B₂O₃ is 15% or less, 14.5% or less, 14% or less, 13.5% or less, 13% or less, 12.5% or less, 12% or less, 11.5% or less, 11% or less, 10.5%, 10% or less, 9.5% or less, 9% or less, 8.5% or less, 8% or less, 7.5% or less, 7% or less, 6.5% or less, or 6% or less, particularly 5.5% or less. When increases in Young's modulus and fracture toughness are regarded as important, a suitable content of B₂O₃ is from 0% to 1% or from 0% to 0.8%, particularly from 0% to 0.5%.

Li₂O is an ion exchange component, and is particularly a component effective in obtaining a large depth of compression through ion exchange between a Li ion in the glass and a Na ion in the molten salt. In addition, Li₂O is a component that reduces the viscosity at high temperature to improve the meltability and the formability, and is also a component that increases the Young's modulus. Accordingly, a suitable lower limit range of the content of Li₂O is 0% or more, 1% or more, 1.5% or more, 2% or more, 2.5% or more, 3% or more, 3.5% or more, 4% or more, 4.3% or more, 4.5% or more, 4.7% or more, 5% or more, 5.2 or more, 5.5% or more, 5.8% or more, 6.2% or more, 6.5% or more, 6.8% or more, 7.0% or more, or 7.5% or more, particularly 8% or more. Meanwhile, when the content of Li₂O is too large, the liquidus temperature is increased, a devitrified crystal is liable to be precipitated in the glass, and it becomes difficult to form the glass into a sheet shape by an overflow down-draw method or the like. Accordingly, a suitable upper limit range of the content of Li₂O is 20% or less, 18% or less, 17% or less, 15% or less, 13% or less, 12% or less, 11.5% or less, 11% or less, 10.5% or less, 10% or less, 9.8% or less, 9.5% or less, 9.3% or less, 9% or less, or 8.8% or less, particularly 8.5% or less.

Na₂O is an ion exchange component, and is also a component that reduces the viscosity at high temperature to improve the meltability and the formability. In addition, Na₂O is a component that improves the devitrification resistance, and is particularly a component that suppresses devitrification caused by a reaction with alumina-based refractory. Accordingly, a suitable lower limit range of the content of Na₂O is 0% or more, 0.1% or more, 0.2% or more, 0.3% or more, 0.5% or more, 0.7% or more, 0.8% or more, 1% or more, 1.2% or more, 1.3% or more, 1.4% or more, 1.5% or more, 1.8% or more, 2% or more, 2.1% or more, 2.2% or more, 2.3% or more, 2.5% or more, or 2.8% or more, particularly 3% or more. Meanwhile, when the content of Na₂O is too large, the thermal expansion coefficient is excessively increased, and the thermal shock resistance is liable to be reduced. In addition, the glass composition loses its component balance, and the devitrification resistance may be reduced contrarily. Accordingly, a suitable upper limit range of the content of Na₂O is 25% or less, 21% or less, 20% or less, 19% or less, 18% or less, 15% or less, 13% or less, 11% or less, 10% or less, 9% or less, 8% or less, 7.5% or less, 7% or less, 6.5% or less, 6% or less, 5.8% or less, 5.5% or less, or 5.2% or less, particularly 5% or less. When the ion exchange between a Na ion in the glass and a K ion in the molten salt is regarded as important, a suitable lower limit range of the content of Na₂O is 5% or more, 6% or more, 7% or more, 8% or more, or 9% or more, particularly 10% or more.

K₂O is a component that reduces the viscosity at high temperature to improve the meltability and the formability. Further, K₂O is a component that increases the depth of compression. Accordingly, a suitable lower limit range of the content of K₂O is 0% or more, 0.01% or more, 0.02% or more, 0.03% or more, 0.05% or more, 0.08% or more, 0.1% or more, 0.2% or more, 0.3% or more, or 0.4% or more, particularly 0.5% or more. Meanwhile, when the content of K₂O is too large, the thermal expansion coefficient may be increased, and the thermal shock resistance may be reduced. In addition, a compressive stress value on the outermost surface is liable to be reduced. Accordingly, a suitable upper limit range of the content of K₂O is 20% or less, 18% or less, 15% or less, 12% or less, 10% or less, 7% or less, 6% or less, 5% or less, 4% or less, 3% or less, 2% or less, 1.5% or less, or 1% or less, particularly less than 1%.

MgO is a component that reduces the viscosity at high temperature to improve the meltability and the formability, and increases the strain point, the Vickers hardness, the Young's modulus, and the fracture toughness. Among alkaline earth metal oxides, MgO is a component that has a high improving effect on the ion exchange performance. Accordingly, a suitable lower limit range of the content of MgO is 0% or more, 0.1% or more, 0.5% or more, 1% or more, 1.5% or more, 2% or more, 2.5% or more, 3% or more, 3.5% or more, 4% or more, 4.5% or more, 5% or more, 5.2% or more, 5.5% or more, 5.8% or more, 6% or more, 6.1% or more, 6.2% or more, 6.3% or more, or 6.4% or more, particularly 6.5% or more. Meanwhile, when the content of MgO is too large, the devitrification resistance is liable to be reduced. In particular, it becomes difficult to suppress devitrification caused by a reaction with alumina-based refractory. Accordingly, a suitable upper limit range of the content of MgO is 20%, or less, 19% or less, 18% or less, 17% or less, 16% or less, 15% or less, 14% or less, 13% or less, 12% or less, 11% or less, 10.8% or less, 10.5% or less, 10.4% or less, 10.3% or less, 10.2% or less, or 10.1% or less, particularly 10% or less.

CaO is a component that reduces the viscosity at high temperature to improve the meltability and the formability without reducing the devitrification resistance as compared to other components, and increases the strain point and the Vickers hardness. However, when the content of CaO is too large, the ion exchange performance may be reduced, or an ion exchange solution may be degraded at the time of ion exchange treatment. Accordingly, the content of CaO is preferably from 0% to 12%, from 0% to 10%, from 0% to 9%, from 0% to 8%, from 0% to 7%, from 0% to 6%, from 0% to 5.5%, from 0% to 5%, from 0% to 4.5%, from 0% to 4%, from 0% to 3.5%, from 0% to 3%, or from 0% to 2%, particularly preferably from 0% to 1%.

SrO is a component that reduces the viscosity at high temperature to improve the meltability and the formability, and increases the strain point and the Young's modulus. However, when the content of SrO is too large, an ion exchange reaction is liable to be inhibited. Besides, the density or the thermal expansion coefficient is increased inappropriately, or the glass is liable to devitrify. Accordingly, the content of SrO is preferably from 0% to 12%, from 0% to 10%, from 0% to 9%, from 0% to 8%, from 0% to 7%, from 0% to 6%, from 0% to 5%, from 0% to 4%, from 0% to 3%, from 0% to 2%, or from 0% to 1.5%, particularly preferably from 0% to 1%.

BaO is a component that reduces the viscosity at high temperature to improve the meltability and the formability, and increases the strain point and the Young's modulus. However, when the content of BaO is too large, the ion exchange reaction is liable to be inhibited. Besides, the density or the thermal expansion coefficient is increased inappropriately, or the glass is liable to devitrify. Accordingly, the content of BaO is preferably from 0% to 12%, from 0% to 10%, from 0% to 9%, from 0% to 8%, from 0% to 7%, from 0% to 6%, from 0% to 5%, from 0% to 4%, from 0% to 3%, from 0% to 2%, or from 0% to 1.5%, particularly preferably from 0% to 1%.

ZnO is a component that improves the ion exchange performance, and is particularly a component that has a high increasing effect on the compressive stress value of the compressive stress layer on the outermost surface. In addition, ZnO is a component that reduces the viscosity at high temperature without significantly reducing a viscosity at low temperature. Meanwhile, when the content of ZnO is too large, there is a tendency that the glass undergoes phase separation, the devitrification resistance is reduced, the density is increased, or the depth of compression is reduced. Accordingly, a suitable upper limit range of the content of ZnO is 10% or less, 8% or less, 7% or less, 6% or less, 5.5% or less, 5.2% or less, 5% or less, or 4.5% or less, particularly 4% or less. A suitable lower limit range of the content of ZnO is 0% or more, 0.1% or more, 0.2% or more, 0.3% or more, 0.4% or more, 0.5% or more, 0.7% or more, 1% or more, 1.1% or more, 1.2% or more, 1.5% or more, 1.8% or more, 2.0% or more, 2.1% or more, 2.2% or more, 2.5% or more, 2.8% or more, 3.0% or more, 3.1% or more, or 3.2% or more, particularly 3.5% or more.

P₂O₅ is a component that improves the ion exchange performance, and is particularly a component that increases the depth of compression. Further, P₂O₅ is a component that improves the acid resistance. Further, P₂O₅ is a component that increases the oxygen electron constraint force exhibited by a cation to reduce the basicity of the glass. However, when the content of P₂O₅ is too large, the glass undergoes phase separation, and water resistance is liable to be reduced. In addition, the depth of compression obtained through ion exchange between a Li ion in the glass and a Na ion in the molten salt is excessively increased, with the result that the compressive stress value at a predetermined depth (from 5 μm to 50 μm) from the outermost surface is liable to be reduced. Accordingly, a suitable upper limit range of the content of P₂O₅ is 15% or less, 12% or less, 10% or less, 8% or less, 7% or less, 6% or less, 5% or less, 4.7% or less, 4.5% or less, or 4% or less, particularly 3.5% or less. Meanwhile, when the content of P₂O₅ is too small, the ion exchange performance may not be sufficiently exhibited. In addition, the glass may become unstable, and the devitrification resistance may be reduced. In addition, the basicity of the glass is excessively increased, and the release amount of O₂ through a reaction of a fining agent is reduced to reduce the foamability, with the result that bubbles may remain in the glass when the glass is formed into a sheet shape. Accordingly, a suitable lower limit range of the content of P₂O₅ is 0% or more, 0.01% or more, 0.02% or more, 0.03% or more, or 0.05% or more, particularly 0.1% or more.

SnO₂ is a fining agent, and is also a component that improves the ion exchange performance. However, when the content of SnO₂ is too large, the devitrification resistance is liable to be reduced. Accordingly, a suitable lower limit range of the content of SnO₂ is 0% or more, 0.001% or more, 0.002% or more, 0.005% or more, or 0.007% or more, particularly 0.010% or more, and a suitable upper limit range thereof is 0.30% or less, 0.27% or less, 0.25% or less, 0.20% or less, 0.18% or less, 0.15% or less, 0.12% or less, 0.10% or less, 0.09% or less, 0.08% or less, 0.07% or less, 0.06% or less, 0.05% or less, 0.047% or less, 0.045% or less, 0.042% or less, 0.040% or less, 0.038% or less, 0.035% or less, 0.032% or less, 0.030% or less, 0.025% or less, or 0.020% or less, particularly 0.015% or less.

Cl is a fining agent. Particularly when Cl is used in combination with SnO₂, a bubble diameter in the glass is easily expanded, and a fining effect is easily exhibited. Meanwhile, Cl is a component that adversely affects an environment or a facility when the content thereof is too large. Accordingly, a suitable lower limit range of the content of Cl is 0.001% or more, 0.005% or more, 0.008% or more, 0.010% or more, 0.015% or more, 0.018% or more, 0.019% or more, 0.020% or more, 0.023% or more, 0.025% or more, 0.027% or more, 0.030% or more, 0.035% or more, 0.040% or more, 0.050% or more, 0.07% or more, or 0.09% or more, particularly 0.10% or more, and a suitable upper limit range thereof is 0.3% or less, 0.2% or less, 0.17% or less, or 0.15% or less, particularly 0.12% or less. When the content of Cl is too small, the content of SnO₂ needs to be increased to ensure a desired fining property, and thus the devitrification resistance may be reduced.

MoO₃ is a component that absorbs UV light (light at a wavelength of from 200 nm to 300 nm). When MoO₃ is incorporated into the glass, an internal element of a device using the tempered glass sheet of the present invention as a cover glass can be prevented from being degraded by UV light. In addition, MoO₃ may be incorporated by adding a trace amount thereof to a raw material batch, but when a raw material batch is melted through electric melting heating, MoO₃ may be incorporated by being eluted from a Mo electrode. The use of electric melting can reduce the amount of water in the glass. When the amount of water in the glass is reduced, the liquidus viscosity and the softening point are increased, and the devitrification resistance and heat resistance of the glass can be improved. In addition, when the strain point is increased, stress relaxation is less liable to occur, and a high compressive stress value can be maintained. When the content of MoO₃ is too small, it becomes difficult to incorporate MoO₃ through electric melting. Accordingly, a suitable lower limit range of the content of MoO₃ is, in terms of mol %, 0% or more, 0.0001% or more, 0.0003% or more, 0.0005% or more, 0.0008% or more, 0.001% or more, 0.0012% or more, or 0.0015% or more, particularly 0.002% or more. Meanwhile, when the content of MoO₃ is too large, the transmittance of a cover glass is liable to be reduced. Accordingly, a suitable upper limit range of the content of MoO₃ is, in terms of mol %, 0.02% or less, 0.018% or less, 0.015% or less, 0.012% or less, 0.01% or less, 0.008% or less, 0.007% or less, 0.006% or less, or 0.005% or less, particularly less than 0.004%.

A suitable lower limit range of the value of [Li₂O]+[Na₂O], which represents the total content of Li₂O and Na₂O, is 1% or more, 3% or more, 5% or more, 6% or more, 7% or more, 7.5% or more, 8% or more, 8.5% or more, 8.8% or more, 93 or more, 9.5% or more, or 9.7% or more, particularly 10% or more. When the value of [Li₂O]+[Na₂O] is too small, it becomes difficult to perform ion exchange. Meanwhile, when the value of [Li₂O]+[Na₂O] is too large, chemical resistance may be reduced. A suitable upper limit range of the value of [Li₂O]+[Na₂O] is 30% or less, 28% or less, 25% or less, or 23% or less, particularly 20% or less.

A suitable lower limit range of the value of [Li₂O]+[MgO], which represents the total content of Li₂O and MgO, is 1% or more, 3% or more, 5% or more, 6% or more, 7% or more, 7.5% or more, 8% or more, 8.5% or more, 8.8% or more, 9% or more, 9.5% or more, or 9.7% or more, particularly 10% or more. When the value of [Li₂O]+[MgO] is too small, the mechanical characteristics, such as the Young's modulus and the fracture toughness, are hardly increased. In addition, the viscosity at high temperature is increased, and the meltability or the formability may be reduced. Meanwhile, when the value of [Li₂O]+[MgO] is too large, the devitrification resistance may be reduced. A suitable upper limit range of the value of [Li₂O]+[MgO] is 25% or less, 23% or less, or 20% or less, particularly 18% or less.

A suitable lower limit range of the value of [MgO]+[CaO]+[SrO]+[BaO], which represents the total content of MgO, CaO, SrO, and BaO, is 0.5% or more, 0.6% or more, 0.7% or more, 0.8% or more, 0.9% or more, 1% or more, 1.5% or more, 2% or more, 3% or more, 3.5% or more, 4% or more, 4.5% or more, 5% or more, 6% or more, 6.5% or more, 7% or more, or 7.5% or more, particularly 8% or more. When the value of [MgO]+[CaO]+[SrO]+[BaO] is too small, the strain point, the Vickers hardness, the Young's modulus, and the fracture toughness are hardly increased. In addition, the viscosity at high temperature is increased, and the meltability and the formability may be reduced. Meanwhile, when the value of [MgO]+[CaO]+[SrO]+[BaO] is too large, the devitrification resistance may be reduced. Accordingly, a suitable upper limit range of the value of [MgO]+[CaO]+[SrO]+[BaO] is 30% or less, 28% or less, 25% or less, 24% or less, 22% or less, 20% or less, 18% or less, 15% or less, or 12% or less, particularly 10% or less.

A suitable lower limit range of the value of [B₂O₃]+[MgO]+[CaO], which represents the total content of B₂O₃, MgO, and CaO, is 0.1% or more, 0.5% or more, 0.8%, or more, 1% or more, 2% or more, 3% or more, 3.5% or more, 4% or more, 5% or more, 6% or more, or 6.5% or more, particularly 7% or more. When the value of [B₂O₃]+[MgO]+[CaO] is too small, it is difficult to reduce the softening point. Meanwhile, when the value of [B₂O₃]+[MgO]+[CaO] is too large, the glass may become unstable, and the devitrification resistance may be reduced. Accordingly, a suitable upper limit range of the value of [B₂O₃]+[MgO]+[CaO] is 30% or less, 28% or less, 25% or less, 24% or less, 22% or less, or 20%, or less, particularly 18% or less.

A suitable lower limit range of the value of [Li₂O]+[Na₂O]+[K₂O], which represents the total content of Li₂O, Na₂O, and K₂O, is 7% or more, 7.5% or more, 8% or more, 8.5% or more, 8.8% or more, 9% or more, 9.5%, or more, or 9.7% or more, particularly 10% or more. When the value of [Li₂O]+[Na₂O]-+[K₂O] is too small, the efficiency of ion exchange is liable to be reduced, and it is difficult to reduce the softening point. Meanwhile, when the value of [Li₂O]+[Na₂O]+[K₂O] is too large, the chemical resistance may be reduced. A suitable upper limit range of the value of [Li₂O]+[Na₂O]+[K₂O] is 30% or less, 28% or less, 25% or less, 23% or less, or 20% or less, particularly 18% or less.

A suitable lower limit range of the molar ratio [R₂O]/[Al₂O₃] is 0.6 or more, 0.65 or more, 0.7 or more, 0.75 or more, or 0.8 or more, particularly 0.85 or more. When the molar ratio [R₂O]/[Al₂O₃] is too small, the efficiency of ion exchange is liable to be reduced. Meanwhile, also when the molar ratio [R₂O]/[Al₂O₃] is too large, the efficiency of ion exchange is liable to be reduced. Accordingly, a suitable upper limit range of the molar ratio [R₂O]/[Al₂O₃] is 2 or less, 1.9 or less, 1.8 or less, 1.7 or less, 1.6 or less, 1.5 or less, or 1.4 or less, particularly 1.3 or less. The molar ratio “[R₂O]/[Al₂O₃]” refers to a value obtained by dividing [R₂O], which represents the total content of Li₂O, Na₂O, and K₂O, by the content of Al₂O₃.

A suitable lower limit range of the molar ratio [RO]/[R₂O] is 0.5 or more, 0.52 or more, 0.55 or more, 0.58 or more, 0.6 or more, 0.62 or more, 0.65 or more, 0.68 or more, 0.70 or more, 0.72 or more, 0.75 or more, or 0.78 or more, particularly 0.8 or more. When the molar ratio [RO]/[R₂O] is too small, the strain point, the Vickers hardness, the Young's modulus, and the fracture toughness may be reduced. Meanwhile, when the molar ratio [RO]/[R₂O] is too large, the devitrification resistance and the efficiency of ion exchange are liable to be reduced, and it is difficult to reduce the softening point. Accordingly, a suitable upper limit range of the molar ratio [RO]/[R₂O] is 1.5 or less, 1.3 or less, 1.2 or less, or 1.1 or less, particularly 1 or less.

A suitable upper limit range of the molar ratio [Al₂O₃]/([R₂O]+[RO]) is 1.5 or less, 1.4 or less, 1.3 or less, 1.2 or less, 1.1 or less, or 1 or less, particularly 0.9 or less. When the molar ratio [Al₂O₃]/([R₂O]+[RO]) is too large, the viscosity at high temperature is increased, with the result that the meltability and the formability are liable to be reduced. Meanwhile, when the molar ratio [Al₂O₃]/([R₂O]+[RO]) is too small, the liquidus temperature and the liquidus viscosity may be reduced. Accordingly, a suitable lower limit range of the molar ratio [Al₂O₃]/([R₂O]+[RO]) is 0.2 or more, 0.25 or more, 0.3 or more, or 0.35 or more, particularly 0.4 or more. The molar ratio [Al₂O]/([R₂O]+[RO]) refers to a value obtained by dividing the content of Al₂O₃ by the total of [RO], which represents the total content of MgO, CaO, SrO, and BaO, and [R₂O], which represents the total content of Li₂O, Na₂O, and K₂O.

A suitable upper limit range of the molar ratio [Na₂O]/[Li₂O] is 1.0 or less, 0.9 or less, 0.8 or less, 0.7 or less, 0.65 or less, 0.6 or less, 0.58 or less, 0.55 or less, 0.52 or less, 0.5 or less, 0.48 or less, 0.45 or less, or 0.43 or less, particularly 0.4 or less. When the molar ratio [Na₂O]/[Li₂O] is too large, the efficiency of ion exchange between a Li ion in the glass and a Na ion in the molten salt is liable to be reduced. Meanwhile, when the molar ratio [Na₂O]/[Li₂O] is too small, the viscosity at high temperature is increased, and the meltability and the formability may be reduced. In addition, the devitrification resistance is liable to be reduced. The molar ratio [Na₂O]/[Li₂O] is preferably 0 or more, 0.03 or more, 0.05 or more, 0.07 or more, 0.10 or more, 0.15 or more, or 0.18 or more, particularly preferably 0.2 or more. The molar ratio [Na₂O]/[Li₂O] refers to a value obtained by dividing the content of Na₂O by the content of Li₂O.

A suitable lower limit range of the molar ratio ([ZnO]+[Li₂O]+[Na₂O]+[K₂O])/[Al₂O₃] is 0.5 or more, 0.55 or more, 0.60 or more, 0.7 or more, 0.75 or more, or 0.8 or more, particularly 0.85 or more. When the molar ratio ([ZnO]+[Li₂O]+[Na₂O]+[K₂O])/[Al₂O₃] is too small, the efficiency of ion exchange is liable to be reduced, and it is difficult to reduce the softening point. Meanwhile, also when the molar ratio ([ZnO]+[Li₂O]+[Na₂O]+[K₂O])/[Al₂O₃] is too large, the efficiency of ion exchange is liable to be reduced. Accordingly, a suitable upper limit range of the molar ratio ([ZnO]+[Li₂O]+[Na₂O]+[K₂O])/[Al₂O₃] is 2 or less, 1.8 or less, 1.9 or less, 1.8 or less, 1.7 or less, 1.6 or less, 1.5 or less, 1.4 or less, 1.35 or less, or 1.3 or less, particularly 1.25 or less. The molar ratio ([ZnO]+[Li₂O]+[Na₂O]+[K₂O])/[Al₂O₃] refers to a value obtained by dividing the total content of ZnO, Li₂O, Na₂O, and K₂O by the content of Al₂O₃.

The molar ratio [MgO]/[Al₂O₃] is preferably 1.2 or less, 1.1 or less, 1.05 or less, 1.0 or less, 0.95 or less, 0.9 or less, 0.85 or less, 0.8 or less, 0.75 or less, 0.7 or less, or 0.6 or less, particularly preferably 0.5 or less. When the molar ratio [MgO]/[Al₂O₃] is too large, reaction stones are liable to be generated at the time of contact with a forming body (particularly, an alumina forming body) at high temperature, with the result that the quality of the glass formed into a sheet shape may be reduced. Meanwhile, the lower limit of the molar ratio [MgO]/[Al₂O₃] is not particularly limited, but is, for example, 0 or more, 0.01 or more, 0.03 or more, or 0.05 or more. The molar ratio [MgO]/[Al₂O₃] refers to a value obtained by dividing the content of MgO by the content of Al₂O₃.

When the range of the molar ratio ([SiO₂]+[B₂O₃]+[P₂O₅])/((100×[SnO₂])×([Li₂O]+[Na₂O]+[K₂O]+[MgO]+[CaO]+[BaO]+[SrO]+[ZnO]+[Al₂O₃])) is restricted, the devitrification resistance can be improved while the fining property is improved. A suitable lower limit range of the molar ratio ([SiO₂]+[B₂O₃]+[P₂O₅])/(100×[SnO₂])×([Li₂O]+[Na₂O]+[K₂O]+[MgO]+[CaO]+[BaO]+[SrO]+[ZnO]+[Al₂O₃])) is 0.30 or more, 0.33 or more, 0.35 or more, 0.37 or more, 0.38 or more, 0.39 or more, 0.40 or more, 0.41 or more, 0.42 or more, 0.43 or more, 0.44 or more, 0.45 or more, 0.48 or more, 0.50 or more, 0.51 or more, 0.52 or more, 0.53 or more, or 0.54 or more, particularly 0.55 or more. When the molar ratio ([SiO₂]+[B₂O₃]+[P₂O₅])/((100× [SnO₂])×([Li₂O]+[Na₂O]+[K₂O]+[MgO]+[CaO]+[BaO]+[SrO]+[ZnO]+[Al₂O₃])) is too small, a SnO₂ crystal is liable to be precipitated. An upper limit range of the molar ratio ([SiO₂]+[B₂O₃]+[P₂O₅])/((100×[SnO₂])×([Li₂O]+[Na₂O]+[K₂O]+[MgO]+[CaO]+[BaO]+[SrO]+[ZnO]+[Al₂O₃])) is not particularly limited, but is, for example, 4.0 or less, 3.0 or less, 2.0 or less, 1.5 or less, or 1.0 or less. The molar ratio ([SiO₂]+[B₂O₃]+[P₂O₅])/((100×[SnO₂])×([Al₂O₃]+[Li₂O]+[Na₂O]+[K₂O]+[MgO]+[CaO]+[BaO]+[SrO]+[ZnO])) refers to a value obtained by dividing the total content of SiO₂, B₂O₃, and P₂O₅ by a value obtained by multiplying 100 times the content of SnO₂ and the total content of Al₂O₃, Li₂O, Na₂O, K₂O, MgO, CaO, BaO, SrO, and ZnO together.

A suitable lower limit range of ([SiO₂]+1.2×[P₂O₅]-3×[Al₂O₃]—[B₂O₃]-2× [Li₂O]-1.5×[Na₂O]—[K₂O]) is −20 or more, −18 or more, −15 or more, −12 or more, −10 or more, −8 or more, −5 or more, or −3 or more, particularly 0 or more. When the value of ([SiO₂]+1.2×[P₂O₅]-3× [Al₂O₃]— [B₂O₃]-2×[Li₂O]-1.5×[Na₂O]— [K₂O]) is too small, the acid resistance is liable to be reduced. Meanwhile, when the value of ([SiO₂]+1.2×[P₂O₅]-3×[Al₂O₃]—[B₂O₃]-2×[Li₂O]-1.5×[Na₂O]—[K₂O]) is too large, the ion exchange performance may not be sufficiently exhibited. Accordingly, a suitable upper limit range of ([SiO₂]+1.2×[P₂O₅]-3×[Al₂O₃]—[B₂O]-2×[Li₂O]-1.5×[Na₂O]—[K₂O]) is 50 or less, 45 or less, 40 or less, 35 or less, 30 or less, or 25 or less, particularly 20 or less. The value of ([SiO₂]+1.2×[P₂O₅]-3×[Al₂O₃]—[B₂O₃]-2×[Li₂O]-1.5×[Na₂O]—[K₂O]) refers to a value obtained by subtracting the total of 3 times the content of Al₂O₃, the content of B₂O₃, 2 times the content of Li₂O, 1.5 times the content of Na₂O, and the content of K₂O from the total of the content of SiO₂ and 1.2 times the content of P₂O₅.

An X value calculated by the following equation is a factor correlated to an exchange speed between a Li ion and a Na ion. When the X value is too small, the efficiency of ion exchange between a Li ion and a Na ion in the molten salt is reduced, and it becomes difficult to produce a compressive stress. In particular, the depth of compression (DOC) of the compressive stress layer obtained through ion exchange between a Li ion in the glass and a Na ion in the molten salt may be reduced. Accordingly, a suitable lower limit range of the X value is 300 or more, 320 or more, 330 or more, 340 or more, 350 or more, 400 or more, 450 or more, 460 or more, 480 or more, 500 or more, or 520 or more, particularly 550 or more. An upper limit range of the X value is not particularly limited, but is, for example, 850 or less or 800 or less.

$$X = - 1.49 \times [ {SiO}_{2} ] + 26.98 \times [ {Al}_{2} {O}_{3} ] - 3.23 \times [ {B}_{2} {O}_{3} ] + 48.56 \times [ {Li}_{2} O ] - 24.31 \times [ {Na}_{2} O ] - 0.28 \times [ MgO ] + 2.74 \times [ CaO ]$$

A W value calculated by the following equation is a factor correlated to the Young's modulus. When the W value is too small, the Young's modulus is reduced, and the glass is liable to be broken. Accordingly, a suitable lower limit range of the W value is 250 or more, 300 or more, 330 or more, 340 or more, 350 or more, 360 or more, 370 or more, 400 or more, 430 or more, 450 or more, or 480 or more, particularly 500 or more. An upper limit range of the W value is not particularly limited, but is, for example, 750 or less or 700 or less.

$$W = 0.07 \times [ {SiO}_{2} ] + 18.17 \times [ {Al}_{2} {O}_{3} ] - 4.42 \times [ {B}_{2} {O}_{3} ] + 41.43 \times [ {Li}_{2} O ] - 29.3 \times [ {Na}_{2} O ] + 1.43 \times [ MgO ] - 10.43 \times [ CaO ]$$

For example, the following components may be added in addition to the above-mentioned components.

TiO₂ is a component that improves the ion exchange performance, and is also a component that reduces the viscosity at high temperature. However, when the content of TiO₂ is too large, transparency and the devitrification resistance are liable to be reduced. Accordingly, a suitable content of TiO₂ is from 0% to 10%, from 0% to 5%, from 0% to 3%, from 0% to 1.5%, from 0% to 1%, or from 0% to 0.1%, particularly from 0.001 mol % to 0.1 mol %.

ZrO₂ is a component that increases the Vickers hardness, and is also a component that increases viscosity around the liquidus viscosity and the strain point. However, when the content of ZrO₂ is too large, the devitrification resistance may be significantly reduced. Accordingly, a suitable content of ZrO₂ is from 0% to 10%, from 0% to 5%, from 0% to 3%, from 0% to 1.5%, from 0% to 1%, from 0% to 0.5%, from 0% to 0.4%, from 0% to 0.3%, or from 0% to 0.2%, particularly from 0% to 0.1%.

Fe₂O₃ is an impurity that is mixed in from raw materials. A suitable upper limit range of the content of Fe₂O₃ is, in terms of mol %, 0.1% or less, 0.08% or less, 0.05% or less, 0.02% or less, less than 0.015%, less than 0.01%, or less than 0.008%, particularly less than 0.005%. When the content of Fe₂O₃ is too large, the transmittance of a cover glass is liable to be reduced. Meanwhile, a suitable lower limit range of the content of Fe₂O₃ is, in terms of mol %, 0.001% or more, 0.002% or more, or 0.003% or more. When the content of Fe₂O₃ is too small, raw material costs rise owing to the use of high-purity raw materials, and a product cannot be manufactured inexpensively.

As a fining agent, SO₃ and/or CeO₂ may be added at from 0.001% to 1%.

Rare earth oxides, such as Nd₂O₃, La₂O₃, Y₂O₃, Nb₂O₅, Ta₂O₅, and Hf₂O₃, are each a component that increases the Young's modulus. However, raw material costs therefor are high. In addition, when the rare earth oxides are each added in a large amount, the devitrification resistance is liable to be reduced. Accordingly, a suitable content of the rare earth oxides is 5% or less, 4% or less, 3% or less, 2% or less, 1% or less, or 0.5% or less, particularly from 0% to 0.1%.

The tempered glass sheet (glass sheet to be tempered) of the present invention is preferably substantially free of As₂O₃, Sb₂O₃, PbO, and F as a glass composition from the standpoint of environmental considerations. In addition, the glass sheet is preferably substantially free of Bi₂O₃ from the standpoint of environmental considerations. In the glass composition of each of the tempered glass sheet and glass sheet to be tempered of the present invention, the phrase “substantially free of” has a concept in which the explicit component is not positively added as a glass component, but its addition at an impurity level is permitted, and specifically refers to a case in which the content of the explicit component is less than 0.05 mol %.

The tempered glass sheet (glass sheet to be tempered) of the present invention preferably has the following characteristics.

A density (ρ) is preferably 2.9 g/cm³ or less, 2.85 g/cm³ or less, 2.83 g/cm³ or less, 2.8 g/cm³ or less, 2.75 g/cm³ or less, 2.7 g/cm³ or less, or from 2.35 g/cm³ to 2.65 g/cm³, particularly preferably from 2.25 g/cm³ to 2.6 g/cm³. As the density becomes lower, the weight of the tempered glass sheet can be reduced more.

A thermal expansion coefficient at from 30° C. to 380° C. is preferably 150×10⁻⁷/° C. or less, 100×10⁻⁷/° C. or less, or from 50×10⁻⁷/° C. to 95×10⁻⁷/° C., particularly preferably from 40×10⁻⁷/° C. to 85×10⁻⁷/° C. The term “thermal expansion coefficient at from 30° C. to 380° C.” refers to a value measured for an average thermal expansion coefficient with a dilatometer.

A softening point (Ts) is preferably 920° C. or less, 910° C. or less, 900° C. or less, 890° C. or less, 880° C. or less, 870° C. or less, 860° C. or less, 850° C. or less, 840° C. or less, or 830° C. or less, particularly preferably from 700° C. to 820° C. When the softening point is too high, thermal processability may be reduced.

A temperature at a viscosity at high temperature of 10^{2.5} dPa·s is preferably 1,680° C. or less, 1,670° C. or less, 1,660° C. or less, 1,650° C. or less, 1,640° C. or less, 1,630° C. or less, 1,620° C. or less, 1,600° C. or less, 1,550° C. or less, 1,520° C. or less, or 1,500° C. or less, particularly preferably from 1,300° C. to 1,490° C. When the temperature at a viscosity at high temperature of 10^{2.5} dPa·s is too high, the meltability and the formability are reduced, and it becomes difficult to form molten glass into a sheet shape.

A liquidus viscosity (xi) is preferably 10^{2.8} dPa·s or more, 10^{2.9} dPa·s or more, 10^{3.0} dPa·s or more, 10^{3.1} dPa·s or more, 10^{3.2} dPa·s or more, 10^{3.3} dPa·s or more, 10^{3.4} dPa·s or more, 10^{3.5} dPa·s or more, or 10^{3.55} dPa·s or more, particularly preferably 10^{3.58} dPa·s or more. As the liquidus viscosity becomes higher, the devitrification resistance is improved more, and devitrified stones are less liable to be generated at the time of forming. The term “liquidus viscosity” as used herein refers to a value measured for a viscosity at a liquidus temperature by a platinum sphere pull up method. The “liquidus temperature” refers to a value obtained by: placing glass powder that has passed through a standard sieve of 30 mesh (500 μm) and remained on a standard sieve of 50 mesh (300 μm) in a platinum boat; keeping the platinum boat in a temperature gradient heating furnace for 24 hours; then removing the platinum boat therefrom; and determining the highest temperature at which devitrification (a devitrified stone) is recognized inside the glass through microscopic observation.

The transmittance of the tempered glass sheet is preferably 85%, or more or 88% or more, particularly preferably 90% or more at a wavelength of 400 nm in terms of a thickness of 0.6 mm. When the transmittance is low, the visibility or color developability of a display using the tempered glass sheet as a cover glass may be reduced. An upper limit range of the transmittance is not particularly limited, but is realistically 100% or less.

In the present invention, the mechanical characteristics refer to characteristics related to the strength of glass determined mainly by the glass composition, and specific examples thereof include characteristics, such as the Young's modulus and the fracture toughness value.

A Young's modulus (E) is preferably 76 GPa or more, 77 GPa or more, 78 GPa or more, 79 GPa or more, or 80 GPa or more, particularly preferably 82 GPa or more. When the Young's modulus is low, a cover glass is liable to be deflected when its sheet thickness is small. In addition, an upper limit range of the Young's modulus is not particularly limited, but is substantially 150 GPa or less. The “Young's modulus” may be calculated by a well-known resonance method.

A fracture toughness K1c is preferably 0.78 MPa·m^{0.5} or more, 0.79 MPa·m^{0.5} or more, 0.80 MPa·m^{0.5} or more, or 0.81 MPa·m^{0.5} or more, particularly preferably 0.82 MPa·m^{0.5} or more. When the fracture toughness K1c is low, the tempered glass sheet is liable to be broken. An upper limit of the fracture toughness K1c is not particularly limited, but is substantially 3 MPa·m^{0.5} or less.

In the present invention, tempered characteristics refer to characteristics related to the strength of glass imparted afterwards through ion exchange treatment of the glass after forming thereof, and specific examples thereof include characteristics, such as a compressive stress value (CS) on the outermost surface of the glass, a compressive stress value (CS30) at a depth of 30 μm from the outermost surface of the glass, a depth of compression (DOC), and an internal tensile stress value (CT_{CV}).

The tempered glass sheet of the present invention has a compressive stress value (CS) on the outermost surface obtained through ion exchange between a Li ion in the glass and a Na ion in the molten salt of preferably 240 MPa or more, 260 MPa or more, 280 MPa or more, 300 MPa or more, 320 MPa or more, 340 MPa or more, 350 MPa or more, 380 MPa or more, 400 MPa or more, or 420 MPa or more, particularly preferably 450 MPa or more. As the compressive stress value (CS) on the outermost surface becomes larger, the strength thereof is increased more. Meanwhile, when an excessively large compressive stress is formed on the surface, the internal tensile stress (CT_{CV}) of the tempered glass sheet is increased excessively, and thus explosive destruction is liable to occur at the time of breaking. In addition, a dimensional change before and after ion exchange treatment may be increased. Accordingly, the compressive stress value (CS) on the outermost surface is preferably 1,200 MPa or less, 1,000 MPa or less, 900 MPa or less, 850 MPa or less, 800 MPa or less, 780 MPa or less, or 750 MPa or less, particularly preferably 740 MPa or less.

The compressive stress value (CS30) at a depth of 30 μm from the outermost surface, which is obtained through ion exchange between a Li ion in the glass and a Na ion in the molten salt, is preferably 25 MPa or more, 30 MPa or more, 35 MPa or more, 40 MPa or more, 50 MPa or more, 60 MPa or more, 70 MPa or more, 80 MPa or more, 90 MPa or more, 100 MPa or more, 105 MPa or more, 110 MPa or more, or 115 MPa or more, particularly preferably 120 MPa or more. As the compressive stress value (CS30) at a depth of 30 μm becomes larger, the strength of the tempered glass sheet is increased more. In addition, “CS30” refers to a characteristic that can effectively improve, in particular, abraded four-point bending strength. Meanwhile, when an excessively large compressive stress is formed at a depth of 30 μm, the internal tensile stress (CT_{CV}) of the tempered glass sheet is increased excessively, and thus explosive destruction is liable to occur at the time of breaking. In addition, a dimensional change before and after ion exchange treatment may be increased. Accordingly, the compressive stress value (CS30) at a depth of 30 μm is preferably 400 MPa or less, 350 MPa or less, 330 MPa or less, 300 MPa or less, 280 MPa or less, 270 MPa or less, or 260 MPa or less, particularly preferably 250 MPa or less.

The depth of compression (DOC), which is obtained through ion exchange between a Li ion in the glass and a Na ion in the molten salt, is preferably 3 μm or more, 5 μm or more, 10 μm or more, 20 μm or more, 25 μm or more, 30 μm or more, 35 μm or more, 40 μm or more, or 45 μm or more, particularly preferably 50 μm or more. As the depth of compression becomes larger, protrusions or sand grains on a road surface are less liable to reach a tensile stress layer at the time of dropping of a smartphone, and thus the breaking probability of the cover glass can be reduced more. Meanwhile, when the depth of compression is too large, a dimensional change before and after ion exchange treatment may be increased. Further, there is a tendency that the compressive stress value on the outermost surface is reduced. Accordingly, the depth of compression (DOC) is preferably 200 μm or less, 180 μm or less, 170 μm or less, 150 μm or less, 140 μm or less, 130 μm or less, 120 μm or less, or 110 μm or less, particularly preferably 100 μm or less. There is a tendency that the depth of compression is increased when the ion exchange time is prolonged, or the temperature of the ion exchange solution is increased.

The internal tensile stress value (CT_{CV}), which is obtained through ion exchange between a Li ion in the glass and a Na ion in the molten salt, is preferably 88 MPa or less, 85 MPa or less, 80 MPa or less, 75 MPa or less, 73 MPa or less, 70 MPa or less, 68 MPa or less, 65 MPa or less, or 62 MPa or less, particularly preferably 60 MPa or less. When the internal tensile stress value is too large, the tempered glass sheet may undergo self-destruction by point-collision, or the glass may be pulverized explosively at the time of destruction. A lower limit range of the internal tensile stress value (CT_{CV}) is not particularly limited, but is substantially 5 MPa or more.

A mass loss of the tempered glass sheet of the present invention per unit surface area when the tempered glass sheet is immersed in a 5 mass % HCl aqueous solution warmed to 80° C. for 24 hours is preferably 2.0 mg/cm² or less, 1.5 mg/cm² or less, 1.0 mg/cm² or less, 0.9 mg/cm² or less, 0.8 mg/cm² or less, 0.7 mg/cm² or less, 0.6 mg/cm² or less, 0.5 mg/cm² or less, 0.4 mg/cm² or less, 0.3 mg/cm² or less, or 0.2 mg/cm² or less, particularly preferably 0.1 mg/cm² or less. The tempered glass sheet may be brought into contact with an acidic chemical solution depending on a usage environment of a device, and hence preferably has high acid resistance from the viewpoint of preventing a failure of the device.

In addition, a mass loss of the tempered glass sheet per unit surface area when the tempered glass sheet is immersed in a 5 mass % NaOH aqueous solution warmed to 80° C. for 6 hours is preferably 5.0 mg/cm² or less, 4.5 mg/cm² or less, 4.0 mg/cm² or less, 3.5 mg/cm² or less, 3.0 mg/cm² or less, 2.5 mg/cm² or less, 2.0 mg/cm² or less, or 1.5 mg/cm² or less, particularly preferably 1.0 mg/cm² or less. The tempered glass sheet may be brought into contact with an alkaline chemical solution or a detergent depending on a usage environment of a device, and is hence required to have high alkali resistance.

In addition, a mass loss of the tempered glass sheet per unit surface area when the tempered glass sheet is immersed in a 10 mass % HF aqueous solution held at 20° C. for 20 minutes is preferably 30 mg/cm² or less, 25 mg/cm² or less, 20 mg/cm² or less, 15 mg/cm² or less, 14 mg/cm² or less, 13 mg/cm² or less, 12 mg/cm² or less, 11 mg/cm² or less, 10.5 mg/cm² or less, 10 mg/cm² or less, 9.5 mg/cm² or less, 9.0 mg/cm² or less, 8.5 mg/cm² or less, 8.0 mg/cm² or less, 7.5 mg/cm² or less, 7.0 mg/cm² or less, 6.5 mg/cm² or less, 6.0 mg/cm² or less, 5.5 mg/cm² or less, 5.0 mg/cm² or less, or 4.5 mg/cm² or less, particularly preferably 4.0 mg/cm² or less. The tempered glass sheet may be subjected to chemical etching treatment for the purpose of adjusting the thickness thereof or modifying a surface state thereof, but even in such case, the tempered glass sheet preferably has high hydrofluoric acid resistance. When the tempered glass sheet has high hydrofluoric acid resistance, a glass surface after the chemical etching treatment can be brought into a state in which fine irregularities are reduced, and thus high strength can be obtained.

In the present invention, the mechanical strength refers to strength characteristics of the glass determined by the mechanical characteristics and tempered characteristics of the glass, and a specific example thereof is abraded four-point bending strength.

The abraded four-point bending strength of the tempered glass sheet of the present invention is preferably 150 MPa or more, 160 MPa or more, 1,170 MPa or more, 180 MPa or more, 190 MPa or more, 200 MPa or more, 220 MPa or more, or 240 MPa or more, particularly preferably 265 MPa or more. When the abraded four-point bending strength is too low, the tempered glass sheet is liable to be broken at the time of dropping when used as a cover glass of a smartphone. The upper limit of the abraded four-point bending strength is not particularly limited, but is realistically 1,500 MPa or less.

The tempered glass sheet of the present invention has a thickness of preferably 2.0 mm or less, 1.5 mm or less, 1.3 mm or less, 1.1 mm or less, 1.0 mm or less, or 0.9 mm or less, particularly preferably 0.85 mm or less. As the thickness becomes smaller, the mass of the tempered glass sheet can be reduced more. Meanwhile, when the thickness is too small, it becomes difficult to obtain desired mechanical strength. Accordingly, the thickness is preferably 0.01 mm or more, 0.02 mm or more, 0.03 mm or more, 0.05 mm or more, 0.1 mm or more, 0.2 mm or more, 0.3 mm or more, 0.35 mm or more, 0.4 mm or more, 0.45 mm or more, 0.5 mm or more, 0.55 mm or more, 0.6 mm or more, or 0.65 mm or more, particularly preferably 0.7 mm or more. The thickness of the glass sheet to be tempered may fall within the same ranges. The thickness of the tempered glass sheet may be selected in accordance with applications. For example, when the tempered glass sheet is used for a non-foldable display, the thickness thereof is preferably from 0.35 mm to 0.85 mm, more preferably from 0.45 mm to 0.75 mm or from 0.51 mm to 0.71 mm. Meanwhile, when the tempered glass sheet is used for a foldable display, the thickness thereof is preferably from 0.01 mm to 0.10 mm, more preferably from 0.02 mm to 0.05 mm or from 0.025 mm to 0.04 mm.

In addition, when high transmittance is regarded as important, the tempered glass sheet of the present invention is preferably substantially free of crystals. Herein, the phrase “substantially free of” means that the content of crystals in the glass is 0.01 mass % or less. Meanwhile, when obtainment of higher mechanical characteristics is regarded as important, the tempered glass sheet may include crystals.

A method of manufacturing a tempered glass sheet of the present invention comprises: a preparation step of preparing a glass sheet to be tempered including as a glass composition, in terms of mol %, 50% to 80% of SiO₂, 1% to 25% of Al₂O₃, 0% to 15% of B₂O₃, 1% to 20% of Li₂O, 0% to 25% of Na₂O, 0% to 20% of K₂O, 0% to 10% of ZnO, 0% to 15% of P₂O₅, 0% to 10% of ZrO₂, and 0% to 0.30% of SnO₂, having a value of [Li₂O]+[Na₂O] of from 1% to 30%, having a value of [Li₂O]+[MgO] of from 1% to 25%, and having a value of [MgO]+[CaO]+[SrO]+[BaO] of from 0.1% to 30%; and an ion exchange step of subjecting the glass sheet to be tempered to ion exchange treatment to provide a tempered glass sheet having a compressive stress layer in a surface thereof. The method of manufacturing a tempered glass sheet of the present invention encompasses not only the case of performing the ion exchange treatment only once, but also the case of performing the ion exchange treatment a plurality of times.

A method of manufacturing the glass sheet to be tempered is, for example, as described below. As a preferred method, first, glass raw materials blended so as to give a desired glass composition are loaded into a continuous melting furnace, are heated to be melted at from 1,400° C. to 1,700° C., and are fined. After that, the molten glass is supplied to a forming apparatus and formed into a sheet shape, followed by cooling. A well-known method may be adopted as a method of cut processing, into predetermined dimensions, the glass having been formed into a sheet shape.

A method of forming the molten glass into a sheet shape is preferably an overflow down-draw method. In the overflow down-draw method, a glass sheet to be obtained has an overflow-merged surface in the central portion thereof in a thickness direction, and a surface to serve as the surface of the glass sheet is not brought into contact with the surface of the forming body refractory, and is formed into a sheet shape in a state of a free surface. Thus, a glass sheet having satisfactory surface quality can be manufactured inexpensively without polishing. Further, in the overflow down-draw method, alumina-based refractory or zirconia-based refractory is used as the forming body refractory. Moreover, the tempered glass sheet (glass sheet to be tempered) of the present invention has satisfactory compatibility with the alumina-based refractory or the zirconia-based refractory (particularly the alumina-based refractory), and hence has a property of hardly generating bubbles, stones, or the like through a reaction with the refractory.

Various forming methods may be adopted in addition to the overflow down-draw method. For example, forming methods, such as a float method, a down-draw method (e.g., a slot down-draw method or a re-draw method), a roll out method, and a press method, may be adopted.

The glass sheet to be tempered and tempered glass sheet of the present invention each include not only a mode of a flat sheet shape, but also a mode of a three-dimensional shape obtained by being formed into a sheet shape and then subjected to bending or the like.

At the time of forming of the molten glass, the molten glass is preferably cooled in a temperature region of from the annealing point of the molten glass to the strain point thereof at a cooling rate of 3° C./min or more and less than 1,000° C./min. A lower limit range of the cooling rate is preferably 10° C./min or more, 20° C./min or more, or 30° C./min or more, particularly preferably 50° C./min or more, and an upper limit range thereof is preferably less than 1,000° C./min or less than 500° C./min, particularly preferably less than 300° C./min. When the cooling rate is too high, the structure of the glass becomes coarse, and it becomes difficult to increase the Vickers hardness after the ion exchange treatment. Meanwhile, when the cooling rate is too low, the production efficiency of the glass sheet is reduced.

In addition, in the method of manufacturing a tempered glass of the present invention, when high transmittance is regarded as important, the glass sheet to be tempered is preferably not crystallized. Meanwhile, when obtainment of higher mechanical characteristics is regarded as important, the glass sheet to be tempered may be subjected to heat treatment for crystallization.

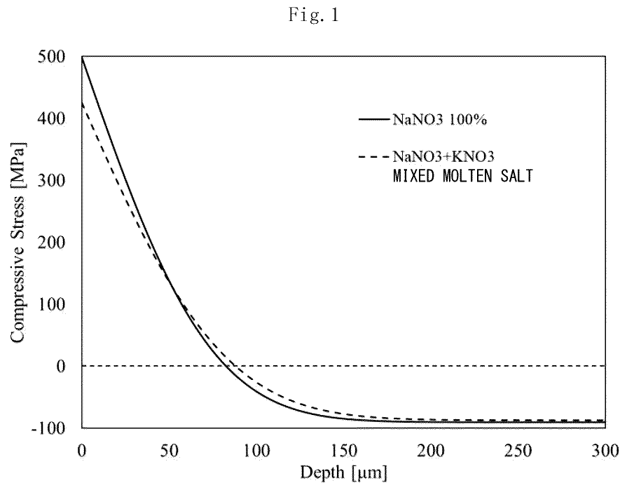

In the method of manufacturing a tempered glass sheet of the present invention, from the viewpoint of suppressing explosive destruction, it is preferred that ion exchange treatment in which the glass sheet to be tempered is immersed in a mixed molten salt of NaNO₃ and KNO₃ once be used. When the ion exchange treatment is performed, the compressive stress value (CS) on the outermost surface and the compressive stress value (CS30) at a depth of 30 μm from the outermost surface can be effectively controlled. Accordingly, the internal tensile stress value (CT_{CV}) of the tempered glass sheet can be prevented from being excessively increased, and a safe tempered glass sheet, which breaks into a small number of broken pieces when dropped, is easily obtained. FIG. 1 is a schematic view of a stress profile of the tempered glass sheet obtained through ion exchange between a Li ion and a Na ion in a molten salt (stress distribution of the glass sheet in a thickness direction). The solid line represents a stress profile of the tempered glass sheet tempered in a tempering molten salt of 100 mass % of NaNO₃, and the dotted line represents a stress profile of the tempered glass sheet tempered in a mixed molten salt including 10 mass % of NaNO₃ and 90 mass % of KNO₃. As apparent from FIG. 1, the tempered glass sheet tempered in 100 mass % of NaNO₃ and represented by the solid line has a CS of 498 MPa, a CS30 of 265 MPa, and a CT_{CV} of 91 MPa, but the tempered glass sheet tempered in a mixed molten salt of NaNO₃ and KNO₃ and represented by the dotted line has a suppressed CS of 425 MPa and a suppressed CS30 of 241 MPa, and as a result, has a small CT_{CV} of 87 MPa.

In the mixed molten salt of NaNO₃ and KNO₃ to be used in the ion exchange step, the concentration of NaNO₃ is preferably 0.5 mass % or more, 1 mass' or more, 5 mass % or more, 7 mass % or more, or 10 mass % or more, particularly preferably from 12 mass %, to 20 mass %. When the concentration of NaNO₃ is too low, measurement of a stress with a surface stress meter SLP-2000 may become difficult. In addition, when the concentration of NaNO₃ is too high, the compressive stress value obtained through ion exchange between a Li ion in the glass and a Na ion in the molten salt may be excessively increased.

When it is prioritized to further increase the compressive stress value (CS) on the outermost surface and the compressive stress value (CS30) at a depth of 30 μm from the outermost surface to provide a more unbreakable tempered glass sheet having high mechanical strength, ion exchange may be performed by immersing the glass sheet to be tempered in a molten salt including 100 mass % of NaNO₃.

In addition, when the glass sheet to be tempered includes Na₂O, ion exchange between a Na ion in glass and a K ion in a molten salt may be performed by immersing the glass sheet to be tempered in a molten salt including 100 mass % of KNOB.

In the ion exchange step, the temperature of the molten salt is preferably from 360° C. to 430° C., and the ion exchange time is preferably from 30 minutes to 6 hours.

### Example 1

The present invention is described below by way of Examples. The following Examples are merely illustrative. The present invention is by no means limited to the following Examples.

### Example 1

The glass compositions and glass characteristics of Examples of the present invention (Samples Nos. 1 to 23 and 26 to 320) and Comparative Examples (Samples Nos. 24 and 25) are shown in Tables 1 to 50. In addition, “N.A.” means not applicable. Further, “R₂O” represents the total content of Li—O, Na₂O, and K₂O, and “RO” represents the total content of MgO, CaO, SrO, and BaO.

TABLE 1

| Component (mol %) | No. 1 | No. 2 | No. 3 | No. 4 | No. 5 | No. 6 | No. 7 | No. 8 | No. 9 | No. 10 | No. 11 | No. 12 | No. 13 |
|---|---|---|---|---|---|---|---|---|---|---|---|---|---|
| SiO₂ | 65.869 | 65.861 | 65.858 | 68.261 | 68.260 | 65.862 | 65.862 | 65.863 | 65.858 | 65.866 | 65.862 | 65.859 | 65.863 |
| Al₂O₃ | 12.0 | 14.4 | 14.4 | 12.0 | 12.0 | 12.0 | 12.0 | 12.0 | 12.0 | 12.0 | 12.0 | 12.0 | 12.0 |
| B₂O₃ | 0.0 | 0.0 | 0.0 | 0.0 | 0.0 | 2.4 | 2.4 | 0.0 | 0.0 | 0.0 | 0.0 | 0.0 | 0.0 |
| Li₂O | 9.6 | 9.6 | 7.2 | 9.6 | 7.2 | 9.6 | 7.2 | 9.6 | 1.2 | 9.6 | 12.0 | 7.2 | 7.2 |
| Na₂O | 2.4 | 0.0 | 2.4 | 0.0 | 2.4 | 0.0 | 2.4 | 4.8 | 2.4 | 0.0 | 0.0 | 4.8 | 2.4 |
| K₂O | 0.0 | 0.0 | 0.0 | 0.0 | 0.0 | 0.0 | 0.0 | 0.0 | 0.0 | 0.0 | 0.0 | 0.0 | 0.0 |
| MgO | 10.0 | 10.0 | 10.0 | 10.0 | 10.0 | 10.0 | 10.0 | 7.6 | 7.6 | 12.4 | 10.0 | 10.0 | 12.4 |
| CaO | 0.0 | 0.0 | 0.0 | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 | 0.0 | 0.0 | 0.0 |
| TiO₂ | 0.000 | 0.002 | 0.002 | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 | 0.0 | 0.0 | 0.0 |
| SnO₂ | 0.03 | 0.03 | 0.03 | 0.03 | 0.03 | 0.03 | 0.03 | 0.03 | 0.03 | 0.03 | 0.03 | 0.03 | 0.03 |
| Y₂O₃ | 0.0 | 0.0 | 0.0 | 0.0 | 0.0 | 0.0 | 0.0 | 0.0 | 0.0 | 0.0 | 0.0 | 0.0 | 0.0 |
| Fe₂O₃ | 0.000 | 0.002 | 0.002 | 0.002 | 0.002 | 0.002 | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 | 0.000 | 0.000 | 0.000 |
| Cl | 0.10 | 0.10 | 0.10 | 0.10 | 0.10 | 0.10 | 0.10 | 0.10 | 0.10 | 0.10 | 0.10 | 0.10 | 0.10 |
| MoO₃ | 0.001 | 0.005 | 0.008 | 0.005 | 0.006 | 0.004 | 0.004 | 0.003 | 0.008 | 0.000 | 0.004 | 0.007 | 0.003 |
| Sb₂O₃ | 0.000 | 0.000 | 0.000 | 0.000 | 0.000 | 0.000 | 0.000 | 0.000 | 0.000 | 0.000 | 0.000 | 0.000 | 0.000 |
| Li₂O + Na₂O | 12.0 | 9.6 | 9.6 | 9.6 | 9.6 | 9.6 | 9.6 | 14.4 | 14.4 | 9.6 | 12.0 | 12.0 | 9.6 |
| Li₂O + MgO | 19.6 | 19.6 | 17.2 | 19.6 | 17.2 | 19.6 | 17.2 | 17.2 | 19.6 | 22.0 | 22.0 | 17.2 | 19.6 |
| RO | 10.0 | 10.0 | 10.0 | 10.0 | 10.0 | 10.0 | 10.0 | 7.6 | 7.6 | 12.4 | 10.0 | 10.0 | 12.4 |
| B₂O₃ + MgO + CaO | 10.0 | 10.0 | 10.0 | 10. | 10.0 | 12.4 | 12.4 | 7.6 | 7.6 | 12.4 | 10.0 | 10.0 | 12.4 |
| R₂O | 12.0 | 9.6 | 9.6 | 9.6 | 9.6 | 9.6 | 9.6 | 14.4 | 14.4 | 9.6 | 12.0 | 12.0 | 9.6 |
| R₂O/Al₂O₃ | 1.0 | 0.7 | 0.7 | 0.8 | 0.8 | 0.8 | 0.8 | 1.2 | 1.2 | 0.8 | 1.0 | 1.0 | 0.8 |
| RO/R₂O | 0.83 | 1.04 | 1.04 | 1.04 | 1.04 | 1.04 | 1.04 | 0.53 | 0.53 | 1.29 | 0.83 | 0.83 | 1.29 |
| Al₂O₃/(R₂O + RO) | 0.55 | 0.73 | 0.73 | 0.61 | 0.61 | 0.61 | 0.61 | 0.55 | 0.55 | 0.55 | 0.55 | 0.55 | 0.55 |
| Na₂O/Li₂O | 0.25 | 0.00 | 0.33 | 0.00 | 0.33 | 0.00 | 0.33 | 0.50 | 0.20 | 0.00 | 0.00 | 0.67 | 0.33 |
| (ZnO + R₂O)/Al₂O₃ | 1.00 | 0.67 | 0.67 | 0.80 | 0.80 | 0.80 | 0.80 | 1.20 | 1.20 | 0.80 | 1.00 | 1.00 | 0.80 |
| MgO/Al₂O₃ | 0.83 | 0.69 | 0.69 | 0.83 | 0.83 | 0.83 | 0.83 | 0.63 | 0.63 | 1.03 | 0.83 | 0.83 | 1.03 |
| (SiO₂ + B₂O₃ + P₂O₃)/ | 0.65 | 0.65 | 0.65 | 0.72 | 0.72 | 0.72 | 0.72 | 0.65 | 0.65 | 0.65 | 0.65 | 0.65 | 0.65 |
| ((100 × SnO₂) × | | | | | | | | | | | | | |
| (R₂O + RO + ZnO + | | | | | | | | | | | | | |
| Al₂O₃)) | | | | | | | | | | | | | |
| SiO₂ + 1.2 × P₂O₅ − | 7.07 | 3.46 | 4.66 | 13.06 | 14.26 | 8.26 | 9.46 | 3.46 | 2.26 | 10.67 | 5.86 | 8.26 | 11.86 |
| 3 × Al₂O₃ − B₂O₃ − | | | | | | | | | | | | | |
| 2 × Li₂O − 1.5 × | | | | | | | | | | | | | |
| Na₂O − K₂O | | | | | | | | | | | | | |
| X | 631 | 754 | 579 | 685 | 511 | 681 | 506 | 573 | 748 | 688 | 806 | 456 | 513 |
| W | 564 | 678 | 509 | 635 | 465 | 624 | 454 | 491 | 660 | 638 | 734 | 395 | 468 |

TABLE 2

| Component (mol %) | No. 14 | No. 15 | No. 16 | No. 17 | No. 18 | No. 19 | No. 20 | No. 21 | No. 22 | No. 23 | No. 24 | No. 25 |
|---|---|---|---|---|---|---|---|---|---|---|---|---|
| SiO₂ | 65.861 | 65.866 | 65.859 | 65.860 | 65.866 | 65.858 | 66.768 | 67.169 | 66.369 | 65.868 | 60.300 | 66.910 |
| Al₂O₃ | 12.0 | 12.0 | 12.0 | 12.0 | 12.0 | 12.0 | 12.0 | 12.0 | 12.4 | 12.5 | 19.0 | 3.0 |
| B₂O₃ | 0.0 | 0.0 | 0.0 | 0.0 | 0.0 | 0.0 | 0.0 | 0.0 | 0.0 | 0.0 | 0.2 | 0.0 |
| Li₂O | 9.6 | 9.6 | 9.6 | 9.6 | 9.6 | 9.6 | 8.7 | 8.8 | 8.7 | 8.8 | 7.2 | 21.3 |
| Na₂O | 2.4 | 2.4 | 2.4 | 2.4 | 2.4 | 2.4 | 2.4 | 2.4 | 2.4 | 2.7 | 8.2 | 2.4 |
| K₂O | 0.0 | 0.0 | 0.0 | 0.0 | 0.0 | 0.0 | 0.0 | 0.0 | 0.0 | 0.0 | 0.4 | 1.4 |
| MgO | 5.0 | 0.0 | 5.0 | 0.0 | 5.0 | 0.0 | 10.0 | 9.5 | 10.0 | 10.0 | 0.3 | 0.0 |
| CaO | 5.0 | 10.0 | 0.0 | 0.0 | 0.0 | 0.0 | 0.0 | 0.0 | 0.0 | 0.0 | 0.0 | 0.0 |
| SrO | 0.0 | 0.0 | 5.0 | 10.0 | 0.0 | 0.0 | 0.0 | 0.0 | 0.0 | 0.0 | 0.0 | 0.0 |
| BaO | 0.0 | 0.0 | 0.0 | 0.0 | 5.0 | 10.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.000 | 0.000 | 0.000 | 0.000 | 0.000 | 0.000 |
| ZrO₂ | 0.0 | 0.0 | 0.0 | 0.0 | 0.0 | 0.0 | 0.0 | 0.0 | 0.0 | 0.0 | 0.0 | 4.2 |
| SnO₂ | 0.03 | 0.03 | 0.03 | 0.03 | 0.03 | 0.03 | 0.03 | 0.03 | 0.03 | 0.03 | 0.05 | 0.00 |
| Y₂O₃ | 0.0 | 0.0 | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.000 | 0.000 | 0.000 | 0.000 | 0.000 | 0.000 |
| P₂O₅ | 0.0 | 0.0 | 0.0 | 0.0 | 0.0 | 0.0 | 0.0 | 0.0 | 0.0 | 0.0 | 4.3 | 0.7 |
| SO₃ | 0.000 | 0.000 | 0.000 | 0.000 | 0.000 | 0.000 | 0.000 | 0.000 | 0.000 | 0.000 | 0.000 | 0.000 |
| Cl | 0.10 | 0.10 | 0.10 | 0.10 | 0.10 | 0.10 | 0.10 | 0.10 | 0.10 | 0.10 | 0.05 | 0.00 |
| MoO₃ | 0.005 | 0.000 | 0.007 | 0.006 | 0.000 | 0.008 | 0.002 | 0.001 | 0.001 | 0.002 | 0.000 | 0.000 |
| Sb₂O₃ | 0.000 | 0.000 | 0.000 | 0.000 | 0.000 | 0.000 | 0.000 | 0.000 | 0.000 | 0.000 | 0.000 | 0.110 |
| Li₂O + Na₂O | 12.0 | 12.0 | 12.0 | 12.0 | 12.0 | 12.0 | 11.1 | 11.2 | 11.1 | 11.5 | 15.4 | 23.7 |
| Li₂O + MgO | 14.6 | 9.6 | 14.6 | 9.6 | 14.6 | 9.6 | 18.7 | 18.3 | 18.7 | 18.8 | 7.5 | 21.3 |
| RO | 10.0 | 10.0 | 10.0 | 10.0 | 10.0 | 10.0 | 10.0 | 9.5 | 10.0 | 10.0 | 0.3 | 0.0 |
| B₂O₃ + MgO + CaO | 10.0 | 10.0 | 5.0 | 0.0 | 5.0 | 0.0 | 10.0 | 9.5 | 10.0 | 10.0 | 0.5 | 0.0 |
| R₂O | 12.0 | 12.0 | 12.0 | 12.0 | 12.0 | 12.0 | 11.1 | 11.2 | 11.1 | 11.5 | 15.8 | 25.0 |
| R₂O/Al₂O₃ | 1.0 | 1.0 | 1.0 | 1.0 | 1.0 | 1.0 | 0.9 | 0.9 | 0.9 | 0.9 | 0.8 | 8.3 |
| RO/R₂O | 0.83 | 0.83 | 0.83 | 0.83 | 0.83 | 0.83 | 0.90 | 0.85 | 0.90 | 0.87 | 0.02 | 0.00 |
| Al₂O₃/(R₂O + RO) | 0.55 | 0.55 | 0.55 | 0.55 | 0.55 | 0.55 | 0.57 | 0.58 | 0.59 | 0.58 | 1.18 | 0.12 |
| Na₂O/Li₂O | 0.25 | 0.25 | 0.25 | 0.25 | 0.25 | 0.25 | 0.28 | 0.27 | 0.28 | 0.31 | 1.14 | 0.11 |
| (ZnO + R₂O)/Al₂O₃ | 1.00 | 1.00 | 1.00 | 1.00 | 1.00 | 1.00 | 0.93 | 0.93 | 0.90 | 0.92 | 0.83 | 8.28 |
| MgO/Al₂O₃ | 0.42 | 0.00 | 0.42 | 0.00 | 0.42 | 0.00 | 0.83 | 0.79 | 0.81 | 0.80 | 0.02 | 0.00 |
| (SiO₂ + B₂O₃ + P₂O₃)/ | 0.65 | 0.65 | 0.65 | 0.65 | 0.65 | 0.65 | 0.67 | 0.68 | 0.66 | 0.65 | 0.10 | — |
| ((100 × SnO₂) × | | | | | | | | | | | | |
| (R₂O + RO + ZnO + | | | | | | | | | | | | |
| Al₂O₃)) | | | | | | | | | | | | |
| SiO₂ + 1.2 × P₂O₅ − | 7.06 | 7.07 | 7.06 | 7.06 | 7.07 | 7.06 | 9.77 | 9.97 | 8.17 | 6.72 | −18.84 | 11.21 |
| 3 × Al₂O₃ − B₂O₃ − | | | | | | | | | | | | |
| 2 × Li₂O − 1.5 × | | | | | | | | | | | | |
| Na₂O − K₂O | | | | | | | | | | | | |
| X | 646 | 661 | 632 | 633 | 632 | 633 | 586 | 590 | 597 | 598 | 572 | 959 |
| W | 505 | 446 | 557 | 550 | 557 | 550 | 527 | 531 | 534 | 532 | 407 | 873 |

TABLE 3

| Component | | | | | | | | | | | | | |
|---|---|---|---|---|---|---|---|---|---|---|---|---|---|
| (mol %) | No. 26 | No. 27 | No. 28 | No. 29 | No. 30 | No. 31 | No. 32 | No. 33 | No. 34 | No. 35 | No. 36 | No. 37 | No. 38 |
| SiO₂ | 66.841 | 66.843 | 66.840 | 66.842 | 66.842 | 66.843 | 66.839 | 66.843 | 66.838 | 66.839 | 64.841 | 64.842 | 64.841 |
| Al₂O₃ | 18.0 | 13.0 | 13.0 | 8.0 | 8.0 | 8.0 | 3.0 | 3.0 | 3.0 | 3.0 | 18.0 | 13.0 | 13.0 |
| B₂O₃ | 0.0 | 0.0 | 0.0 | 0.0 | 0.0 | 0.0 | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 | 0.0 | 0.0 | 0.0 | 0.0 | 0.0 | 0.0 |
| Na₂O | 10.0 | 10.0 | 15.0 | 10.0 | 15.0 | 20.0 | 10.0 | 15.0 | 20.0 | 25.0 | 10.0 | 10.0 | 15.0 |
| K₂O | 0.0 | 0.0 | 0.0 | 0.0 | 0.0 | 0.0 | 0.0 | 0.0 | 0.0 | 0.0 | 2.0 | 2.0 | 2.0 |
| MgO | 5.0 | 10.0 | 5.0 | 15.0 | 10.0 | 5.0 | 20.0 | 15.0 | 10.0 | 5.0 | 5.0 | 10.0 | 5.0 |
| CaO | 0.0 | 0.0 | 0.0 | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 | 0.0 | 0.0 | 0.0 |
| SnO₂ | 0.1 | 0.1 | 0.1 | 0.1 | 0.1 | 0.1 | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 | 0.000 | 0.000 | 0.000 |
| Cl | 0.05 | 0.05 | 0.05 | 0.05 | 0.05 | 0.05 | 0.05 | 0.05 | 0.05 | 0.05 | 0.05 | 0.05 | 0.05 |
| MoO₃ | 0.005 | 0.003 | 0.006 | 0.004 | 0.004 | 0.003 | 0.007 | 0.003 | 0.008 | 0.007 | 0.005 | 0.004 | 0.005 |
| Sb₂O₃ | 0.000 | 0.000 | 0.000 | 0.000 | 0.000 | 0.000 | 0.000 | 0.000 | 0.000 | 0.000 | 0.000 | 0.000 | 0.000 |
| Li₂O + Na₂O | 10.0 | 10.0 | 15.0 | 10.0 | 15.0 | 20.0 | 10.0 | 15.0 | 20.0 | 25.0 | 10.0 | 10.0 | 15.0 |
| Li₂O + MgO | 5.0 | 10.0 | 5.0 | 15.0 | 10.0 | 5.0 | 20.0 | 15.0 | 10.0 | 5.0 | 5.0 | 10.0 | 5.0 |
| RO | 5.0 | 10.0 | 5.0 | 15.0 | 10.0 | 5.0 | 20.0 | 15.0 | 10.0 | 5.0 | 5.0 | 10.0 | 5.0 |
| B₂O₃ + | 5.0 | 10.0 | 5.0 | 15.0 | 10.0 | 5.0 | 20.0 | 15.0 | 10.0 | 5.0 | 5.0 | 10.0 | 5.0 |
| MgO + CaO | | | | | | | | | | | | | |
| R₂O | 10.0 | 10.0 | 15.0 | 10.0 | 15.0 | 20.0 | 10.0 | 15.0 | 20.0 | 25.0 | 12.0 | 12.0 | 17.0 |
| R₂O/Al₂O₃ | 0.6 | 0.8 | 1.2 | 1.3 | 1.9 | 2.5 | 3.3 | 5.0 | 6.7 | 8.3 | 0.7 | 0.9 | 1.3 |
| RO/R₂O | 0.50 | 1.00 | 0.33 | 1.50 | 0.67 | 0.25 | 2.00 | 1.00 | 0.50 | 0.20 | 0.42 | 0.83 | 0.29 |
| Al₂O₃/ | 1.20 | 0.65 | 0.65 | 0.32 | 0.32 | 0.32 | 0.10 | 0.10 | 0.10 | 0.10 | 1.06 | 0.59 | 0.59 |
| (R₂O + RO) | | | | | | | | | | | | | |
| Na₂O/Li₂O | — | — | — | — | — | — | — | — | — | — | — | — | — |
| (ZnO + | 0.56 | 0.77 | 1.15 | 1.25 | 1.88 | 2.50 | 3.33 | 5.00 | 6.67 | 8.33 | 0.67 | 0.92 | 1.31 |
| R₂O)/Al₂O₃ | | | | | | | | | | | | | |
| MgO/Al₂O₃ | 0.28 | 0.77 | 0.38 | 1.88 | 1.25 | 0.63 | 6.67 | 5.00 | 3.33 | 1.67 | 0.28 | 0.77 | 0.38 |
| (SiO₂ + | 0.20 | 0.20 | 0.20 | 0.20 | 0.20 | 0.20 | 0.20 | 0.20 | 0.20 | 0.20 | 0.19 | 0.19 | 0.19 |
| B₂O₃ + | | | | | | | | | | | | | |
| P₂O₃)/ | | | | | | | | | | | | | |
| ((100 × | | | | | | | | | | | | | |
| SnO₂) × | | | | | | | | | | | | | |
| (R₂O + | | | | | | | | | | | | | |
| RO + ZnO + | | | | | | | | | | | | | |
| Al₂O₃)) | | | | | | | | | | | | | |
| SiO₂ + 1.2 × | −2.16 | 12.84 | 5.34 | 27.84 | 20.34 | 12.84 | 42.84 | 35.34 | 27.84 | 20.34 | −6.16 | 8.84 | 1.34 |
| P₂O₅ − 3 × | | | | | | | | | | | | | |
| Al₂O₃ − | | | | | | | | | | | | | |
| B₂O₃ − 2 × | | | | | | | | | | | | | |
| Li₂O − 1.5 × | | | | | | | | | | | | | |
| Na₂O − K₂O | | | | | | | | | | | | | |
| X | 142 | 5 | −115 | −131 | −251 | −371 | −267 | −388 | −508 | −628 | 145 | 8 | −112 |
| W | 46 | −38 | −191 | −122 | −275 | −429 | −205 | −359 | −513 | −666 | 46 | −38 | −192 |

TABLE 4

| Component (mol %) | No. 39 | No. 40 | No. 41 | No. 42 | No. 43 | No. 44 | No. 45 |
|---|---|---|---|---|---|---|---|
| SiO₂ | 64.843 | 64.838 | 64.843 | 64.842 | 64.841 | 64.840 | 64.843 |
| Al₂O₃ | 8.0 | 8.0 | 8.0 | 3.0 | 3.0 | 3.0 | 3.0 |
| B₂O₃ | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 |
| Na₂O | 10.0 | 15.0 | 20.0 | 10.0 | 15.0 | 20.0 | 25.0 |
| K₂O | 2.0 | 2.0 | 2.0 | 2.0 | 2.0 | 2.0 | 2.0 |
| MgO | 15.0 | 10.0 | 5.0 | 20.0 | 15.0 | 10.0 | 5.0 |
| CaO | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 |
| SnO₂ | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 |
| Cl | 0.05 | 0.05 | 0.05 | 0.05 | 0.05 | 0.05 | 0.05 |
| MoO₃ | 0.003 | 0.008 | 0.003 | 0.004 | 0.005 | 0.006 | 0.003 |
| Sb₂O₃ | 0.000 | 0.000 | 0.000 | 0.000 | 0.000 | 0.000 | 0.000 |
| Li₂O + Na₂O | 10.0 | 15.0 | 20.0 | 10.0 | 15.0 | 20.0 | 25.0 |
| Li₂O + MgO | 15.0 | 10.0 | 5.0 | 20.0 | 15.0 | 10.0 | 5.0 |
| RO | 15.0 | 10.0 | 5.0 | 20.0 | 15.0 | 10.0 | 5.0 |
| B₂O₃ + MgO + CaO | 15.0 | 10.0 | 5.0 | 20.0 | 15.0 | 10.0 | 5.0 |
| R₂O | 12.0 | 17.0 | 22.0 | 12.0 | 17.0 | 22.0 | 27.0 |
| R₂O/Al₂O₃ | 1.5 | 2.1 | 2.8 | 4.0 | 5.7 | 7.3 | 9.0 |
| RO/R₂O | 1.25 | 0.59 | 0.23 | 1.67 | 0.88 | 0.45 | 0.19 |
| Al₂O₃/(R₂O + RO) | 0.30 | 0.30 | 0.30 | 0.09 | 0.09 | 0.09 | 0.09 |
| Na₂O/Li₂O | — | — | — | — | — | — | — |
| (ZnO + R₂O)/Al₂O₃ | 1.50 | 2.13 | 2.75 | 4.00 | 5.67 | 7.33 | 9.00 |
| MgO/Al₂O₃ | 1.88 | 1.25 | 0.63 | 6.67 | 5.00 | 3.33 | 1.67 |
| (SiO₂ + B₂O₃ + P₂O₃)/ | 0.19 | 0.19 | 0.19 | 0.19 | 0.19 | 0.19 | 0.19 |
| ((100 × SnO₂) × | | | | | | | |
| (R₂O + RO + ZnO + | | | | | | | |
| Al₂O₃)) | | | | | | | |
| SiO₂ + 1.2 × P₂O₅ − | 23.84 | 16.34 | 8.84 | 38.84 | 31.34 | 23.84 | 16.34 |
| 3 × Al₂O₃ − B₂O₃ − | | | | | | | |
| 2 × Li₂O − 1.5 × | | | | | | | |
| Na₂O − K₂O | | | | | | | |
| X | −128 | −248 | −368 | −264 | −385 | −505 | −625 |
| W | −122 | −275 | −429 | −205 | −359 | −513 | −666 |

| Component (mol %) | No. 46 | No. 47 | No. 48 | No. 49 | No. 50 | No. 51 |
|---|---|---|---|---|---|---|
| SiO₂ | 64.841 | 64.839 | 64.842 | 64.841 | 64.838 | 64.842 |
| Al₂O₃ | 18.0 | 13.0 | 13.0 | 8.0 | 8.0 | 8.0 |
| B₂O₃ | 0.0 | 0.0 | 0.0 | 0.0 | 0.0 | 0.0 |
| Li₂O | 0.0 | 0.0 | 0.0 | 0.0 | 0.0 | 0.0 |
| Na₂O | 10.0 | 10.0 | 15.0 | 10.0 | 15.0 | 20.0 |
| K₂O | 0.0 | 0.0 | 0.0 | 0.0 | 0.0 | 0.0 |
| MgO | 5.0 | 10.0 | 5.0 | 15.0 | 10.0 | 5.0 |
| CaO | 0.0 | 0.0 | 0.0 | 0.0 | 0.0 | 0.0 |
| SrO | 0.0 | 0.0 | 0.0 | 0.0 | 0.0 | 0.0 |
| BaO | 0.0 | 0.0 | 0.0 | 0.0 | 0.0 | 0.0 |
| ZnO | 0.0 | 0.0 | 0.0 | 0.0 | 0.0 | 0.0 |
| TiO₂ | 0.002 | 0.002 | 0.002 | 0.002 | 0.002 | 0.002 |
| ZrO₂ | 0.0 | 0.0 | 0.0 | 0.0 | 0.0 | 0.0 |
| SnO₂ | 0.1 | 0.1 | 0.1 | 0.1 | 0.1 | 0.1 |
| Y₂O₃ | 0.0 | 0.0 | 0.0 | 0.0 | 0.0 | 0.0 |
| Fe₂O₃ | 0.002 | 0.002 | 0.002 | 0.002 | 0.002 | 0.002 |
| P₂O₅ | 2.0 | 2.0 | 2.0 | 2.0 | 2.0 | 2.0 |
| SO₃ | 0.000 | 0.000 | 0.000 | 0.000 | 0.000 | 0.000 |
| Cl | 0.05 | 0.05 | 0.05 | 0.05 | 0.05 | 0.05 |
| MoO₃ | 0.005 | 0.007 | 0.004 | 0.005 | 0.008 | 0.004 |
| Sb₂O₃ | 0.000 | 0.000 | 0.000 | 0.000 | 0.000 | 0.000 |
| Li₂O + Na₂O | 10.0 | 10.0 | 15.0 | 10.0 | 15.0 | 20.0 |
| Li₂O + MgO | 5.0 | 10.0 | 5.0 | 15.0 | 10.0 | 5.0 |
| RO | 5.0 | 10.0 | 5.0 | 15.0 | 10.0 | 5.0 |
| B₂O₃ + MgO + CaO | 5.0 | 10.0 | 5.0 | 15.0 | 10.0 | 5.0 |
| R₂O | 10.0 | 10.0 | 15.0 | 10.0 | 15.0 | 20.0 |
| R₂O/Al₂O₃ | 0.6 | 0.8 | 1.2 | 1.3 | 1.9 | 2.5 |
| RO/R₂O | 0.50 | 1.00 | 0.33 | 1.50 | 0.67 | 0.25 |
| Al₂O₃/(R₂O + RO) | 1.20 | 0.65 | 0.65 | 0.32 | 0.32 | 0.32 |
| Na₂O/Li₂O | — | — | — | — | — | — |
| (ZnO + R₂O)/Al₂O₃ | 0.56 | 0.77 | 1.15 | 1.25 | 1.88 | 2.50 |
| MgO/Al₂O₃ | 0.28 | 0.77 | 0.38 | 1.88 | 1.25 | 0.63 |
| (SiO₂ + B₂O₃ + P₂O₃)/ | 0.20 | 0.20 | 0.20 | 0.20 | 0.20 | 0.20 |
| ((100 × SnO₂) × (R₂O + RO + | | | | | | |
| ZnO + Al₂O₃)) | | | | | | |
| SiO₂ + 1.2 × P₂O₅ − 3 × Al₂O₃ − | −1.76 | 13.24 | 5.74 | 28.24 | 20.74 | 13.24 |
| B₂O₃ − 2 × Li₂O − 1.5 × | | | | | | |
| Na₂O − K₂O | | | | | | |
| X | 145 | 8 | −112 | −128 | −248 | −368 |
| W | 46 | −38 | −192 | −122 | −275 | −429 |

TABLE 5

| Component (mol %) | No. 52 | No. 53 | No. 54 | No. 55 | No. 56 | No. 57 | No. 58 |
|---|---|---|---|---|---|---|---|
| SiO₂ | 64.843 | 64.841 | 64.841 | 64.840 | 62.838 | 62.841 | 62.843 |
| Al₂O₃ | 3.0 | 3.0 | 3.0 | 3.0 | 18.0 | 13.0 | 13.0 |
| B₂O₃ | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 |
| Na₂O | 10.0 | 15.0 | 20.0 | 25.0 | 10.0 | 10.0 | 15.0 |
| K₂O | 0.0 | 0.0 | 0.0 | 0.0 | 2.0 | 2.0 | 2.0 |
| MgO | 20.0 | 15.0 | 10.0 | 5.0 | 5.0 | 10.0 | 5.0 |
| CaO | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 |
| SnO₂ | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 |
| P₂O₅ | 2.0 | 2.0 | 2.0 | 2.0 | 2.0 | 2.0 | 2.0 |
| SO₃ | 0.000 | 0.000 | 0.000 | 0.000 | 0.000 | 0.000 | 0.000 |
| Cl | 0.05 | 0.05 | 0.05 | 0.05 | 0.05 | 0.05 | 0.05 |
| MoO₃ | 0.003 | 0.005 | 0.005 | 0.006 | 0.008 | 0.005 | 0.003 |
| Sb₂O₃ | 0.000 | 0.000 | 0.000 | 0.000 | 0.000 | 0.000 | 0.000 |
| Li₂O + Na₂O | 10.0 | 15.0 | 20.0 | 25.0 | 10.0 | 10.0 | 15.0 |
| Li₂O + MgO | 20.0 | 15.0 | 10.0 | 5.0 | 5.0 | 10.0 | 5.0 |
| RO | 20.0 | 15.0 | 10.0 | 5.0 | 5.0 | 10.0 | 5.0 |
| B₂O₃ + MgO + CaO | 20.0 | 15.0 | 10.0 | 5.0 | 5.0 | 10.0 | 5.0 |
| R₂O | 10.0 | 15.0 | 20.0 | 25.0 | 12.0 | 12.0 | 17.0 |
| R₂O/Al₂O₃ | 3.3 | 5.0 | 6.7 | 8.3 | 0.7 | 0.9 | 1.3 |
| RO/R₂O | 2.00 | 1.00 | 0.50 | 0.20 | 0.42 | 0.83 | 0.29 |
| Al₂O₃/(R₂O + RO) | 0.10 | 0.10 | 0.10 | 0.10 | 1.06 | 0.59 | 0.59 |
| Na₂O/Li₂O | — | — | — | — | — | — | — |
| (ZnO + R₂O)/Al₂O₃ | 3.33 | 5.00 | 6.67 | 8.33 | 0.67 | 0.92 | 1.31 |
| MgO/Al₂O₃ | 6.67 | 5.00 | 3.33 | 1.67 | 0.28 | 0.77 | 0.38 |
| (SiO₂ + B₂O₃ + P₂O₃)/ | 0.20 | 0.20 | 0.20 | 0.20 | 0.19 | 0.19 | 0.19 |
| ((100 × SnO₂) × | | | | | | | |
| (R₂O + RO + ZnO + | | | | | | | |
| Al₂O₃)) | | | | | | | |
| SiO₂ + 1.2 × P₂O₅ − | 43.24 | 35.74 | 28.24 | 20.74 | −5.76 | 9.24 | 1.74 |
| 3 × Al₂O₃ − B₂O₃ − | | | | | | | |
| 2 × Li₂O − 1.5 × | | | | | | | |
| Na₂O − K₂O | | | | | | | |
| X | −264 | −385 | −505 | −625 | 148 | 11 | −109 |
| W | −205 | −359 | −513 | −666 | 46 | −38 | −192 |
| Component (mol %) | No. 59 | No. 60 | No. 61 | No. 62 | No. 63 | No. 64 | No. 65 |
| SiO₂ | 62.842 | 62.841 | 62.843 | 62.841 | 62.838 | 62.841 | 62.843 |
| Al₂O₃ | 8.0 | 8.0 | 8.0 | 3.0 | 3.0 | 3.0 | 3.0 |
| B₂O₃ | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 |
| Na₂O | 10.0 | 15.0 | 20.0 | 10.0 | 15.0 | 20.0 | 25.0 |
| K₂O | 2.0 | 2.0 | 2.0 | 2.0 | 2.0 | 2.0 | 2.0 |
| MgO | 15.0 | 10.0 | 5.0 | 20.0 | 15.0 | 10.0 | 5.0 |
| CaO | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 |
| SnO₂ | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 |
| P₂O₅ | 2.0 | 2.0 | 2.0 | 2.0 | 2.0 | 2.0 | 2.0 |
| SO₃ | 0.000 | 0.000 | 0.000 | 0.000 | 0.000 | 0.000 | 0.000 |
| Cl | 0.05 | 0.05 | 0.05 | 0.05 | 0.05 | 0.05 | 0.05 |
| MoO₃ | 0.004 | 0.005 | 0.003 | 0.005 | 0.008 | 0.005 | 0.003 |
| Sb₂O₃ | 0.000 | 0.000 | 0.000 | 0.000 | 0.000 | 0.000 | 0.000 |
| Li₂O + Na₂O | 10.0 | 15.0 | 20.0 | 10.0 | 15.0 | 20.0 | 25.0 |
| Li₂O + MgO | 15.0 | 10.0 | 5.0 | 20.0 | 15.0 | 10.0 | 5.0 |
| RO | 15.0 | 10.0 | 5.0 | 20.0 | 15.0 | 10.0 | 5.0 |
| B₂O₃ + MgO + CaO | 15.0 | 10.0 | 5.0 | 20.0 | 15.0 | 10.0 | 5.0 |
| R₂O | 12.0 | 17.0 | 22.0 | 12.0 | 17.0 | 22.0 | 27.0 |
| R₂O/Al₂O₃ | 1.5 | 2.1 | 2.8 | 4.0 | 5.7 | 7.3 | 9.0 |
| RO/R₂O | 1.25 | 0.59 | 0.23 | 1.67 | 0.88 | 0.45 | 0.19 |
| Al₂O₃/(R₂O + RO) | 0.30 | 0.30 | 0.30 | 0.09 | 0.09 | 0.09 | 0.09 |
| Na₂O/Li₂O | — | — | — | — | — | — | — |
| (ZnO + R₂O)/Al₂O₃ | 1.50 | 2.13 | 2.75 | 4.00 | 5.67 | 7.33 | 9.00 |
| MgO/Al₂O₃ | 1.88 | 1.25 | 0.63 | 6.67 | 5.00 | 3.33 | 1.67 |
| (SiO₂ + B₂O₃ + P₂O₃)/ | 0.19 | 0.19 | 0.19 | 0.19 | 0.19 | 0.19 | 0.19 |
| ((100 × SnO₂) × | | | | | | | |
| (R₂O + RO + ZnO + | | | | | | | |
| Al₂O₃)) | | | | | | | |
| SiO₂ + 1.2 × P₂O₅ − | 24.24 | 16.74 | 9.24 | 39.24 | 31.74 | 24.24 | 16.74 |
| 3 × Al₂O₃ − B₂O₃ − | | | | | | | |
| 2 × Li₂O − 1.5 × | | | | | | | |
| Na₂O − K₂O | | | | | | | |
| X | −125 | −245 | −365 | −261 | −382 | −502 | −622 |
| W | −122 | −275 | −429 | −205 | −359 | −513 | −666 |

TABLE 6

| Component (mol %) | No. 66 | No. 67 | No. 68 | No. 69 | No. 70 | No. 71 | No. 72 | No. 73 | No. 74 | No. 75 |
|---|---|---|---|---|---|---|---|---|---|---|
| SiO₂ | 69.321 | 68.319 | 67.326 | 66.323 | 70.320 | 68.326 | 69.322 | 72.329 | 72.726 | 65.921 |
| Al₂O₃ | 8.9 | 9.9 | 10.9 | 11.9 | 8.9 | 8.9 | 8.9 | 5.9 | 8.9 | 8.9 |
| B₂O₃ | 3.4 | 3.4 | 3.4 | 3.4 | 2.4 | 4.4 | 3.4 | 3.4 | 0.0 | 6.8 |
| Li₂O | 0.0 | 0.0 | 0.0 | 0.0 | 0.0 | 0.0 | 0.0 | 0.0 | 0.0 | 0.0 |
| Na₂O | 13.3 | 13.3 | 13.3 | 13.3 | 13.3 | 13.3 | 13.3 | 13.3 | 13.3 | 13.3 |
| K₂O | 0.0 | 0.0 | 0.0 | 0.0 | 0.0 | 0.0 | 0.0 | 0.0 | 0.0 | 0.0 |
| MgO | 4.8 | 4.8 | 4.8 | 4.8 | 4.8 | 4.8 | 4.9 | 4.8 | 4.8 | 4.8 |
| CaO | 0.1 | 0.1 | 0.1 | 0.1 | 0.1 | 0.1 | 0.0 | 0.1 | 0.1 | 0.1 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 | 0.000 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.1 | 0.1 | 0.1 | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.000 | 0.002 | 0.002 |
| P₂O₅ | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 |
| Cl | 0.05 | 0.05 | 0.05 | 0.05 | 0.05 | 0.05 | 0.05 | 0.05 | 0.05 | 0.05 |
| MoO₃ | 0.005 | 0.007 | 0.000 | 0.003 | 0.006 | 0.000 | 0.004 | 0.001 | 0.000 | 0.005 |
| Sb₂O₃ | 0.000 | 0.000 | 0.000 | 0.000 | 0.000 | 0.000 | 0.000 | 0.000 | 0.000 | 0.000 |
| Li₂O + Na₂O | 13.3 | 13.3 | 13.3 | 13.3 | 13.3 | 13.3 | 13.3 | 13.3 | 13.3 | 13.3 |
| Li₂O + MgO | 4.8 | 4.8 | 4.8 | 4.8 | 4.8 | 4.8 | 4.9 | 4.8 | 4.8 | 4.8 |
| RO | 4.9 | 4.9 | 4.9 | 4.9 | 4.9 | 4.9 | 4.9 | 4.9 | 4.9 | 4.9 |
| B₂O₃ + MgO + CaO | 8.3 | 8.3 | 8.3 | 8.3 | 7.3 | 9.3 | 8.3 | 8.3 | 4.9 | 11.7 |
| R₂O | 13.3 | 13.3 | 13.3 | 13.3 | 13.3 | 13.3 | 13.3 | 13.3 | 13.3 | 13.3 |
| R₂O/Al₂O₃ | 1.5 | 1.3 | 1.2 | 1.1 | 1.5 | 1.5 | 1.5 | 2.3 | 1.5 | 1.5 |
| RO/R₂O | 0.37 | 0.37 | 0.37 | 0.37 | 0.37 | 0.37 | 0.37 | 0.37 | 0.37 | 0.37 |
| Al₂O₃/(R₂O + RO) | 0.49 | 0.54 | 0.60 | 0.65 | 0.49 | 0.49 | 0.49 | 0.32 | 0.49 | 0.49 |
| Na₂O/Li₂O | — | — | — | — | — | — | — | — | — | — |
| (ZnO + R₂O)/Al₂O₃ | 1.49 | 1.34 | 1.22 | 1.12 | 1.49 | 1.49 | 1.49 | 2.25 | 1.49 | 1.49 |
| MgO/Al₂O₃ | 0.54 | 0.48 | 0.44 | 0.40 | 0.54 | 0.54 | 0.55 | 0.81 | 0.54 | 0.54 |
| (SiO₂ + B₂O₃ + P₂O₃)/ | 0.22 | 0.21 | 0.20 | 0.19 | 0.22 | 0.22 | 0.22 | 0.26 | 0.22 | 0.22 |
| ((100 × SnO₂) × | | | | | | | | | | |
| (R₂O + RO + ZnO + | | | | | | | | | | |
| Al₂O₃)) | | | | | | | | | | |
| SiO₂ + 1.2 × P₂O₅ − | 19.27 | 15.27 | 11.28 | 7.27 | 21.27 | 17.28 | 19.27 | 31.28 | 26.08 | 12.47 |
| 3 × Al₂O₃ − B₂O₃ − | | | | | | | | | | |
| 2 × Li₂O − 1.5 × | | | | | | | | | | |
| Na₂O − K₂O | | | | | | | | | | |
| X | −199 | −170 | −142 | −113 | −197 | −200 | −199 | −284 | −193 | −204 |
| W | −232 | −214 | −196 | −178 | −228 | −237 | −231 | −287 | −217 | −248 |

TABLE 7

| Component (mol %) | No. 76 | No. 77 | No. 78 | No. 79 | No. 80 | No. 81 | No. 82 |
|---|---|---|---|---|---|---|---|
| SiO₂ | 69.322 | 64.581 | 67.346 | 62.503 | 62.449 | 75.743 | 72.813 |
| Al₂O₃ | 10.4 | 14.0 | 12.8 | 14.4 | 16.9 | 6.1 | 8.8 |
| B₂O₃ | 4.9 | 4.7 | 3.4 | 1.8 | 0.1 | 2.7 | 2.7 |
| Li₂O | 0.0 | 0.0 | 0.0 | 0.0 | 0.0 | 0.0 | 0.0 |
| Na₂O | 10.3 | 14.1 | 14.0 | 17.7 | 12.2 | 12.1 | 12.3 |
| K₂O | 0.0 | 0.0 | 0.0 | 0.0 | 4.0 | 0.0 | 0.0 |
| MgO | 4.8 | 2.5 | 2.4 | 3.3 | 4.1 | 3.1 | 3.2 |
| CaO | 0.1 | 0.0 | 0.0 | 0.0 | 0.0 | 0.0 | 0.0 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 |
| TiO₂ | 0.002 | 0.002 | 0.002 | 0.002 | 0.002 | 0.000 | 0.002 |
| ZrO₂ | 0.0 | 0.0 | 0.0 | 0.0 | 0.0 | 0.0 | 0.0 |
| SnO₂ | 0.1 | 0.1 | 0.1 | 0.2 | 0.1 | 0.1 | 0.1 |
| Y₂O₃ | 0.0 | 0.0 | 0.0 | 0.0 | 0.0 | 0.0 | 0.0 |
| Fe₂O₃ | 0.002 | 0.002 | 0.002 | 0.002 | 0.002 | 0.000 | 0.002 |
| P₂O₅ | 0.0 | 0.0 | 0.0 | 0.0 | 0.1 | 0.0 | 0.0 |
| SO₃ | 0.000 | 0.000 | 0.000 | 0.000 | 0.000 | 0.000 | 0.000 |
| Cl | 0.05 | 0.05 | 0.05 | 0.05 | 0.05 | 0.05 | 0.05 |
| MoO₃ | 0.004 | 0.005 | 0.000 | 0.003 | 0.007 | 0.001 | 0.005 |
| Sb₂O₃ | 0.000 | 0.000 | 0.000 | 0.000 | 0.000 | 0.000 | 0.000 |
| Li₂O + Na₂O | 10.3 | 14.1 | 14.0 | 17.7 | 12.2 | 12.1 | 12.3 |
| Li₂O + MgO | 4.8 | 2.5 | 2.4 | 3.3 | 4.1 | 3.1 | 3.2 |
| RO | 4.9 | 2.5 | 2.4 | 3.3 | 4.1 | 3.1 | 3.2 |
| B₂O₃ + MgO + CaO | 9.8 | 7.2 | 5.8 | 5.1 | 4.2 | 5.8 | 5.9 |
| R₂O | 10.3 | 14.1 | 14.0 | 17.7 | 16.2 | 12.1 | 12.3 |
| R₂O/Al₂O₃ | 1.0 | 1.0 | 1.1 | 1.2 | 1.0 | 2.0 | 1.4 |
| RO/R₂O | 0.48 | 0.18 | 0.17 | 0.19 | 0.25 | 0.26 | 0.26 |
| Al₂O₃/(R₂O + RO) | 0.68 | 0.85 | 0.78 | 0.69 | 0.83 | 0.40 | 0.56 |
| Na₂O/Li₂O | — | — | — | — | — | — | — |
| (ZnO + R₂O)/Al₂O₃ | 0.99 | 1.00 | 1.10 | 1.22 | 0.96 | 1.97 | 1.41 |
| MgO/Al₂O₃ | 0.46 | 0.18 | 0.19 | 0.23 | 0.24 | 0.51 | 0.36 |
| (SiO₂ + B₂O₃ + P₂O₃)/ | 0.24 | 0.17 | 0.24 | 0.09 | 0.15 | 0.29 | 0.25 |
| ((100 × SnO₂) × | | | | | | | |
| (R₂O + RO + ZnO + | | | | | | | |
| Al₂O₃)) | | | | | | | |
| SiO₂ + 1.2 × P₂O₅ − | 17.77 | −3.25 | 4.74 | −9.13 | −10.51 | 36.42 | 25.30 |
| 3 × Al₂O₃ − B₂O₃ − | | | | | | | |
| 2 × Li₂O − 1.5 × | | | | | | | |
| Na₂O − K₂O | | | | | | | |
| X | −90 | −76 | −108 | −140 | 65 | −252 | −182 |
| W | −124 | −170 | −185 | −254 | −40 | −246 | −205 |

| Component (mol %) | No. 83 | No. 84 | No. 85 | No. 86 | No. 87 | No. 88 |
|---|---|---|---|---|---|---|
| SiO₂ | 69.789 | 71.983 | 68.976 | 68.179 | 73.698 | 70.738 |
| Al₂O₃ | 11.5 | 6.2 | 8.8 | 6.2 | 6.1 | 8.8 |
| B₂O₃ | 2.8 | 6.3 | 6.4 | 10.0 | 2.7 | 2.7 |
| Li₂O | 0.0 | 0.0 | 0.0 | 0.0 | 0.0 | 0.0 |
| Na₂O | 12.6 | 12.2 | 12.4 | 12.3 | 14.2 | 14.4 |
| K₂O | 0.0 | 0.0 | 0.0 | 0.0 | 0.0 | 0.0 |
| MgO | 3.2 | 3.1 | 3.2 | 3.1 | 3.1 | 3.2 |
| CaO | 0.0 | 0.0 | 0.0 | 0.0 | 0.0 | 0.0 |
| SrO | 0.0 | 0.0 | 0.0 | 0.0 | 0.0 | 0.0 |
| BaO | 0.0 | 0.0 | 0.0 | 0.0 | 0.0 | 0.0 |
| ZnO | 0.0 | 0.0 | 0.0 | 0.0 | 0.0 | 0.0 |
| TiO₂ | 0.002 | 0.000 | 0.002 | 0.002 | 0.002 | 0.002 |
| ZrO₂ | 0.0 | 0.0 | 0.0 | 0.0 | 0.0 | 0.0 |
| SnO₂ | 0.1 | 0.1 | 0.1 | 0.1 | 0.1 | 0.1 |
| Y₂O₃ | 0.0 | 0.0 | 0.0 | 0.0 | 0.0 | 0.0 |
| Fe₂O₃ | 0.002 | 0.000 | 0.002 | 0.002 | 0.002 | 0.002 |
| P₂O₅ | 0.0 | 0.0 | 0.0 | 0.0 | 0.0 | 0.0 |
| SO₃ | 0.000 | 0.000 | 0.000 | 0.000 | 0.000 | 0.000 |
| Cl | 0.05 | 0.05 | 0.05 | 0.05 | 0.05 | 0.05 |
| MoO₃ | 0.003 | 0.002 | 0.000 | 0.000 | 0.004 | 0.004 |
| Sb₂O₃ | 0.000 | 0.000 | 0.000 | 0.000 | 0.000 | 0.000 |
| Li₂O + Na₂O | 12.6 | 12.2 | 12.4 | 12.3 | 14.2 | 14.4 |
| Li₂O + MgO | 3.2 | 3.1 | 3.2 | 3.1 | 3.1 | 3.2 |
| RO | 3.2 | 3.1 | 3.2 | 3.1 | 3.1 | 3.2 |
| B₂O₃ + MgO + CaO | 6.0 | 9.5 | 9.6 | 13.2 | 5.8 | 5.9 |
| R₂O | 12.6 | 12.2 | 12.4 | 12.3 | 14.2 | 14.4 |
| R₂O/Al₂O₃ | 1.1 | 2.0 | 1.4 | 2.0 | 2.3 | 1.6 |
| RO/R₂O | 0.26 | 0.26 | 0.26 | 0.26 | 0.22 | 0.22 |
| Al₂O₃/(R₂O + RO) | 0.73 | 0.40 | 0.56 | 0.40 | 0.36 | 0.50 |
| Na₂O/Li₂O | — | — | — | — | — | — |
| (ZnO + R₂O)/Al₂O₃ | 1.10 | 1.97 | 1.41 | 1.97 | 2.30 | 1.65 |
| MgO/Al₂O₃ | 0.28 | 0.51 | 0.36 | 0.51 | 0.51 | 0.36 |
| (SiO₂ + B₂O₃ + P₂O₃)/((100 × | 0.21 | 0.29 | 0.24 | 0.29 | 0.26 | 0.22 |
| SnO₂) × (R₂O + RO + ZnO + | | | | | | |
| Al₂O₃)) | | | | | | |
| SiO₂ + 1.2 × P₂O₅ − 3 × Al₂O₃ − | 13.80 | 28.81 | 17.50 | 21.12 | 31.31 | 20.11 |
| B₂O₃ − 2 × Li₂O − 1.5 × Na₂O − | | | | | | |
| K₂O | | | | | | |
| X | −110 | −258 | −189 | −265 | −298 | −229 |
| W | −163 | −264 | −223 | −282 | −306 | −266 |

TABLE 8

| Component (mol %) | No. 89 | No. 90 | No. 91 | No. 92 | No.93 | No. 94 | No. 95 |
|---|---|---|---|---|---|---|---|
| SiO₂ | 67.674 | 69.921 | 66.878 | 66.106 | 67.733 | 69.322 | 69.326 |
| Al₂O₃ | 11.5 | 6.2 | 8.8 | 6.2 | 10.1 | 10.6 | 10.9 |
| B₂O₃ | 2.8 | 6.3 | 6.5 | 10.0 | 0.0 | 4.9 | 4.9 |
| Li₂O | 0.0 | 0.0 | 0.0 | 0.0 | 0.0 | 0.0 | 0.0 |
| Na₂O | 14.7 | 14.2 | 14.5 | 14.3 | 14.1 | 10.5 | 10.8 |
| K₂O | 0.0 | 0.0 | 0.0 | 0.0 | 0.1 | 0.0 | 0.0 |
| MgO | 3.2 | 3.1 | 3.2 | 3.1 | 7.9 | 4.5 | 3.9 |
| CaO | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 |
| SnO₂ | 0.1 | 0.1 | 0.1 | 0.1 | 0.0 | 0.1 | 0.1 |
| Y₂O₃ | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 |
| Cl | 0.05 | 0.05 | 0.05 | 0.05 | 0.05 | 0.05 | 0.05 |
| MoO₃ | 0.003 | 0.008 | 0.007 | 0.006 | 0.005 | 0.004 | 0.000 |
| Sb₂O₃ | 0.000 | 0.000 | 0.000 | 0.000 | 0.000 | 0.000 | 0.000 |
| Li₂O + Na₂O | 14.7 | 14.2 | 14.5 | 14.3 | 14.1 | 10.5 | 10.8 |
| Li₂O + MgO | 3.2 | 3.1 | 3.2 | 3.1 | 7.9 | 4.5 | 3.9 |
| RO | 3.2 | 3.1 | 3.2 | 3.1 | 8.0 | 4.5 | 3.9 |
| B₂O₃ + MgO + CaO | 6.0 | 9.5 | 9.6 | 13.2 | 8.0 | 9.4 | 8.8 |
| R₂O | 14.7 | 14.2 | 14.5 | 14.3 | 14.2 | 10.5 | 10.8 |
| R₂O/Al₂O₃ | 1.3 | 2.3 | 1.6 | 2.3 | 1.4 | 1.0 | 1.0 |
| RO/R₂O | 0.22 | 0.22 | 0.22 | 0.22 | 0.56 | 0.43 | 0.36 |
| Al₂O₃/(R₂O + RO) | 0.64 | 0.36 | 0.50 | 0.36 | 0.46 | 0.71 | 0.74 |
| Na₂O/Li₂O | — | — | — | — | — | — | — |
| (ZnO + R₂O)/Al₂O₃ | 1.28 | 2.30 | 1.65 | 2.30 | 1.40 | 0.99 | 0.99 |
| MgO/Al₂O₃ | 0.28 | 0.51 | 0.36 | 0.51 | 0.79 | 0.42 | 0.36 |
| (SiO₂ + B₂O₃ + P₂O₃)/ | 0.19 | 0.26 | 0.22 | .25 | # DIV/ | 0.24 | 0.24 |
| ((100 × SnO₂) × | | | | | | | |
| (R₂O + RO + ZnO + | | | | | | | |
| Al₂O₃)) | | | | | | | |
| SiO₂ + 1.2 × P₂O₅ − | 8.51 | 23.67 | 12.27 | 15.94 | 16.29 | 16.87 | 15.53 |
| 3 × Al₂O₃ − B₂O₃ − | | | | | | | |
| 2 × Li₂O − 1.5 × | | | | | | | |
| Na₂O − K₂O | | | | | | | |
| X | −158 | −305 | −236 | −312 | −172 | −90 | −89 |
| W | −224 | −324 | −284 | −342 | −213 | −125 | −130 |

| Component (mol %) | No. 96 | No. 97 | No. 98 | No. 99 | No. 100 | No. 101 |
|---|---|---|---|---|---|---|
| SiO₂ | 69.323 | 69.326 | 69.321 | 67.318 | 65.319 | 67.321 |
| Al₂O₃ | 11.2 | 11.5 | 10.4 | 10.4 | 10.4 | 10.4 |
| B₂O₃ | 4.9 | 4.9 | 4.4 | 6.4 | 8.4 | 4.4 |
| Li₂O | 0.0 | 0.0 | 0.0 | 0.0 | 0.0 | 0.0 |
| Na₂O | 11.1 | 11.4 | 10.8 | 10.8 | 10.8 | 12.8 |
| K₂O | 0.0 | 0.0 | 2.1 | 2.1 | 2.1 | 2.1 |
| MgO | 3.3 | 2.7 | 2.7 | 2.7 | 2.7 | 2.7 |
| CaO | 0.0 | 0.0 | 0.1 | 0.1 | 0.1 | 0.1 |
| SrO | 0.0 | 0.0 | 0.0 | 0.0 | 0.0 | 0.0 |
| BaO | 0.0 | 0.0 | 0.0 | 0.0 | 0.0 | 0.0 |
| ZnO | 0.0 | 0.0 | 0.0 | 0.0 | 0.0 | 0.0 |
| TiO₂ | 0.002 | 0.002 | 0.002 | 0.002 | 0.002 | 0.002 |
| ZrO₂ | 0.0 | 0.0 | 0.0 | 0.0 | 0.0 | 0.0 |
| SnO₂ | 0.1 | 0.1 | 0.1 | 0.1 | 0.1 | 0.1 |
| Y₂O₃ | 0.0 | 0.0 | 0.0 | 0.0 | 0.0 | 0.0 |
| Fe₂O₃ | 0.002 | 0.002 | 0.002 | 0.002 | 0.002 | 0.002 |
| P₂O₅ | 0.0 | 0.0 | 0.0 | 0.0 | 0.0 | 0.0 |
| SO₃ | 0.000 | 0.000 | 0.000 | 0.000 | 0.000 | 0.000 |
| Cl | 0.05 | 0.05 | 0.05 | 0.05 | 0.05 | 0.05 |
| MoO₃ | 0.003 | 0.000 | 0.005 | 0.008 | 0.007 | 0.005 |
| Sb₂O₃ | 0.000 | 0.000 | 0.000 | 0.000 | 0.000 | 0.000 |
| Li₂O + Na₂O | 11.1 | 11.4 | 10.8 | 10.8 | 10.8 | 12.8 |
| Li₂O + MgO | 3.3 | 2.7 | 2.7 | 2.7 | 2.7 | 2.7 |
| RO | 3.3 | 2.7 | 2.8 | 2.8 | 2.8 | 2.8 |
| B₂O₃ + MgO + CaO | 8.2 | 7.6 | 7.2 | 9.2 | 11.2 | 7.2 |
| R₂O | 11.1 | 11.4 | 12.9 | 12.9 | 12.9 | 14.9 |
| R₂O/Al₂O₃ | 1.0 | 1.0 | 1.2 | 1.2 | 1.2 | 1.4 |
| RO/R₂O | 0.30 | 0.24 | 0.22 | 0.22 | 0.22 | 0.19 |
| Al₂O₃/(R₂O + RO) | 0.78 | 0.82 | 0.66 | 0.66 | 0.66 | 0.59 |
| Na₂O/Li₂O | — | — | — | — | — | — |
| (ZnO + R₂O)/Al₂O₃ | 0.99 | 0.99 | 1.24 | 1.24 | 1.24 | 1.43 |
| MgO/Al₂O₃ | 0.29 | 0.23 | 0.26 | 0.26 | 0.26 | 0.26 |
| (SiO₂ + B₂O₃ + P₂O₃)/((100 × | 0.24 | 0.24 | 0.24 | 0.24 | 0.24 | 0.21 |
| SnO₂) × (R₂O + RO + ZnO + | | | | | | |
| Al₂O₃)) | | | | | | |
| SiO₂ + 1.2 × P₂O₅ − 3 × | 14.17 | 12.83 | 15.42 | 11.42 | 7.42 | 10.42 |
| Al₂O₃ − B₂O₃ − 2 × Li₂O − | | | | | | |
| 1.5 × Na₂O − K₂O | | | | | | |
| X | −88 | −87 | −100 | −103 | −107 | −146 |
| W | −134 | −138 | −139 | −148 | −157 | −198 |

TABLE 9

| Component | No. | No. | No. | No. | No. | No. | No. |
|---|---|---|---|---|---|---|---|
| (mol %) | 102 | 103 | 104 | 105 | 106 | 107 | 108 |
| SiO₂ | 65.322 | 65.326 | 71.978 | 68.972 | 68.179 | 70.488 | 70.085 |
| Al₂O₃ | 10.4 | 10.4 | 6.2 | 8.8 | 6.2 | 7.5 | 6.2 |
| B₂O₃ | 6.4 | 4.4 | 6.3 | 6.4 | 10.0 | 6.4 | 8.2 |
| Li₂O | 0.0 | 0.0 | 0.0 | 0.0 | 0.0 | 0.0 | 0.0 |
| Na₂O | 12.8 | 14.8 | 12.2 | 12.4 | 12.3 | 12.3 | 12.2 |
| K₂O | 2.1 | 2.1 | 0.0 | 0.0 | 0.0 | 0.0 | 0.0 |
| MgO | 2.7 | 2.7 | 3.1 | 3.2 | 3.1 | 3.2 | 3.1 |
| CaO | 0.1 | 0.1 | 0.0 | 0.0 | 0.0 | 0.0 | 0.0 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 |
| SnO₂ | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 |
| Cl | 0.05 | 0.05 | 0.05 | 0.05 | 0.05 | 0.05 | 0.05 |
| MoO₃ | 0.004 | 0.000 | 0.003 | 0.004 | 0.000 | 0.003 | 0.000 |
| Sb₂O₃ | 0.000 | 0.000 | 0.000 | 0.000 | 0.000 | 0.000 | 0.000 |
| Li₂O + Na₂O | 12.8 | 14.8 | 12.2 | 12.4 | 12.3 | 12.3 | 12.2 |
| Li₂O + MgO | 2.7 | 2.7 | 3.1 | 3.2 | 3.1 | 3.2 | 3.1 |
| RO | 2.8 | 2.8 | 3.1 | 3.2 | 3.1 | 3.2 | 3.1 |
| B₂O₃ + MgO + CaO | 9.2 | 7.2 | 9.5 | 9.6 | 13.2 | 9.5 | 11.3 |
| R₂O | 14.9 | 16.9 | 12.2 | 12.4 | 12.3 | 12.3 | 12.2 |
| R₂O/Al₂O₃ | 1.4 | 1.6 | 2.0 | 1.4 | 2.0 | 1.6 | 2.0 |
| RO/R₂O | 0.19 | 0.17 | 0.26 | 0.26 | 0.26 | 0.26 | 0.26 |
| Al₂O₃/(R₂O + RO) | 0.59 | 0.53 | 0.40 | 0.56 | 0.40 | 0.48 | 0.40 |
| Na₂O/Li₂O | — | — | — | — | — | — | — |
| (ZnO + R₂O)/ | 1.43 | 1.63 | 1.97 | 1.41 | 1.97 | 1.65 | 1.97 |
| Al₂O₃ | | | | | | | |
| MgO/Al₂O₃ | 0.26 | 0.26 | 0.51 | 0.36 | 0.51 | 0.42 | 0.51 |
| (SiO₂ + B₂O₃ + P₂O₅)/ | 0.21 | 0.19 | 0.29 | 0.24 | 0.29 | 0.26 | 0.29 |
| ((100 × SnO₂) × | | | | | | | |
| (R₂O + RO + ZnO + | | | | | | | |
| Al₂O₃)) | | | | | | | |
| SiO₂ + 1.2 × P₂O₅- | 6.42 | 5.43 | 28.81 | 17.50 | 21.12 | 23.20 | 24.97 |
| 3 × Al₂O₃—B₂O₃- | | | | | | | |
| 2 × Li₂O- | | | | | | | |
| 1.5 × Na₂O—K₂O | | | | | | | |
| X | −149 | −191 | −258 | −189 | −265 | −224 | −262 |
| W | −207 | −257 | −264 | −223 | −282 | −243 | −273 |
| Component | No. | No. | No. | No. | No. | No. | No. |
| (mol %) | 109 | 110 | 111 | 112 | 113 | 114 | 115 |
| SiO₂ | 68.570 | 70.420 | 68.421 | 66.426 | 68.426 | 66.421 | 66.421 |
| Al₂O₃ | 7.5 | 8.4 | 10.4 | 12.4 | 8.4 | 10.4 | 8.4 |
| B₂O₃ | 8.2 | 4.9 | 4.9 | 4.9 | 6.9 | 6.9 | 8.9 |
| Li₂O | 0.0 | 0.0 | 0.0 | 0.0 | 0.0 | 0.0 | 0.0 |
| Na₂O | 12.3 | 12.3 | 12.3 | 12.3 | 12.3 | 12.3 | 12.3 |
| K₂O | 0.0 | 1.0 | 1.0 | 1.0 | 1.0 | 1.0 | 1.0 |
| MgO | 3.2 | 2.7 | 2.7 | 2.7 | 2.7 | 2.7 | 2.7 |
| CaO | 0.0 | 0.1 | 0.1 | 0.1 | 0.1 | 0.1 | 0.1 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 |
| SnO₂ | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 |
| Cl | 0.05 | 0.05 | 0.05 | 0.05 | 0.05 | 0.05 | 0.05 |
| MoO₃ | 0.005 | 0.006 | 0.005 | 0.000 | 0.000 | 0.005 | 0.005 |
| Sb₂O₃ | 0.000 | 0.000 | 0.000 | 0.000 | 0.000 | 0.000 | 0.000 |
| Li₂O + Na₂O | 12.3 | 12.3 | 12.3 | 12.3 | 12.3 | 12.3 | 12.3 |
| Li₂O + MgO | 3.2 | 2.7 | 2.7 | 2.7 | 2.7 | 2.7 | 2.7 |
| RO | 3.2 | 2.8 | 2.8 | 2.8 | 2.8 | 2.8 | 2.8 |
| B₂O₃ + MgO + CaO | 11.4 | 7.7 | 7.7 | 7.7 | 9.7 | 9.7 | 11.7 |
| R₂O | 12.3 | 13.3 | 13.3 | 13.3 | 13.3 | 13.3 | 13.3 |
| R₂O/Al₂O₃ | 1.6 | 1.6 | 1.3 | 1.1 | 1.6 | 1.3 | 1.6 |
| RO/R₂O | 0.26 | 0.21 | 0.21 | 0.21 | 0.21 | 0.21 | 0.21 |
| Al₂O₃/(R₂O + RO) | 0.48 | 0.52 | 0.65 | 0.77 | 0.52 | 0.65 | 0.52 |
| Na₂O/Li₂O | — | — | — | — | — | — | — |
| (ZnO + R₂O)/ | 1.65 | 1.58 | 1.28 | 1.07 | 1.58 | 1.28 | 1.58 |
| Al₂O₃ | | | | | | | |
| MgO/Al₂O₃ | 0.42 | 0.32 | 0.26 | 0.22 | 0.32 | 0.26 | 0.32 |
| (SiO₂ + B₂O₃ + P₂O₅)/ | 0.26 | 0.26 | 0.23 | 0.21 | 0.26 | 0.23 | 0.26 |
| ((100 × SnO₂) × | | | | | | | |
| (R₂O + RO + ZnO + | | | | | | | |
| Al₂O₃)) | | | | | | | |
| SiO₂ + 1.2 × P₂O₅- | 19.31 | 20.87 | 12.87 | 4.88 | 16.88 | 8.87 | 12.87 |
| 3 × Al₂O₃—B₂O₃- | | | | | | | |
| 2 × Li₂O- | | | | | | | |
| 1.5 × Na₂O—K₂O | | | | | | | |
| X | −227 | −194 | −137 | −80 | −197 | −140 | −201 |
| W | −252 | −222 | −185 | −149 | −231 | −194 | −240 |

TABLE 10

| Component | No. | No. | No. | No. | No. | No. | No. |
|---|---|---|---|---|---|---|---|
| (mol %) | 116 | 117 | 118 | 119 | 120 | 121 | 122 |
| SiO₂ | 72.422 | 70.423 | 68.426 | 70.420 | 68.418 | 68.420 | 69.421 |
| Al₂O₃ | 8.4 | 10.4 | 12.4 | 8.4 | 10.4 | 8.4 | 8.4 |
| B₂O₃ | 4.9 | 4.9 | 4.9 | 6.9 | 6.9 | 8.9 | 5.9 |
| Li₂O | 0.0 | 0.0 | 0.0 | 0.0 | 0.0 | 0.0 | 0.0 |
| Na₂O | 10.3 | 10.3 | 10.3 | 10.3 | 10.3 | 10.3 | 12.3 |
| K₂O | 1.0 | 1.0 | 1.0 | 1.0 | 1.0 | 1.0 | 1.0 |
| MgO | 2.7 | 2.7 | 2.7 | 2.7 | 2.7 | 2.7 | 2.7 |
| CaO | 0.1 | 0.1 | 0.1 | 0.1 | 0.1 | 0.1 | 0.1 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 |
| SnO₂ | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 |
| Cl | 0.05 | 0.05 | 0.05 | 0.05 | 0.05 | 0.05 | 0.05 |
| MoO₃ | 0.004 | 0.003 | 0.000 | 0.006 | 0.008 | 0.006 | 0.005 |
| Sb₂O₃ | 0.000 | 0.000 | 0.000 | 0.000 | 0.000 | 0.000 | 0.000 |
| Li₂O + Na₂O | 10.3 | 10.3 | 10.3 | 10.3 | 10.3 | 10.3 | 12.3 |
| Li₂O + MgO | 2.7 | 2.7 | 2.7 | 2.7 | 2.7 | 2.7 | 2.7 |
| RO | 2.8 | 2.8 | 2.8 | 2.8 | 2.8 | 2.8 | 2.8 |
| B₂O₃ + MgO + CaO | 7.7 | 7.7 | 7.7 | 9.7 | 9.7 | 11.7 | 8.7 |
| R₂O | 11.3 | 11.3 | 11.3 | 11.3 | 11.3 | 11.3 | 13.3 |
| R₂O/Al₂O₃ | 1.3 | 1.1 | 0.9 | 1.3 | 1.1 | 1.3 | 1.6 |
| RO/R₂O | 0.25 | 0.25 | 0.25 | 0.25 | 0.25 | 0.25 | 0.21 |
| Al₂O₃/(R₂O + RO) | 0.60 | 0.74 | 0.88 | 0.60 | 0.74 | 0.60 | 0.52 |
| Na₂O/Li₂O | — | — | — | — | — | — | — |
| (ZnO + R₂O)/Al₂O₃ | 1.35 | 1.09 | 0.91 | 1.35 | 1.09 | 1.35 | 1.58 |
| MgO/Al₂O₃ | 0.32 | 0.26 | 0.22 | 0.32 | 0.26 | 0.32 | 0.32 |
| (SiO₂ + B₂O₃ + P₂O₅)/ | 0.29 | 0.26 | 0.23 | 0.29 | 0.26 | 0.29 | 0.26 |
| ((100 × SnO₂) × | | | | | | | |
| (R₂O + RO + ZnO + | | | | | | | |
| Al₂O₃)) | | | | | | | |
| SiO₂ + 1.2 × P₂O₅- | 25.87 | 17.87 | 9.88 | 21.87 | 13.87 | 17.87 | 18.87 |
| 3 × Al₂O₃—B₂O₃- | | | | | | | |
| 2 × Li₂O- | | | | | | | |
| 1.5 × Na₂O—K₂O | | | | | | | |
| X | −148 | −91 | −34 | −151 | −95 | −155 | −195 |
| W | −163 | −127 | −91 | −172 | −136 | −181 | −226 |
| | Component | No. | No. | No. | No. | No. | No. |
| | (mol %) | 123 | 124 | 125 | 126 | 127 | 128 |
| | SiO₂ | 68.422 | 67.426 | 66.423 | 69.426 | 67.423 | 66.426 |
| | Al₂O₃ | 9.4 | 10.4 | 11.4 | 9.4 | 9.4 | 9.4 |
| | B₂O₃ | 5.9 | 5.9 | 5.9 | 4.9 | 6.9 | 7.9 |
| | Li₂O | 0.0 | 0.0 | 0.0 | 0.0 | 0.0 | 0.0 |
| | Na₂O | 12.3 | 12.3 | 12.3 | 12.3 | 12.3 | 12.3 |
| | K₂O | 1.0 | 1.0 | 1.0 | 1.0 | 1.0 | 1.0 |
| | MgO | 2.7 | 2.7 | 2.7 | 2.7 | 2.7 | 2.7 |
| | CaO | 0.1 | 0.1 | 0.1 | 0.1 | 0.1 | 0.1 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | ZnO | 0.0 | 0.0 | 0.0 | 0.0 | 0.0 | 0.0 |
| | TiO₂ | 0.002 | 0.002 | 0.002 | 0.002 | 0.002 | 0.002 |
| | ZrO₂ | 0.0 | 0.0 | 0.0 | 0.0 | 0.0 | 0.0 |
| | SnO₂ | 0.1 | 0.1 | 0.1 | 0.1 | 0.1 | 0.1 |
| | Y₂O₃ | 0.0 | 0.0 | 0.0 | 0.0 | 0.0 | 0.0 |
| | Fe₂O₃ | 0.002 | 0.002 | 0.002 | 0.002 | 0.002 | 0.002 |
| | P₂O₅ | 0.0 | 0.0 | 0.0 | 0.0 | 0.0 | 0.0 |
| | SO₃ | 0.000 | 0.000 | 0.000 | 0.000 | 0.000 | 0.000 |
| | Cl | 0.05 | 0.05 | 0.05 | 0.05 | 0.05 | 0.05 |
| | MoO₃ | 0.004 | 0.000 | 0.003 | 0.000 | 0.003 | 0.000 |
| | Sb₂O₃ | 0.000 | 0.000 | 0.000 | 0.000 | 0.000 | 0.000 |
| | Li₂O + Na₂O | 12.3 | 12.3 | 12.3 | 12.3 | 12.3 | 12.3 |
| | Li₂O + MgO | 2.7 | 2.7 | 2.7 | 2.7 | 2.7 | 2.7 |
| | RO | 2.8 | 2.8 | 2.8 | 2.8 | 2.8 | 2.8 |
| | B₂O₃ + MgO + CaO | 8.7 | 8.7 | 8.7 | 7.7 | 9.7 | 10.7 |
| | R₂O | 13.3 | 13.3 | 13.3 | 13.3 | 13.3 | 13.3 |
| | R₂O/Al₂O₃ | 1.4 | 1.3 | 1.2 | 1.4 | 1.4 | 1.4 |
| | RO/R₂O | 0.21 | 0.21 | 0.21 | 0.21 | 0.21 | 0.21 |
| | Al₂O₃/(R₂O + RO) | 0.58 | 0.65 | 0.71 | 0.58 | 0.58 | 0.58 |
| | Na₂O/Li₂O | — | — | — | — | — | — |
| | (ZnO + R₂O)/Al₂O₃ | 1.41 | 1.28 | 1.17 | 1.41 | 1.41 | 1.41 |
| | MgO/Al₂O₃ | 0.29 | 0.26 | 0.24 | 0.29 | 0.29 | 0.29 |
| | (SiO₂ + B₂O₃ + P₂O₅)/ | 0.24 | 0.23 | 0.22 | 0.24 | 0.24 | 0.24 |
| | ((100 × SnO₂) × | | | | | | |
| | (R₂O + RO + ZnO + | | | | | | |
| | Al₂O₃)) | | | | | | |
| | SiO₂ + 1.2 × P₂O₅- | 14.87 | 10.88 | 6.87 | 16.88 | 12.87 | 10.88 |
| | 3 × Al₂O₃—B₂O₃- | | | | | | |
| | 2 × Li₂O- | | | | | | |
| | 1.5 × Na₂O—K₂O | | | | | | |
| | X | −167 | −138 | −110 | −165 | −169 | −170 |
| | W | −208 | −190 | −172 | −204 | −213 | −217 |

TABLE 11

| Component | No. | No. | No. | No. | No. | No. | No. |
|---|---|---|---|---|---|---|---|
| (mol %) | 129 | 130 | 131 | 132 | 133 | 134 | 135 |
| SiO₂ | 71.420 | 70.419 | 69.426 | 68.421 | 71.422 | 69.426 | 68.423 |
| Al₂O₃ | 8.4 | 9.4 | 10.4 | 11.4 | 9.4 | 9.4 | 9.4 |
| B₂O₃ | 5.9 | 5.9 | 5.9 | 5.9 | 4.9 | 6.9 | 7.9 |
| Li₂O | 0.0 | 0.0 | 0.0 | 0.0 | 0.0 | 0.0 | 0.0 |
| Na₂O | 10.3 | 10.3 | 10.3 | 10.3 | 10.3 | 10.3 | 10.3 |
| K₂O | 1.0 | 1.0 | 1.0 | 1.0 | 1.0 | 1.0 | 1.0 |
| MgO | 2.7 | 2.7 | 2.7 | 2.7 | 2.7 | 2.7 | 2.7 |
| CaO | 0.1 | 0.1 | 0.1 | 0.1 | 0.1 | 0.1 | 0.1 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 |
| SnO₂ | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 |
| Cl | 0.05 | 0.05 | 0.05 | 0.05 | 0.05 | 0.05 | 0.05 |
| MoO₃ | 0.006 | 0.007 | 0.000 | 0.005 | 0.004 | 0.000 | 0.003 |
| Sb₂O₃ | 0.000 | 0.000 | 0.000 | 0.000 | 0.000 | 0.000 | 0.000 |
| Li₂O + Na₂O | 10.3 | 10.3 | 10.3 | 10.3 | 10.3 | 10.3 | 10.3 |
| Li₂O + MgO | 2.7 | 2.7 | 2.7 | 2.7 | 2.7 | 2.7 | 2.7 |
| RO | 2.8 | 2.8 | 2.8 | 2.8 | 2.8 | 2.8 | 2.8 |
| B₂O₃ + MgO + CaO | 8.7 | 8.7 | 8.7 | 8.7 | 7.7 | 9.7 | 10.7 |
| R₂O | 11.3 | 11.3 | 11.3 | 11.3 | 11.3 | 11.3 | 11.3 |
| R₂O/Al₂O₃ | 1.3 | 1.2 | 1.1 | 1.0 | 1.2 | 1.2 | 1.2 |
| RO/R₂O | 0.25 | 0.25 | 0.25 | 0.25 | 0.25 | 0.25 | 0.25 |
| Al₂O₃/(R₂O + RO) | 0.60 | 0.67 | 0.74 | 0.81 | 0.67 | 0.67 | 0.67 |
| Na₂O/Li₂O | — | — | — | — | — | — | — |
| (ZnO + R₂O)/Al₂O₃ | 1.35 | 1.20 | 1.09 | 0.99 | 1.20 | 1.20 | 1.20 |
| MgO/Al₂O₃ | 0.32 | 0.29 | 0.26 | 0.24 | 0.29 | 0.29 | 0.29 |
| (SiO₂ + B₂O₃ + P₂O₅)/ | 0.29 | 0.27 | 0.26 | 0.24 | 0.27 | 0.27 | 0.27 |
| ((100 × SnO₂) × | | | | | | | |
| (R₂O + RO + ZnO + | | | | | | | |
| Al₂O₃)) | | | | | | | |
| SiO₂ + 1.2 × P₂O₅- | 23.87 | 19.87 | 15.88 | 11.87 | 21.87 | 17.88 | 15.87 |
| 3 × Al₂O₃—B₂O₃- | | | | | | | |
| 2 × Li₂O- | | | | | | | |
| 1.5 × Na₂O—K₂O | | | | | | | |
| X | −150 | −121 | −93 | −64 | −120 | −123 | −125 |
| W | −167 | −149 | −131 | −113 | −145 | −154 | −158 |
| | Component | No. | No. | No. | No. | No. | No. |
| | (mol %) | 136 | 137 | 138 | 139 | 140 | 141 |
| | SiO₂ | 66.426 | 66.422 | 64.421 | 64.420 | 55.311 | 69.419 |
| | Al₂O₃ | 11.4 | 9.4 | 11.4 | 9.4 | 16.3 | 10.1 |
| | B₂O₃ | 7.9 | 9.9 | 9.9 | 11.9 | 0.0 | 4.9 |
| | Li₂O | 0.0 | 0.0 | 0.0 | 0.0 | 0.0 | 0.0 |
| | Na₂O | 10.3 | 10.3 | 10.3 | 10.3 | 17.5 | 11.1 |
| | K₂O | 1.0 | 1.0 | 1.0 | 1.0 | 0.0 | 1.0 |
| | MgO | 2.7 | 2.7 | 2.7 | 2.7 | 3.6 | 3.2 |
| | CaO | 0.1 | 0.1 | 0.1 | 0.1 | 0.0 | 0.1 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | ZnO | 0.0 | 0.0 | 0.0 | 0.0 | 0.0 | 0.0 |
| | TiO₂ | 0.002 | 0.002 | 0.002 | 0.002 | 0.002 | 0.002 |
| | ZrO₂ | 0.0 | 0.0 | 0.0 | 0.0 | 0.0 | 0.0 |
| | SnO₂ | 0.1 | 0.1 | 0.1 | 0.1 | 0.1 | 0.1 |
| | Y₂O₃ | 0.0 | 0.0 | 0.0 | 0.0 | 0.0 | 0.0 |
| | Fe₂O₃ | 0.002 | 0.002 | 0.002 | 0.002 | 0.002 | 0.002 |
| | P₂O₅ | 0.0 | 0.0 | 0.0 | 0.0 | 7.1 | 0.0 |
| | SO₃ | 0.000 | 0.000 | 0.000 | 0.000 | 0.000 | 0.000 |
| | Cl | 0.05 | 0.05 | 0.05 | 0.05 | 0.05 | 0.05 |
| | MoO₃ | 0.000 | 0.004 | 0.005 | 0.006 | 0.000 | 0.007 |
| | Sb₂O₃ | 0.000 | 0.000 | 0.000 | 0.000 | 0.000 | 0.000 |
| | Li₂O + Na₂O | 10.3 | 10.3 | 10.3 | 10.3 | 17.5 | 11.1 |
| | Li₂O + MgO | 2.7 | 2.7 | 2.7 | 2.7 | 3.6 | 3.2 |
| | RO | 2.8 | 2.8 | 2.8 | 2.8 | 3.6 | 3.3 |
| | B₂O₃ + MgO + CaO | 10.7 | 12.7 | 12.7 | 14.7 | 3.6 | 8.2 |
| | R₂O | 11.3 | 11.3 | 11.3 | 11.3 | 17.5 | 12.1 |
| | R₂O/Al₂O₃ | 1.0 | 1.2 | 1.0 | 1.2 | 1.1 | 1.2 |
| | RO/R₂O | 0.25 | 0.25 | 0.25 | 0.25 | 0.21 | 0.27 |
| | Al₂O₃/(R₂O + RO) | 0.81 | 0.67 | 0.81 | 0.67 | 0.77 | 0.66 |
| | Na₂O/Li₂O | — | — | — | — | — | — |
| | (ZnO + R₂O)/Al₂O₃ | 0.99 | 1.20 | 0.99 | 1.20 | 1.07 | 1.20 |
| | MgO/Al₂O₃ | 0.24 | 0.29 | 0.24 | 0.29 | 0.22 | 0.32 |
| | (SiO₂ + B₂O₃ + P₂O₅)/ | 0.24 | 0.27 | 0.24 | 0.27 | 0.17 | 0.24 |
| | ((100 × SnO₂) × | | | | | | |
| | (R₂O + RO + ZnO + | | | | | | |
| | Al₂O₃)) | | | | | | |
| | SiO₂ + 1.2 × P₂O₅- | 7.88 | 11.87 | 3.87 | 7.87 | −11.33 | 16.57 |
| | 3 × Al₂O₃—B₂O₃- | | | | | | |
| | 2 × Li₂O- | | | | | | |
| | 1.5 × Na₂O—K₂O | | | | | | |
| | X | −68 | −128 | −71 | −132 | −69 | −117 |
| | W | −122 | −167 | −131 | −176 | −207 | −155 |

TABLE 12

| Component | No. | No. | No. | No. | No. | No. | No. |
|---|---|---|---|---|---|---|---|
| (mol %) | 142 | 143 | 144 | 145 | 146 | 147 | 148 |
| SiO₂ | 67.422 | 65.418 | 65.422 | 67.421 | 65.426 | 69.319 | 67.320 |
| Al₂O₃ | 12.1 | 14.1 | 12.1 | 10.1 | 10.1 | 11.2 | 13.2 |
| B₂O₃ | 4.9 | 4.9 | 6.9 | 6.9 | 8.9 | 4.9 | 4.9 |
| Li₂O | 0.0 | 0.0 | 0.0 | 0.0 | 0.0 | 0.0 | 0.0 |
| Na₂O | 11.1 | 11.1 | 11.1 | 11.1 | 11.1 | 10.1 | 10.1 |
| K₂O | 1.0 | 1.0 | 1.0 | 1.0 | 1.0 | 1.0 | 1.0 |
| MgO | 3.2 | 3.2 | 3.2 | 3.2 | 3.2 | 3.2 | 3.2 |
| CaO | 0.1 | 0.1 | 0.1 | 0.1 | 0.1 | 0.1 | 0.1 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 |
| SnO₂ | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 |
| Cl | 0.05 | 0.05 | 0.05 | 0.05 | 0.05 | 0.05 | 0.05 |
| MoO₃ | 0.004 | 0.008 | 0.004 | 0.005 | 0.000 | 0.007 | 0.006 |
| Sb₂O₃ | 0.000 | 0.000 | 0.000 | 0.000 | 0.000 | 0.000 | 0.000 |
| Li₂O + Na₂O | 11.1 | 11.1 | 11.1 | 11.1 | 11.1 | 10.1 | 10.1 |
| Li₂O + MgO | 3.2 | 3.2 | 3.2 | 3.2 | 3.2 | 3.2 | 3.2 |
| RO | 3.3 | 3.3 | 3.3 | 3.3 | 3.3 | 3.3 | 3.3 |
| B₂O₃ + MgO + CaO | 8.2 | 8.2 | 10.2 | 10.2 | 12.2 | 8.2 | 8.2 |
| R₂O | 12.1 | 12.1 | 12.1 | 12.1 | 12.1 | 11.1 | 11.1 |
| R₂O/Al₂O₃ | 1.0 | 0.9 | 1.0 | 1.2 | 1.2 | 1.0 | 0.8 |
| RO/R₂O | 0.27 | 0.27 | 0.27 | 0.27 | 0.27 | 0.30 | 0.30 |
| Al₂O₃/(R₂O + RO) | 0.79 | 0.92 | 0.79 | 0.66 | 0.66 | 0.78 | 0.92 |
| Na₂O/Li₂O | — | — | — | — | — | — | — |
| (ZnO + R₂O)/Al₂O₃ | 1.00 | 0.86 | 1.00 | 1.20 | 1.20 | 0.99 | 0.84 |
| MgO/Al₂O₃ | 0.26 | 0.23 | 0.26 | 0.32 | 0.32 | 0.29 | 0.24 |
| (SiO₂ + B₂O₃ + P₂O₅)/ | 0.22 | 0.20 | 0.22 | 0.24 | 0.24 | 0.24 | 0.22 |
| ((100 × SnO₂) × | | | | | | | |
| (R₂O + RO + ZnO + | | | | | | | |
| Al₂O₃)) | | | | | | | |
| SiO₂ + 1.2 × P₂O₅- | 8.57 | 0.57 | 4.57 | 12.57 | 8.58 | 14.67 | 6.67 |
| 3 × Al₂O₃—B₂O₃- | | | | | | | |
| 2 × Li₂O- | | | | | | | |
| 1.5 × Na₂O—K₂O | | | | | | | |
| X | −60 | −3 | −64 | −121 | −124 | −63 | −6 |
| W | −119 | −83 | −128 | −164 | −173 | −106 | −69 |
| | Component | No. | No. | No. | No. | No. | No. |
| | (mol %) | 149 | 150 | 151 | 152 | 153 | 154 |
| | SiO₂ | 65.326 | 67.321 | 65.322 | 65.326 | 64.923 | 64.422 |
| | Al₂O₃ | 15.2 | 11.2 | 13.2 | 11.2 | 12.1 | 12.1 |
| | B₂O₃ | 4.9 | 6.9 | 6.9 | 8.9 | 6.9 | 6.9 |
| | Li₂O | 0.0 | 0.0 | 0.0 | 0.0 | 0.0 | 0.0 |
| | Na₂O | 10.1 | 10.1 | 10.1 | 10.1 | 11.1 | 11.1 |
| | K₂O | 1.0 | 1.0 | 1.0 | 1.0 | 1.0 | 1.0 |
| | MgO | 3.2 | 3.2 | 3.2 | 3.2 | 3.2 | 3.2 |
| | CaO | 0.1 | 0.1 | 0.1 | 0.1 | 0.6 | 1.1 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | ZnO | 0.0 | 0.0 | 0.0 | 0.0 | 0.0 | 0.0 |
| | TiO₂ | 0.002 | 0.002 | 0.002 | 0.002 | 0.002 | 0.002 |
| | ZrO₂ | 0.0 | 0.0 | 0.0 | 0.0 | 0.0 | 0.0 |
| | SnO₂ | 0.1 | 0.1 | 0.1 | 0.1 | 0.1 | 0.1 |
| | Y₂O₃ | 0.0 | 0.0 | 0.0 | 0.0 | 0.0 | 0.0 |
| | Fe₂O₃ | 0.002 | 0.002 | 0.002 | 0.002 | 0.002 | 0.002 |
| | P₂O₅ | 0.0 | 0.0 | 0.0 | 0.0 | 0.0 | 0.0 |
| | SO₃ | 0.000 | 0.000 | 0.000 | 0.000 | 0.000 | 0.000 |
| | Cl | 0.05 | 0.05 | 0.05 | 0.05 | 0.05 | 0.05 |
| | MoO₃ | 0.000 | 0.005 | 0.004 | 0.000 | 0.003 | 0.004 |
| | Sb₂O₃ | 0.000 | 0.000 | 0.000 | 0.000 | 0.000 | 0.000 |
| | Li₂O + Na₂O | 10.1 | 10.1 | 10.1 | 10.1 | 11.1 | 11.1 |
| | Li₂O + MgO | 3.2 | 3.2 | 3.2 | 3.2 | 3.2 | 3.2 |
| | RO | 3.3 | 3.3 | 3.3 | 3.3 | 3.8 | 4.3 |
| | B₂O₃ + MgO + CaO | 8.2 | 10.2 | 10.2 | 12.2 | 10.7 | 11.2 |
| | R₂O | 11.1 | 11.1 | 11.1 | 11.1 | 12.1 | 12.1 |
| | R₂O/Al₂O₃ | 0.7 | 1.0 | 0.8 | 1.0 | 1.0 | 1.0 |
| | RO/R₂O | 0.30 | 0.30 | 0.30 | 0.30 | 0.31 | 0.36 |
| | Al₂O₃/(R₂O + RO) | 1.06 | 0.78 | 0.92 | 0.78 | 0.76 | 0.74 |
| | Na₂O/Li₂O | — | — | — | — | — | — |
| | (ZnO + R₂O)/Al₂O₃ | 0.73 | 0.99 | 0.84 | 0.99 | 1.00 | 1.00 |
| | MgO/Al₂O₃ | 0.21 | 0.29 | 0.24 | 0.29 | 0.26 | 0.26 |
| | (SiO₂ + B₂O₃ + P₂O₅)/ | 0.20 | 0.24 | 0.22 | 0.24 | 0.21 | 0.21 |
| | ((100 × SnO₂) × | | | | | | |
| | (R₂O + RO + ZnO + | | | | | | |
| | Al₂O₃)) | | | | | | |
| | SiO₂ + 1.2 × P₂O₅- | −1.32 | 10.67 | 2.67 | 6.68 | 4.07 | 3.57 |
| | 3 × Al₂O₃—B₂O₃- | | | | | | |
| | 2 × Li₂O- | | | | | | |
| | 1.5 × Na₂O—K₂O | | | | | | |
| | X | 51 | −67 | −10 | −70 | −62 | −60 |
| | W | −33 | −115 | −78 | −124 | −133 | −138 |

TABLE 13

| Component | No. | No. | No. | No. | No. | No. | No. |
|---|---|---|---|---|---|---|---|
| (mol %) | 155 | 156 | 157 | 158 | 159 | 160 | 161 |
| SiO₂ | 66.922 | 66.420 | 73.000 | 73.500 | 62.800 | 74.600 | 77.770 |
| Al₂O₃ | 10.1 | 10.1 | 6.8 | 6.8 | 13.5 | 6.8 | 7.2 |
| B₂O₃ | 6.9 | 6.9 | 1.6 | 0.6 | 2.6 | 0.6 | 0.1 |
| Li₂O | 0.0 | 0.0 | 0.0 | 0.0 | 0.5 | 0.0 | 6.1 |
| Na₂O | 11.1 | 11.1 | 12.8 | 12.2 | 12.8 | 12.2 | 1.8 |
| K₂O | 1.0 | 1.0 | 0.7 | 0.7 | 1.6 | 0.7 | 2.7 |
| MgO | 3.2 | 3.2 | 4.9 | 4.8 | 4.8 | 4.9 | 0.0 |
| CaO | 0.6 | 1.1 | 0.0 | 1.2 | 1.2 | 0.0 | 3.7 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 |
| TiO₂ | 0.002 | 0.002 | 0.000 | 0.000 | 0.000 | 0.000 | 0.000 |
| ZrO₂ | 0.0 | 0.0 | 0.0 | 0.0 | 0.0 | 0.0 | 0.5 |
| SnO₂ | 0.1 | 0.1 | 0.2 | 0.2 | 0.2 | 0.2 | 0.1 |
| Y₂O₃ | 0.0 | 0.0 | 0.0 | 0.0 | 0.0 | 0.0 | 0.0 |
| Fe₂O₃ | 0.002 | 0.002 | 0.000 | 0.000 | 0.000 | 0.000 | 0.000 |
| P₂O₅ | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 |
| Cl | 0.05 | 0.05 | 0.00 | 0.00 | 0.00 | 0.00 | 0.00 |
| MoO₃ | 0.004 | 0.006 | 0.000 | 0.000 | 0.000 | 0.000 | 0.000 |
| Sb₂O₃ | 0.000 | 0.000 | 0.000 | 0.000 | 0.000 | 0.000 | 0.000 |
| Li₂O + Na₂O | 11.1 | 11.1 | 12.8 | 12.2 | 13.3 | 12.2 | 7.9 |
| Li₂O + MgO | 3.2 | 3.2 | 4.9 | 4.8 | 5.3 | 4.9 | 6.1 |
| RO | 3.8 | 4.3 | 4.9 | 6.0 | 6.0 | 4.9 | 3.7 |
| B₂O₃ + MgO + CaO | 10.7 | 11.2 | 6.5 | 6.6 | 8.6 | 5.5 | 3.7 |
| R₂O | 12.1 | 12.1 | 13.5 | 12.9 | 14.9 | 12.9 | 10.6 |
| R₂O/Al₂O₃ | 1.2 | 1.2 | 2.0 | 1.9 | 1.1 | 1.9 | 1.5 |
| RO/R₂O | 0.31 | 0.36 | 0.36 | 0.47 | 0.40 | 0.38 | 0.34 |
| Al₂O₃/(R₂O + RO) | 0.64 | 0.62 | 0.37 | 0.36 | 0.65 | 0.38 | 0.51 |
| Na₂O/Li₂O | — | — | — | — | 25.60 | — | 0.29 |
| (ZnO + R₂O)/Al₂O₃ | 1.20 | 1.20 | 1.99 | 1.90 | 1.10 | 1.90 | 1.47 |
| MgO/Al₂O₃ | 0.32 | 0.32 | 0.72 | 0.71 | 0.36 | 0.72 | 0.00 |
| (SiO₂ + B₂O₃ + PaO₅)/ | 0.24 | 0.23 | 0.65 | 0.65 | 0.65 | 0.65 | 0.65 |
| ((100 × SnO₂) × | | | | | | | |
| (R₂O + RO + ZnO + | | | | | | | |
| Al₂O₃)) | | | | | | | |
| SiO₂ + 1.2 × P₂O₅- | 12.07 | 11.57 | 4.66 | 4.66 | 4.66 | 4.66 | 4.66 |
| 3 × Al₂O₃—B₂O₃- | | | | | | | |
| 2 × Li₂O- | | | | | | | |
| 1.5 × Na₂O—K₂O | | | | | | | |
| X | −119 | −116 | −243 | −223 | −23 | −228 | 343 |
| W | −169 | −174 | −246 | −237 | −122 | −224 | 300 |
| | Component | No. | No. | No. | No. | No. | No. |
| | (mol %) | 162 | 163 | 164 | 165 | 166 | 167 |
| | SiO₂ | 77.82 | 77.82 | 76.90 | 80.00 | 80.00 | 80.00 |
| | Al₂O₃ | 7.23 | 7.23 | 7.21 | 5.00 | 5.00 | 5.00 |
| | B₂O₃ | 0.09 | 0.09 | 0.09 | 0.10 | 0.10 | 0.10 |
| | Li₂O | 4.10 | 2.10 | 3.10 | 3.50 | 4.80 | 3.50 |
| | Na₂O | 3.78 | 5.80 | 5.74 | 2.70 | 1.40 | 1.40 |
| | K₂O | 2.71 | 2.70 | 2.69 | 4.50 | 4.50 | 5.80 |
| | MgO | 0.00 | 0.00 | 0.00 | 0.00 | 0.00 | 0.00 |
| | CaO | 3.65 | 3.64 | 3.66 | 3.6 | 3.6 | 3.6 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | ZnO | 0.0 | 0.0 | 0.0 | 0.0 | 0.0 | 0.0 |
| | TiO₂ | 0.000 | 0.000 | 0.000 | 0.000 | 0.000 | 0.000 |
| | ZrO₂ | 0.52 | 0.52 | 0.52 | 0.5 | 0.5 | 0.5 |
| | SnO₂ | 0.1 | 0.1 | 0.1 | 0.1 | 0.1 | 0.1 |
| | Y₂O₃ | 0.0 | 0.0 | 0.0 | 0.0 | 0.0 | 0.0 |
| | Fe₂O₃ | 0.000 | 0.000 | 0.000 | 0.000 | 0.000 | 0.000 |
| | P₂O₅ | 0.0 | 0.0 | 0.0 | 0.0 | 0.0 | 0.0 |
| | SO₃ | 0.000 | 0.000 | 0.000 | 0.000 | 0.000 | 0.000 |
| | Cl | 0.00 | 0.00 | 0.00 | 0.00 | 0.00 | 0.00 |
| | MoO₃ | 0.000 | 0.000 | 0.000 | 0.000 | 0.000 | 0.000 |
| | Sb₂O₃ | 0.000 | 0.000 | 0.000 | 0.000 | 0.000 | 0.000 |
| | Li₂O + Na₂O | 7.9 | 7.9 | 8.8 | 6.2 | 6.2 | 4.9 |
| | Li₂O + MgO | 4.1 | 2.1 | 3.1 | 3.5 | 4.8 | 3.5 |
| | RO | 3.7 | 3.6 | 3.7 | 3.6 | 3.6 | 3.6 |
| | B₂O₃ + MgO + CaO | 3.7 | 3.7 | 3.8 | 3.7 | 3.7 | 3.7 |
| | R₂O | 10.6 | 10.6 | 11.5 | 10.7 | 10.7 | 10.7 |
| | R₂O/Al₂O₃ | 1.5 | 1.5 | 1.6 | 2.1 | 2.1 | 2.1 |
| | RO/R₂O | 0.34 | 0.34 | 0.32 | 0.34 | 0.34 | 0.34 |
| | Al₂O₃/(R₂O + RO) | 0.51 | 0.51 | 0.47 | 0.35 | 0.35 | 0.35 |
| | Na₂O/Li₂O | 0.92 | 2.76 | 1.85 | 0.77 | 0.29 | 0.40 |
| | (ZnO + R₂O)/Al₂O₃ | 1.46 | 1.47 | 1.60 | 2.14 | 2.14 | 2.14 |
| | MgO/Al₂O₃ | 0.00 | 0.00 | 0.00 | 0.00 | 0.00 | 0.00 |
| | (SiO₂ + B₂O₃ + PaO₅)/ | 0.65 | 0.65 | 0.65 | 0.65 | 0.65 | 0.65 |
| | ((100 × SnO₂) × | | | | | | |
| | (R₂O + RO + ZnO + | | | | | | |
| | Al₂O₃)) | | | | | | |
| | SiO₂ + 1.2 × P₂O₅- | 4.66 | 4.66 | 4.66 | 4.66 | 4.66 | 4.66 |
| | 3 × Al₂O₃—B₂O₃- | | | | | | |
| | 2 × Li₂O- | | | | | | |
| | 1.5 × Na₂O—K₂O | | | | | | |
| | X | 196 | 50 | 101 | 130 | 224 | 161 |
| | W | 157 | 16 | 58 | 124 | 216 | 162 |

TABLE 14

| | No. | No. | No. | No. | No. | No. | No. |
|---|---|---|---|---|---|---|---|
| Component (mol %) | 168 | 169 | 170 | 171 | 172 | 173 | 174 |
| SiO₂ | 80.00 | 80.00 | 73.80 | 73.80 | 73.80 | 75.80 | 75.80 |
| Al₂O₃ | 5.00 | 5.00 | 7.20 | 7.20 | 7.20 | 7.20 | 7.20 |
| B₂O₃ | 0.10 | 0.10 | 0.10 | 0.10 | 0.10 | 0.10 | 0.10 |
| Li₂O | 4.80 | 6.10 | 8.10 | 6.10 | 4.10 | 6.10 | 4.10 |
| Na₂O | 0.10 | 0.10 | 3.80 | 5.80 | 7.80 | 3.80 | 5.80 |
| K₂O | 5.80 | 4.50 | 2.70 | 2.70 | 2.70 | 2.70 | 2.70 |
| MgO | 0.00 | 0.00 | 0.00 | 0.00 | 0.00 | 0.00 | 0.00 |
| CaO | 3.6 | 3.6 | 3.7 | 3.7 | 3.7 | 3.7 | 3.7 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 |
| TiO₂ | 0.000 | 0.000 | 0.000 | 0.000 | 0.000 | 0.000 | 0.000 |
| ZrO₂ | 0.5 | 0.5 | 0.5 | 0.5 | 0.5 | 0.5 | 0.5 |
| SnO₂ | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 |
| Fe₂O₃ | 0.000 | 0.000 | 0.000 | 0.000 | 0.000 | 0.000 | 0.000 |
| P₂O₅ | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 |
| Cl | 0.00 | 0.00 | 0.00 | 0.00 | 0.00 | 0.00 | 0.00 |
| MoO₃ | 0.000 | 0.000 | 0.000 | 0.000 | 0.000 | 0.000 | 0.000 |
| Sb₂O₃ | 0.000 | 0.000 | 0.000 | 0.000 | 0.000 | 0.000 | 0.000 |
| Li₂O + Na₂O | 4.9 | 6.2 | 11.9 | 11.9 | 11.9 | 9.9 | 9.9 |
| Li₂O + MgO | 4.8 | 6.1 | 8.1 | 6.1 | 4.1 | 6.1 | 4.1 |
| RO | 3.6 | 3.6 | 3.7 | 3.7 | 3.7 | 3.7 | 3.7 |
| B₂O₃ + MgO + CaO | 3.7 | 3.7 | 3.8 | 3.8 | 3.8 | 3.8 | 3.8 |
| R₂O | 10.7 | 10.7 | 14.6 | 14.6 | 14.6 | 12.6 | 12.6 |
| R₂O/Al₂O₃ | 2.1 | 2.1 | 2.0 | 2.0 | 2.0 | 1.8 | 1.8 |
| RO/R₂O | 0.34 | 0.34 | 0.25 | 0.25 | 0.25 | 0.29 | 0.29 |
| Al₂O₃/(R₂O + RO) | 0.35 | 0.35 | 0.39 | 0.39 | 0.39 | 0.44 | 0.44 |
| Na₂O/Li₂O | 0.02 | 0.02 | 0.47 | 0.95 | 1.90 | 0.62 | 1.41 |
| (ZnO + R₂O)/Al₂O₃ | 2.14 | 2.14 | 2.03 | 2.03 | 2.03 | 1.75 | 1.75 |
| MgO/Al₂O₃ | 0.00 | 0.00 | 0.00 | 0.00 | 0.00 | 0.00 | 0.00 |
| (SiO₂ + B₂O₃ + P₂O₅)/ | 0.65 | 0.65 | 0.65 | 0.65 | 0.65 | 0.65 | 0.65 |
| ((100 × SnO₂) × (R₂O + | | | | | | | |
| RO + ZnO + Al₂O₃)) | | | | | | | |
| SiO₂ + 1.2 × P₂O₅-3 × | 4.66 | 4.66 | 4.66 | 4.66 | 4.66 | 4.66 | 4.66 |
| Al₂O₃—B₂O₃-2 × | | | | | | | |
| Li₂O-1.5 × Na₂O—K₂O | | | | | | | |
| X | 256 | 319 | 395 | 249 | 104 | 295 | 149 |
| W | 254 | 308 | 321 | 180 | 38 | 238 | 97 |
| | | No. | No. | No. | No. | No. | No. |
| | Component (mol %) | 175 | 176 | 177 | 178 | 179 | 180 |
| | SiO₂ | 77.80 | 77.80 | 77.90 | 76.90 | 76.80 | 76.80 |
| | Al₂O₃ | 7.20 | 7.20 | 7.20 | 7.20 | 7.20 | 7.20 |
| | B₂O₃ | 0.10 | 0.10 | 0.10 | 0.10 | 0.10 | 0.10 |
| | Li₂O | 6.10 | 4.10 | 2.10 | 3.10 | 4.10 | 4.60 |
| | Na₂O | 1.80 | 3.80 | 5.80 | 5.70 | 4.80 | 4.30 |
| | K₂O | 2.70 | 2.70 | 2.70 | 2.70 | 2.70 | 2.70 |
| | MgO | 0.00 | 0.00 | 0.00 | 0.00 | 0.00 | 0.00 |
| | CaO | 3.7 | 3.7 | 3.6 | 3.7 | 3.7 | 3.7 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | ZnO | 0.0 | 0.0 | 0.0 | 0.0 | 0.0 | 0.0 |
| | TiO₂ | 0.000 | 0.000 | 0.000 | 0.000 | 0.000 | 0.000 |
| | ZrO₂ | 0.5 | 0.5 | 0.5 | 0.5 | 0.5 | 0.5 |
| | SnO₂ | 0.1 | 0.1 | 0.1 | 0.1 | 0.1 | 0.1 |
| | Y₂O₃ | 0.0 | 0.0 | 0.0 | 0.0 | 0.0 | 0.0 |
| | Fe₂O₃ | 0.000 | 0.000 | 0.000 | 0.000 | 0.000 | 0.000 |
| | P₂O₅ | 0.0 | 0.0 | 0.0 | 0.0 | 0.0 | 0.0 |
| | SO₃ | 0.000 | 0.000 | 0.000 | 0.000 | 0.000 | 0.000 |
| | Cl | 0.00 | 0.00 | 0.00 | 0.00 | 0.00 | 0.00 |
| | MoO₃ | 0.000 | 0.000 | 0.000 | 0.000 | 0.000 | 0.000 |
| | Sb₂O₃ | 0.000 | 0.000 | 0.000 | 0.000 | 0.000 | 0.000 |
| | Li₂O + Na₂O | 7.9 | 7.9 | 7.9 | 8.8 | 8.9 | 8.9 |
| | Li₂O + MgO | 6.1 | 4.1 | 2.1 | 3.1 | 4.1 | 4.6 |
| | RO | 3.7 | 3.7 | 3.6 | 3.7 | 3.7 | 3.7 |
| | B₂O₃ + MgO + CaO | 3.8 | 3.8 | 3.7 | 3.8 | 3.8 | 3.8 |
| | R₂O | 10.6 | 10.6 | 10.6 | 11.5 | 11.6 | 11.6 |
| | R₂O/Al₂O₃ | 1.5 | 1.5 | 1.5 | 1.6 | 1.6 | 1.6 |
| | RO/R₂O | 0.35 | 0.35 | 0.34 | 0.32 | 0.32 | 0.32 |
| | Al₂O₃/(R₂O + RO) | 0.50 | 0.50 | 0.51 | 0.47 | 0.47 | 0.47 |
| | Na₂O/Li₂O | 0.30 | 0.93 | 2.76 | 1.84 | 1.17 | 0.93 |
| | (ZnO + R₂O)/Al₂O₃ | 1.47 | 1.47 | 1.47 | 1.60 | 1.61 | 1.61 |
| | MgO/Al₂O₃ | 0.00 | 0.00 | 0.00 | 0.00 | 0.00 | 0.00 |
| | (SiO₂ + B₂O₃ + P₂O₅)/ | 0.65 | 0.65 | 0.65 | 0.65 | 0.65 | 0.65 |
| | ((100 × SnO₂) × (R₂O + | | | | | | |
| | RO + ZnO + Al₂O₃)) | | | | | | |
| | SiO₂ + 1.2 × P₂O₅-3 × | 4.66 | 4.66 | 4.66 | 4.66 | 4.66 | 4.66 |
| | Al₂O₃—B₂O₃-2 × | | | | | | |
| | Li₂O-1.5 × Na₂O—K₂O | | | | | | |
| | X | 341 | 195 | 49 | 101 | 172 | 208 |
| | W | 297 | 156 | 15 | 59 | 126 | 162 |

TABLE 15

| Component | No. | No. | No. | No. | No. | No. | No. | No. | No. | No. | No. | No. | No. |
|---|---|---|---|---|---|---|---|---|---|---|---|---|---|
| (mol %) | 181 | 182 | 183 | 184 | 185 | 186 | 187 | 188 | 189 | 190 | 191 | 192 | 193 |
| SiO₂ | 76.70 | 76.70 | 76.60 | 75.80 | 75.60 | 77.00 | 77.00 | 78.51 | 80.00 | 80.00 | 80.00 | 80.00 | 80.00 |
| Al₂O₃ | 7.30 | 7.20 | 7.30 | 7.20 | 7.30 | 6.00 | 6.00 | 5.50 | 5.00 | 5.00 | 5.00 | 5.00 | 5.00 |
| B₂O₃ | 0.10 | 0.10 | 0.10 | 0.10 | 0.10 | 0.10 | 0.10 | 0.09 | 0.10 | 0.10 | 0.10 | 0.10 | 0.10 |
| Li₂O | 5.10 | 6.10 | 7.10 | 5.10 | 7.10 | 6.10 | 8.10 | 7.09 | 6.10 | 6.10 | 4.80 | 3.50 | 3.50 |
| Na₂O | 3.80 | 2.90 | 1.90 | 4.80 | 2.90 | 3.90 | 1.90 | 1.91 | 1.90 | 1.40 | 2.70 | 4.00 | 2.70 |
| K₂O | 2.70 | 2.70 | 2.70 | 2.70 | 2.70 | 2.70 | 2.70 | 2.70 | 2.70 | 3.20 | 3.20 | 3.20 | 4.50 |
| MgO | 0.00 | 0.00 | 0.00 | 0.00 | 0.00 | 0.00 | 0.00 | 0.00 | 0.00 | 0.00 | 0.00 | 0.00 | 0.00 |
| CaO | 3.7 | 3.7 | 3.7 | 3.7 | 3.7 | 3.6 | 3.6 | 3.6 | 3.6 | 3.6 | 3.6 | 3.6 | 3.6 |
| SrO | 0.0 | 0.0 | 0.0 | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 | 0.0 | 0.0 | 0.0 |
| TiO₂ | 0.000 | 0.000 | 0.000 | 0.000 | 0.000 | 0.000 | 0.000 | 0.000 | 0.000 | 0.000 | 0.000 | 0.000 | 0.000 |
| ZrO₂ | 0.5 | 0.5 | 0.5 | 0.5 | 0.5 | 0.5 | 0.5 | 0.5 | 0.5 | 0.5 | 0.5 | 0.5 | 0.5 |
| SnO₂ | 0.1 | 0.1 | 0.1 | 0.1 | 0.1 | 0.1 | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 | 0.0 | 0.0 | 0.0 | 0.0 | 0.0 | 0.0 |
| Fe₂O₃ | 0.000 | 0.000 | 0.000 | 0.000 | 0.000 | 0.000 | 0.000 | 0.000 | 0.000 | 0.000 | 0.000 | 0.000 | 0.000 |
| P₂O₅ | 0.0 | 0.0 | 0.0 | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 | 0.000 | 0.000 | 0.000 |
| Cl | 0.00 | 0.00 | 0.00 | 0.00 | 0.00 | 0.00 | 0.00 | 0.00 | 0.00 | 0.00 | 0.00 | 0.00 | 0.00 |
| MoO₃ | 0.000 | 0.000 | 0.000 | 0.000 | 0.000 | 0.000 | 0.000 | 0.000 | 0.000 | 0.000 | 0.000 | 0.000 | 0.000 |
| Sb₂O₃ | 0.000 | 0.000 | 0.000 | 0.000 | 0.000 | 0.000 | 0.000 | 0.000 | 0.000 | 0.000 | 0.000 | 0.000 | 0.000 |
| Li₂O + Na₂O | 8.9 | 9.0 | 9.0 | 9.9 | 10.0 | 10.0 | 10.0 | 9.0 | 8.0 | 7.5 | 7.5 | 7.5 | 6.2 |
| Li₂O + MgO | 5.1 | 6.1 | 7.1 | 5.1 | 7.1 | 6.1 | 8.1 | 7.1 | 6.1 | 6.1 | 4.8 | 3.5 | 3.5 |
| RO | 3.7 | 3.7 | 3.7 | 3.7 | 3.7 | 3.6 | 3.6 | 3.6 | 3.6 | 3.6 | 3.6 | 3.6 | 3.6 |
| B₂O₃ + MgO + CaO | 3.8 | 3.8 | 3.8 | 3.8 | 3.8 | 3.7 | 3.7 | 3.7 | 3.7 | 3.7 | 3.7 | 3.7 | 3.7 |
| R₂O | 11.6 | 11.7 | 11.7 | 12.6 | 12.7 | 12.7 | 12.7 | 11.7 | 10.7 | 10.7 | 10.7 | 10.7 | 10.7 |
| R₂O/Al₂O₃ | 1.6 | 1.6 | 1.6 | 1.8 | 1.7 | 2.1 | 2.1 | 2.1 | 2.1 | 2.1 | 2.1 | 2.1 | 2.1 |
| RO/R₂O | 0.32 | 0.32 | 0.32 | 0.29 | 0.29 | 0.28 | 0.28 | 0.31 | 0.34 | 0.34 | 0.34 | 0.34 | 0.34 |
| Al₂O₃/(R₂O + RO) | 0.48 | 0.47 | 0.47 | 0.44 | 0.45 | 0.37 | 0.37 | 0.36 | 0.35 | 0.35 | 0.35 | 0.35 | 0.35 |
| Na₂O/Li₂O | 0.75 | 0.48 | 0.27 | 0.94 | 0.41 | 0.64 | 0.23 | 0.27 | 0.31 | 0.23 | 0.56 | 1.14 | 0.77 |
| (ZnO + R₂O)/Al₂O₃ | 1.59 | 1.63 | 1.60 | 1.75 | 1.74 | 2.12 | 2.12 | 2.13 | 2.14 | 2.14 | 2.14 | 2.14 | 2.14 |
| MgO/Al₂O₃ | 0.00 | 0.00 | 0.00 | 0.00 | 0.00 | 0.00 | 0.00 | 0.00 | 0.00 | 0.00 | 0.00 | 0.00 | 0.00 |
| (SiO₂ + B₂O₃ + P₂O₅)/ | 0.65 | 0.65 | 0.65 | 0.65 | 0.65 | 0.65 | 0.65 | 0.65 | 0.65 | 0.65 | 0.65 | 0.65 | 0.65 |
| ((100 × SnO₂) × | | | | | | | | | | | | | |
| (R₂O + RO + ZnO + | | | | | | | | | | | | | |
| Al₂O₃)) | | | | | | | | | | | | | |
| SiO₂ + 1.2 × P₂O₅- | 4.66 | 4.66 | 4.66 | 4.66 | 4.66 | 4.66 | 4.66 | 4.66 | 4.66 | 4.66 | 4.66 | 4.66 | 4.66 |
| 3 × Al₂O₃—B₂O₃- | | | | | | | | | | | | | |
| 2 × Li₂O- | | | | | | | | | | | | | |
| 1.5 × Na₂O—K₂O | | | | | | | | | | | | | |
| X | 248 | 316 | 391 | 222 | 368 | 258 | 404 | 339 | 275 | 287 | 193 | 98 | 130 |
| W | 199 | 265 | 337 | 168 | 308 | 215 | 356 | 305 | 256 | 270 | 178 | 86 | 124 |

TABLE 16

| | No. | No. | No. | No. | No. | No. | No. |
|---|---|---|---|---|---|---|---|
| Component (mol %) | 194 | 195 | 196 | 197 | 198 | 199 | 200 |
| SiO₂ | 80.00 | 80.00 | 80.00 | 80.00 | 79.50 | 79.00 | 78.40 |
| Al₂O₃ | 5.00 | 5.00 | 5.00 | 5.00 | 5.10 | 5.30 | 5.50 |
| B₂O₃ | 0.10 | 0.10 | 0.10 | 0.10 | 0.10 | 0.10 | 0.10 |
| Li₂O | 4.80 | 3.50 | 4.80 | 6.10 | 5.00 | 5.10 | 5.30 |
| Na₂O | 1.40 | 1.40 | 0.10 | 0.10 | 2.80 | 2.90 | 3.00 |
| K₂O | 4.50 | 5.80 | 5.80 | 4.50 | 3.30 | 3.40 | 3.50 |
| MgO | 0.00 | 0.00 | 0.00 | 0.00 | 0.00 | 0.00 | 0.00 |
| CaO | 3.6 | 3.6 | 3.6 | 3.6 | 3.6 | 3.6 | 3.6 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 |
| TiO₂ | 0.000 | 0.000 | 0.000 | 0.000 | 0.000 | 0.000 | 0.000 |
| ZrO₂ | 0.5 | 0.5 | 0.5 | 0.5 | 0.5 | 0.5 | 0.5 |
| SnO₂ | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 |
| Fe₂O₃ | 0.000 | 0.000 | 0.000 | 0.000 | 0.000 | 0.000 | 0.000 |
| P₂O₅ | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 |
| Cl | 0.00 | 0.00 | 0.00 | 0.00 | 0.00 | 0.00 | 0.00 |
| MoO₃ | 0.000 | 0.000 | 0.000 | 0.000 | 0.000 | 0.000 | 0.000 |
| Sb₂O₃ | 0.000 | 0.000 | 0.000 | 0.000 | 0.000 | 0.000 | 0.000 |
| Li₂O + Na₂O | 6.2 | 4.9 | 4.9 | 6.2 | 7.8 | 8.0 | 8.3 |
| Li₂O + MgO | 4.8 | 3.5 | 4.8 | 6.1 | 5.0 | 5.1 | 5.3 |
| RO | 3.6 | 3.6 | 3.6 | 3.6 | 3.6 | 3.6 | 3.6 |
| B₂O₃ + MgO + CaO | 3.7 | 3.7 | 3.7 | 3.7 | 3.7 | 3.7 | 3.7 |
| R₂O | 10.7 | 10.7 | 10.7 | 10.7 | 11.1 | 11.4 | 11.8 |
| R₂O/Al₂O₃ | 2.1 | 2.1 | 2.1 | 2.1 | 2.2 | 2.2 | 2.1 |
| RO/R₂O | 0.34 | 0.34 | 0.34 | 0.34 | 0.32 | 0.32 | 0.31 |
| Al₂O₃/(R₂O + RO) | 0.35 | 0.35 | 0.35 | 0.35 | 0.35 | 0.35 | 0.36 |
| Na₂O/Li₂O | 0.29 | 0.40 | 0.02 | 0.02 | 0.56 | 0.57 | 0.57 |
| (ZnO + R₂O)/Al₂O₃ | 2.14 | 2.14 | 2.14 | 2.14 | 2.18 | 2.15 | 2.15 |
| MgO/Al₂O₃ | 0.00 | 0.00 | 0.00 | 0.00 | 0.00 | 0.00 | 0.00 |
| (SiO₂ + B₂O₃ + P₂O₅)/ | 0.65 | 0.65 | 0.65 | 0.65 | 0.65 | 0.65 | 0.65 |
| ((100 × SnO₂) × (R₂O + | | | | | | | |
| RO + ZnO + Al₂O₃)) | | | | | | | |
| SiO₂ + 1.2 × P₂O₅-3 × | 4.66 | 4.66 | 4.66 | 4.66 | 4.66 | 4.66 | 4.66 |
| Al₂O₃—B₂O₃-2 × | | | | | | | |
| Li₂O-1.5 × Na₂O—K₂O | | | | | | | |
| X | 224 | 161 | 256 | 319 | 203 | 212 | 226 |
| W | 216 | 162 | 254 | 308 | 185 | 190 | 199 |
| | | No. | No. | No. | No. | No. | No. |
| | Component (mol %) | 201 | 202 | 203 | 204 | 205 | 206 |
| | SiO₂ | 78.80 | 78.00 | 78.00 | 78.00 | 78.00 | 79.00 |
| | Al₂O₃ | 5.00 | 5.00 | 5.00 | 5.00 | 5.00 | 5.30 |
| | B₂O₃ | 0.10 | 0.10 | 0.10 | 0.10 | 0.10 | 0.10 |
| | Li₂O | 5.10 | 6.10 | 5.70 | 5.50 | 8.00 | 4.80 |
| | Na₂O | 4.00 | 3.40 | 3.20 | 4.40 | 2.00 | 2.70 |
| | K₂O | 2.70 | 3.20 | 3.80 | 2.80 | 2.70 | 3.90 |
| | MgO | 0.00 | 0.00 | 0.00 | 0.00 | 0.00 | 0.00 |
| | CaO | 3.7 | 3.6 | 3.6 | 3.6 | 3.6 | 3.6 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | ZnO | 0.0 | 0.0 | 0.0 | 0.0 | 0.0 | 0.0 |
| | TiO₂ | 0.000 | 0.000 | 0.000 | 0.000 | 0.000 | 0.000 |
| | ZrO₂ | 0.5 | 0.5 | 0.5 | 0.5 | 0.5 | 0.5 |
| | SnO₂ | 0.1 | 0.1 | 0.1 | 0.1 | 0.1 | 0.1 |
| | Y₂O₃ | 0.0 | 0.0 | 0.0 | 0.0 | 0.0 | 0.0 |
| | Fe₂O₃ | 0.000 | 0.000 | 0.000 | 0.000 | 0.000 | 0.000 |
| | P₂O₅ | 0.0 | 0.0 | 0.0 | 0.0 | 0.0 | 0.0 |
| | SO₃ | 0.000 | 0.000 | 0.000 | 0.000 | 0.000 | 0.000 |
| | Cl | 0.00 | 0.00 | 0.00 | 0.00 | 0.00 | 0.00 |
| | MoO₃ | 0.000 | 0.000 | 0.000 | 0.000 | 0.000 | 0.000 |
| | Sb₂O₃ | 0.000 | 0.000 | 0.000 | 0.000 | 0.000 | 0.000 |
| | Li₂O + Na₂O | 9.1 | 9.5 | 8.9 | 9.9 | 10.0 | 7.5 |
| | Li₂O + MgO | 5.1 | 6.1 | 5.7 | 5.5 | 8.0 | 4.8 |
| | RO | 3.7 | 3.6 | 3.6 | 3.6 | 3.6 | 3.6 |
| | B₂O₃ + MgO + CaO | 3.8 | 3.7 | 3.7 | 3.7 | 3.7 | 3.7 |
| | R₂O | 11.8 | 12.7 | 12.7 | 12.7 | 12.7 | 11.4 |
| | R₂O/Al₂O₃ | 2.4 | 2.5 | 2.5 | 2.5 | 2.5 | 2.2 |
| | RO/R₂O | 0.31 | 0.28 | 0.28 | 0.28 | 0.28 | 0.32 |
| | Al₂O₃/(R₂O + RO) | 0.32 | 0.31 | 0.31 | 0.31 | 0.31 | 0.35 |
| | Na₂O/Li₂O | 0.78 | 0.56 | 0.56 | 0.80 | 0.25 | 0.56 |
| | (ZnO + R₂O)/Al₂O₃ | 2.36 | 2.54 | 2.54 | 2.54 | 2.54 | 2.15 |
| | MgO/Al₂O₃ | 0.00 | 0.00 | 0.00 | 0.00 | 0.00 | 0.00 |
| | (SiO₂ + B₂O₃ + P₂O₅)/ | 0.65 | 0.65 | 0.65 | 0.65 | 0.65 | 0.65 |
| | ((100 × SnO₂) × (R₂O + | | | | | | |
| | RO + ZnO + Al₂O₃)) | | | | | | |
| | SiO₂ + 1.2 × P₂O₅-3 × | 4.66 | 4.66 | 4.66 | 4.66 | 4.66 | 4.66 |
| | Al₂O₃—B₂O₃-2 × | | | | | | |
| | Li₂O-1.5 × Na₂O—K₂O | | | | | | |
| | X | 178 | 242 | 227 | 188 | 368 | 202 |
| | W | 151 | 211 | 201 | 157 | 331 | 184 |

TABLE 17

| Component | No. | No. | No. | No. | No. | No. | No. | No. | No. | No. | No. | No. | No. |
|---|---|---|---|---|---|---|---|---|---|---|---|---|---|
| (mol %) | 207 | 208 | 209 | 210 | 211 | 212 | 213 | 214 | 215 | 216 | 217 | 218 | 219 |
| SiO₂ | 79.80 | 77.01 | 76.01 | 77.01 | 77.40 | 77.45 | 77.14 | 77.15 | 77.75 | 77.18 | 77.32 | 76.17 | 76.79 |
| Al₂O₃ | 5.00 | 6.00 | 6.00 | 6.00 | 5.99 | 5.97 | 6.16 | 6.08 | 5.97 | 6.36 | 5.99 | 6.6 | 5.96 |
| B₂O₃ | 0.10 | 0.09 | 0.09 | 0.09 | 0.09 | 0.09 | 0.09 | 0.09 | 0.09 | 0.09 | 0.09 | 0.09 | 0.09 |
| Li₂O | 4.80 | 6.09 | 6.09 | 6.09 | 6.22 | 6.11 | 6.33 | 6.13 | 6.13 | 6.12 | 6.34 | 6.47 | 6.13 |
| Na₂O | 2.70 | 5.91 | 5.91 | 5.91 | 5.82 | 5.89 | 5.8 | 4.93 | 5.82 | 5.84 | 5.83 | 5.83 | 5.89 |
| K₂O | 3.60 | 1.90 | 1.90 | 1.90 | 1.52 | 1.52 | 1.51 | 1.89 | 0.0 | 0.01 | 1.88 | 1.89 | 0.01 |
| MgO | 0.00 | 0.00 | 1.50 | 1.00 | 0.0 | 0.0 | 0.0 | 0.0 | 0.0 | 0.0 | 0.09 | 0.48 | 1.5 |
| CaO | 3.4 | 2.4 | 1.9 | 1.4 | 2.34 | 2.34 | 2.33 | 3.11 | 3.62 | 3.8 | 1.84 | 1.85 | 3.0 |
| SrO | 0.0 | 0.0 | 0.0 | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 | 0.0 | 0.0 | 0.0 |
| TiO₂ | 0.000 | 0.000 | 0.000 | 0.000 | 0.000 | 0.000 | 0.000 | 0.000 | 0.000 | 0.000 | 0.000 | 0.000 | 0.000 |
| ZrO₂ | 0.5 | 0.5 | 0.5 | 0.5 | 0.52 | 0.52 | 0.53 | 0.53 | 0.53 | 0.52 | 0.53 | 0.52 | 0.52 |
| SnO₂ | 0.1 | 0.1 | 0.1 | 0.1 | 0.1 | 0.1 | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 | 0.0 | 0.0 | 0.0 | 0.0 | 0.0 | 0.0 |
| Fe₂O₃ | 0.000 | 0.000 | 0.000 | 0.000 | 0.000 | 0.000 | 0.000 | 0.000 | 0.000 | 0.000 | 0.000 | 0.000 | 0.000 |
| P₂O₅ | 0.0 | 0.0 | 0.0 | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 | 0.000 | 0.000 | 0.000 |
| Cl | 0.00 | 0.00 | 0.00 | 0.00 | 0.00 | 0.00 | 0.00 | 0.00 | 0.00 | 0.00 | 0.00 | 0.00 | 0.00 |
| MoO₃ | 0.000 | 0.000 | 0.000 | 0.000 | 0.000 | 0.000 | 0.000 | 0.000 | 0.000 | 0.000 | 0.000 | 0.000 | 0.000 |
| Sb₂O₃ | 0.000 | 0.000 | 0.000 | 0.000 | 0.000 | 0.000 | 0.000 | 0.000 | 0.000 | 0.000 | 0.000 | 0.000 | 0.000 |
| Li₂O + Na₂O | 7.5 | 12.0 | 12.0 | 12.0 | 12.0 | 12.0 | 12.1 | 11.1 | 12.0 | 12.0 | 12.2 | 12.3 | 12.0 |
| Li₂O + MgO | 4.8 | 6.1 | 7.6 | 7.1 | 6.2 | 6.1 | 6.3 | 6.1 | 6.1 | 6.1 | 6.4 | 7.0 | 7.6 |
| RO | 3.4 | 2.4 | 3.4 | 2.4 | 2.3 | 2.3 | 2.3 | 3.1 | 3.6 | 3.8 | 1.9 | 2.3 | 4.5 |
| B₂O₃ + MgO + CaO | 3.5 | 2.5 | 3.5 | 2.5 | 2.4 | 2.4 | 2.4 | 3.2 | 3.7 | 3.9 | 2.0 | 2.4 | 4.6 |
| R₂O | 11.1 | 13.9 | 13.9 | 13.9 | 13.6 | 13.5 | 13.6 | 13.0 | 12.0 | 12.0 | 14.1 | 14.2 | 12.0 |
| R₂O/Al₂O₃ | 2.2 | 2.3 | 2.3 | 2.3 | 2.3 | 2.3 | 2.2 | 2.1 | 2.0 | 1.9 | 2.3 | 2.2 | 2.0 |
| RO/R₂O | 0.31 | 0.17 | 0.24 | 0.17 | 0.17 | 0.17 | 0.17 | 0.24 | 0.30 | 0.32 | 0.14 | 0.16 | 0.37 |
| Al₂O₃/(R₂O + RO) | 0.34 | 0.37 | 0.35 | 0.37 | 0.38 | 0.38 | 0.39 | 0.38 | 0.38 | 0.40 | 0.37 | 0.40 | 0.36 |
| Na₂O/Li₂O | 0.56 | 0.97 | 0.97 | 0.97 | 0.94 | 0.96 | 0.92 | 0.80 | 0.95 | 0.95 | 0.92 | 0.90 | 0.96 |
| (ZnO + R₂O)/Al₂O₃ | 2.22 | 2.32 | 2.32 | 2.32 | 2.26 | 2.26 | 2.21 | 2.13 | 2.00 | 1.88 | 2.35 | 2.15 | 2.02 |
| MgO/Al₂O₃ | 0.00 | 0.00 | 0.25 | 0.17 | 0.00 | 0.00 | 0.00 | 0.00 | 0.00 | 0.00 | 0.02 | 0.07 | 0.25 |
| (SiO₂ + B₂O₃ + P₂O₃)/ | 0.65 | 0.65 | 0.65 | 0.65 | 0.65 | 0.65 | 0.65 | 0.65 | 0.65 | 0.65 | 0.65 | 0.65 | 0.65 |
| ((100 × SnO₂) × | | | | | | | | | | | | | |
| (R₂O + RO + ZnO + | | | | | | | | | | | | | |
| Al₂O₃)) | | | | | | | | | | | | | |
| SiO₂ + 1.2 × P₂O₅- | 4.66 | 4.66 | 4.66 | 4.66 | 4.66 | 4.66 | 4.66 | 4.66 | 4.66 | 4.66 | 4.66 | 4.66 | 4.66 |
| 3 × Al₂O₃—B₂O₃- | | | | | | | | | | | | | |
| 2 × Li₂O- | | | | | | | | | | | | | |
| 1.5 × Na₂O—K₂O | | | | | | | | | | | | | |
| X | 192 | 205 | 205 | 202 | 213 | 205 | 224 | 235 | 211 | 222 | 217 | 242 | 208 |
| W | 1800 | 168 | 175 | 180 | 177 | 170 | 185 | 193 | 159 | 163 | 187 | 203 | 166 |

TABLE 18

| | No. | No. | No. | No. | No. | No. | No. |
|---|---|---|---|---|---|---|---|
| Component (mol %) | 220 | 221 | 222 | 223 | 224 | 225 | 226 |
| SiO₂ | 72.71 | 77.08 | 73.50 | 73.10 | 73.50 | 73.60 | 76.13 |
| Al₂O₃ | 8.46 | 6.03 | 9.5 | 9.4 | 8.7 | 8.7 | 5.99 |
| B₂O₃ | 0.09 | 0.09 | 0.1 | 0.1 | 0.1 | 0.1 | 0.09 |
| Li₂O | 6.11 | 6.0 | 6.1 | 6.1 | 6.1 | 6.1 | 6.12 |
| Na₂O | 5.79 | 0.0 | 5.8 | 5.8 | 5.8 | 5.8 | 1.93 |
| K₂O | 1.89 | 0.0 | 1.9 | 1.9 | 1.9 | 1.9 | 1.9 |
| MgO | 1.5 | 0.05 | 0.2 | 0.0 | 1.0 | 0.2 | 1.52 |
| CaO | 2.83 | 10.19 | 2.3 | 3.0 | 2.3 | 3.0 | 5.7 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 |
| TiO₂ | 0.000 | 0.000 | 0.000 | 0.000 | 0.000 | 0.000 | 0.000 |
| ZrO₂ | 0.53 | 0.48 | 0.5 | 0.5 | 0.5 | 0.5 | 0.52 |
| SnO₂ | 0.1 | 0.08 | 0.1 | 0.1 | 0.1 | 0.1 | 0.1 |
| Y₂O₃ | 0.0 | 0.0 | 0.0 | 0.0 | 0.0 | 0.0 | 0.0 |
| Fe₂O₃ | 0.000 | 0.000 | 0.000 | 0.000 | 0.000 | 0.000 | 0.000 |
| P₂O₅ | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 |
| Cl | 0.00 | 0.00 | 0.00 | 0.00 | 0.00 | 0.00 | 0.00 |
| MoO₃ | 0.000 | 0.000 | 0.000 | 0.000 | 0.000 | 0.000 | 0.000 |
| Sb₂O₃ | 0.000 | 0.000 | 0.000 | 0.000 | 0.000 | 0.000 | 0.000 |
| Li₂O + Na₂O | 11.9 | 6.0 | 11.9 | 11.9 | 11.9 | 11.9 | 8.1 |
| Li₂O + MgO | 7.6 | 6.1 | 6.3 | 6.1 | 7.1 | 6.3 | 7.6 |
| RO | 4.3 | 10.2 | 2.5 | 3.0 | 3.3 | 3.2 | 7.2 |
| B₂O₃ + MgO + CaO | 4.4 | 10.3 | 2.6 | 3.1 | 3.4 | 3.3 | 7.3 |
| R₂O | 13.8 | 6.0 | 13.8 | 13.8 | 13.8 | 13.8 | 10.0 |
| R₂O/Al₂O₃ | 1.6 | 1.0 | 1.5 | 1.5 | 1.6 | 1.6 | 1.7 |
| RO/R₂O | 0.31 | 1.71 | 0.18 | 0.22 | 0.24 | 0.23 | 0.73 |
| Al₂O₃/(R₂O + RO) | 0.47 | 0.37 | 0.58 | 0.56 | 0.51 | 0.51 | 0.35 |
| Na₂O/Li₂O | 0.95 | 0.00 | 0.95 | 0.95 | 0.95 | 0.95 | 0.32 |
| (ZnO + R₂O)/Al₂O₃ | 1.63 | 1.00 | 1.45 | 1.47 | 1.59 | 1.59 | 1.66 |
| MgO/Al₂O₃ | 0.18 | 0.01 | 0.02 | 0.00 | 0.11 | 0.02 | 0.25 |
| (SiO₂ + B₂O₃ + P₂O₅)/ | 0.65 | 0.65 | 0.65 | 0.65 | 0.65 | 0.65 | 0.65 |
| ((100 × SnO₂) × (R₂O + | | | | | | | |
| RO + ZnO + Al₂O₃)) | | | | | | | |
| SiO₂ + 1.2 × P₂O₅-3 × | 4.66 | 4.66 | 4.66 | 4.66 | 4.66 | 4.66 | 4.66 |
| Al₂O₃—B₂O₃-2 × | | | | | | | |
| Li₂O-1.5 × Na₂O—K₂O | | | | | | | |
| X | 283 | 367 | 308 | 308 | 286 | 288 | 313 |
| W | 215 | 257 | 236 | 227 | 223 | 215 | 253 |
| | | No. | No. | No. | No. | No. | No. |
| | Component (mol %) | 227 | 228 | 229 | 230 | 231 | 232 |
| | SiO₂ | 76.10 | 73.62 | 76.16 | 73.46 | 73.52 | 73.45 |
| | Al₂O₃ | 5.99 | 8.55 | 5.99 | 9.47 | 9.43 | 8.72 |
| | B₂O₃ | 0.09 | 0.09 | 0.09 | 0.09 | 0.09 | 0.09 |
| | Li₂O | 6.96 | 6.11 | 6.13 | 6.12 | 6.11 | 6.12 |
| | Na₂O | 0.05 | 5.79 | 3.36 | 5.84 | 5.84 | 5.84 |
| | K₂O | 1.89 | 1.82 | 1.88 | 1.88 | 1.87 | 1.87 |
| | MgO | 1.53 | 0.08 | 1.5 | 0.74 | 0.0 | 1.5 |
| | CaO | 6.77 | 3.31 | 4.27 | 1.79 | 2.52 | 1.79 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | ZnO | 0.0 | 0.0 | 0.0 | 0.0 | 0.0 | 0.0 |
| | TiO₂ | 0.000 | 0.000 | 0.000 | 0.000 | 0.000 | 0.000 |
| | ZrO₂ | 0.52 | 0.52 | 0.52 | 0.51 | 0.52 | 0.52 |
| | SnO₂ | 0.1 | 0.1 | 0.1 | 0.1 | 0.1 | 0.1 |
| | Y₂O₃ | 0.0 | 0.0 | 0.0 | 0.0 | 0.0 | 0.0 |
| | Fe₂O₃ | 0.000 | 0.000 | 0.000 | 0.000 | 0.000 | 0.000 |
| | P₂O₅ | 0.0 | 0.0 | 0.0 | 0.0 | 0.0 | 0.0 |
| | SO₃ | 0.000 | 0.000 | 0.000 | 0.000 | 0.000 | 0.000 |
| | Cl | 0.00 | 0.00 | 0.00 | 0.00 | 0.00 | 0.00 |
| | MoO₃ | 0.000 | 0.000 | 0.000 | 0.000 | 0.000 | 0.000 |
| | Sb₂O₃ | 0.000 | 0.000 | 0.000 | 0.000 | 0.000 | 0.000 |
| | Li₂O + Na₂O | 7.0 | 11.9 | 9.5 | 12.0 | 12.0 | 12.0 |
| | Li₂O + MgO | 8.5 | 6.2 | 7.6 | 6.9 | 6.1 | 7.6 |
| | RO | 8.3 | 3.4 | 5.8 | 2.5 | 2.5 | 3.3 |
| | B₂O₃ + MgO + CaO | 8.4 | 3.5 | 5.9 | 2.6 | 2.6 | 3.4 |
| | R₂O | 8.9 | 13.7 | 11.4 | 13.8 | 13.8 | 13.8 |
| | R₂O/Al₂O₃ | 1.5 | 1.6 | 1.9 | 1.5 | 1.5 | 1.6 |
| | RO/R₂O | 0.93 | 0.25 | 0.51 | 0.18 | 0.18 | 0.24 |
| | Al₂O₃/(R₂O + RO) | 0.35 | 0.50 | 0.35 | 0.58 | 0.58 | 0.51 |
| | Na₂O/Li₂O | 0.01 | 0.95 | 0.55 | 0.95 | 0.96 | 0.95 |
| | (ZnO + R₂O)/Al₂O₃ | 1.49 | 1.60 | 1.90 | 1.46 | 1.47 | 1.59 |
| | MgO/Al₂O₃ | 0.26 | 0.01 | 0.25 | 0.08 | 0.00 | 0.17 |
| | (SiO₂ + B₂O₃ + P₂O₅)/ | 0.65 | 0.65 | 0.65 | 0.65 | 0.65 | 0.65 |
| | ((100 × SnO₂) × (R₂O + | | | | | | |
| | RO + ZnO + Al₂O₃)) | | | | | | |
| | SiO₂ + 1.2 × P₂O₅-3 × | 4.66 | 4.66 | 4.66 | 4.66 | 4.66 | 4.66 |
| | Al₂O₃—B₂O₃-2 × | | | | | | |
| | Li₂O-1.5 × Na₂O—K₂O | | | | | | |
| | X | 403 | 286 | 275 | 306 | 306 | 285 |
| | W | 332 | 209 | 227 | 242 | 232 | 229 |

TABLE 19

| Component | No. | No. | No. | No. | No. | No. | No. |
|---|---|---|---|---|---|---|---|
| (mol %) | 233 | 234 | 235 | 236 | 237 | 238 | 239 |
| SiO₂ | 73.51 | 69.10 | 81.00 | 77.85 | 76.90 | 74.90 | 72.90 |
| Al₂O₃ | 8.69 | 10.00 | 4.00 | 5.97 | 6.00 | 6.00 | 6.00 |
| B₂O₃ | 0.09 | 0.40 | 0.10 | 0.00 | 1.00 | 3.00 | 5.00 |
| Li₂O | 6.12 | 6.09 | 5.1 | 6.13 | 6.1 | 6.1 | 6.1 |
| Na₂O | 5.82 | 5.91 | 4.9 | 5.82 | 5.8 | 5.8 | 5.8 |
| K₂O | 1.87 | 1.9 | 1.3 | 0.00 | 0.00 | 0.00 | 0.00 |
| MgO | 0.74 | 2.0 | 1.0 | 0.00 | 0.00 | 0.00 | 0.00 |
| CaO | 2.53 | 4.0 | 2.0 | 3.6 | 3.6 | 3.6 | 3.6 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 |
| TiO₂ | 0.000 | 0.000 | 0.000 | 0.000 | 0.000 | 0.000 | 0.000 |
| ZrO₂ | 0.52 | 0.5 | 0.5 | 0.53 | 0.5 | 0.5 | 0.5 |
| SnO₂ | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 |
| Fe₂O₃ | 0.000 | 0.000 | 0.000 | 0.000 | 0.000 | 0.000 | 0.000 |
| P₂O₅ | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 |
| Cl | 0.00 | 0.00 | 0.00 | 0.00 | 0.00 | 0.00 | 0.00 |
| MoO₃ | 0.000 | 0.000 | 0.000 | 0.000 | 0.000 | 0.000 | 0.000 |
| Sb₂O₃ | 0.000 | 0.000 | 0.000 | 0.000 | 0.000 | 0.000 | 0.000 |
| Li₂O + Na₂O | 11.9 | 12.0 | 10.0 | 12.0 | 11.9 | 11.9 | 11.9 |
| Li₂O + MgO | 6.9 | 8.1 | 6.1 | 6.1 | 6.1 | 6.1 | 6.1 |
| RO | 3.3 | 6.0 | 3.0 | 3.6 | 3.6 | 3.6 | 3.6 |
| B₂O₃ + MgO + CaO | 3.4 | 6.4 | 3.1 | 3.6 | 4.6 | 6.6 | 8.6 |
| R₂O | 13.8 | 13.9 | 11.3 | 12.0 | 11.9 | 11.9 | 11.9 |
| R₂O/Al₂O₃ | 1.6 | 1.4 | 2.8 | 2.0 | 2.0 | 2.0 | 2.0 |
| RO/R₂O | 0.24 | 0.43 | 0.27 | 0.30 | 0.30 | 0.30 | 0.30 |
| Al₂O₃/(R₂O + RO) | 0.51 | 0.50 | 0.28 | 0.38 | 0.39 | 0.39 | 0.39 |
| Na₂O/Li₂O | 0.95 | 0.97 | 0.96 | 0.95 | 0.95 | 0.95 | 0.95 |
| (ZnO + R₂O)/Al₂O₃ | 1.59 | 1.39 | 2.83 | 2.00 | 1.98 | 1.98 | 1.98 |
| MgO/Al₂O₃ | 0.09 | 0.20 | 0.25 | 0.00 | 0.00 | 0.00 | 0.00 |
| (SiO₂ + B₂O₃ + P₂O₅)/ | 0.65 | 0.65 | 0.65 | 0.65 | 0.65 | 0.65 | 0.65 |
| ((100 × SnO₂) × | | | | | | | |
| (R₂O + RO + ZnO + | | | | | | | |
| Al₂O₃)) | | | | | | | |
| SiO₂ + 1.2 × P₂O₅- | 4.66 | 4.66 | 4.66 | 4.66 | 4.66 | 4.66 | 4.66 |
| 3 × Al₂O₃—B₂O₃- | | | | | | | |
| 2 × Li₂O- | | | | | | | |
| 1.5 × Na₂O—K₂O | | | | | | | |
| X | 287 | 328 | 121 | 211 | 209 | 206 | 202 |
| W | 220 | 225 | 126 | 160 | 155 | 146 | 137 |
| | Component | No. | No. | No. | No. | No. | No. |
| | (mol %) | 240 | 241 | 242 | 243 | 244 | 245 |
| | SiO₂ | 78.30 | 75.40 | 75.30 | 78.30 | 75.40 | 73.90 |
| | Al₂O₃ | 5.00 | 7.00 | 7.00 | 4.00 | 7.00 | 7.00 |
| | B₂O₃ | 0.10 | 0.10 | 0.10 | 0.10 | 0.10 | 0.10 |
| | Li₂O | 2.6 | 0.0 | 0.1 | 11.1 | 2.0 | 6.1 |
| | Na₂O | 2.4 | 11.0 | 11.0 | 2.0 | 11.0 | 5.9 |
| | K₂O | 1.00 | 2.90 | 2.90 | 0.90 | 0.90 | 1.9 |
| | MgO | 3.00 | 1.00 | 1.00 | 1.00 | 1.00 | 4.0 |
| | CaO | 7.0 | 2.0 | 2.0 | 2.0 | 2.0 | 0.5 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | ZnO | 0.0 | 0.0 | 0.0 | 0.0 | 0.0 | 0.0 |
| | TiO₂ | 0.000 | 0.000 | 0.000 | 0.000 | 0.000 | 0.000 |
| | ZrO₂ | 0.53 | 0.53 | 0.53 | 0.53 | 0.53 | 0.53 |
| | SnO₂ | 0.1 | 0.1 | 0.1 | 0.1 | 0.1 | 0.1 |
| | Y₂O₃ | 0.0 | 0.0 | 0.0 | 0.0 | 0.0 | 0.0 |
| | Fe₂O₃ | 0.000 | 0.000 | 0.000 | 0.000 | 0.000 | 0.000 |
| | P₂O₅ | 0.0 | 0.0 | 0.0 | 0.0 | 0.0 | 0.0 |
| | SO₃ | 0.000 | 0.000 | 0.000 | 0.000 | 0.000 | 0.000 |
| | Cl | 0.00 | 0.00 | 0.00 | 0.00 | 0.00 | 0.00 |
| | MoO₃ | 0.000 | 0.000 | 0.000 | 0.000 | 0.000 | 0.000 |
| | Sb₂O₃ | 0.000 | 0.000 | 0.000 | 0.000 | 0.000 | 0.000 |
| | Li₂O + Na₂O | 5.0 | 11.0 | 11.1 | 13.1 | 13.0 | 12.0 |
| | Li₂O + MgO | 5.6 | 1.0 | 1.1 | 12.1 | 3.0 | 10.1 |
| | RO | 10.0 | 3.0 | 3.0 | 3.0 | 3.0 | 4.5 |
| | B₂O₃ + MgO + CaO | 10.1 | 3.1 | 3.1 | 3.1 | 3.1 | 4.6 |
| | R₂O | 6.0 | 13.9 | 14.0 | 14.0 | 13.9 | 13.9 |
| | R₂O/Al₂O₃ | 1.2 | 2.0 | 2.0 | 3.5 | 2.0 | 2.0 |
| | RO/R₂O | 1.67 | 0.22 | 0.21 | 0.21 | 0.22 | 0.32 |
| | Al₂O₃/(R₂O + RO) | 0.31 | 0.41 | 0.41 | 0.24 | 0.41 | 0.38 |
| | Na₂O/Li₂O | 0.92 | — | 110.00 | 0.18 | 5.50 | 0.97 |
| | (ZnO + R₂O)/Al₂O₃ | 1.20 | 1.99 | 2.00 | 3.50 | 1.99 | 1.99 |
| | MgO/Al₂O₃ | 0.60 | 0.14 | 0.14 | 0.25 | 0.14 | 0.57 |
| | (SiO₂ + B₂O₃ + P₂O₅)/ | 0.65 | 0.65 | 0.65 | 0.65 | 0.65 | 0.65 |
| | ((100 × SnO₂) × | | | | | | |
| | (R₂O + RO + ZnO + | | | | | | |
| | Al₂O₃)) | | | | | | |
| | SiO₂ + 1.2 × P₂O₅- | 4.66 | 4.66 | 4.66 | 4.66 | 4.66 | 4.66 |
| | 3 × Al₂O₃—B₂O₃- | | | | | | |
| | 2 × Li₂O- | | | | | | |
| | 1.5 × Na₂O—K₂O | | | | | | |
| | X | 104 | −186 | −181 | 487 | −89 | 231 |
| | W | 65 | −210 | −206 | 460 | −127 | 212 |

TABLE 20

| Component | No. | No. | No. | No. | No. | No. | No. |
|---|---|---|---|---|---|---|---|
| (mol %) | 246 | 247 | 248 | 249 | 250 | 251 | 252 |
| SiO₂ | 75.90 | 76.90 | 72.00 | 72.10 | 72.80 | 72.80 | 72.40 |
| Al₂O₃ | 7.00 | 7.0 | 9.5 | 9.4 | 8.7 | 8.7 | 9.0 |
| B₂O₃ | 0.10 | 0.1 | 0.1 | 0.1 | 0.1 | 0.1 | 0.1 |
| Li₂O | 6.1 | 6.1 | 6.1 | 6.1 | 6.1 | 6.1 | 0.0 |
| Na₂O | 5.9 | 5.9 | 5.8 | 5.8 | 5.8 | 5.8 | 11.0 |
| K₂O | 1.9 | 1.9 | 1.9 | 1.9 | 1.9 | 1.9 | 2.9 |
| MgO | 2.0 | 1.0 | 1.5 | 1.0 | 1.5 | 1.0 | 1.0 |
| CaO | 0.5 | 0.5 | 2.5 | 3.0 | 2.5 | 3.0 | 3.0 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 |
| TiO₂ | 0.000 | 0.000 | 0.000 | 0.000 | 0.000 | 0.000 | 0.000 |
| ZrO₂ | 0.53 | 0.53 | 0.5 | 0.5 | 0.5 | 0.5 | 0.53 |
| SnO₂ | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 |
| Fe₂O₃ | 0.000 | 0.000 | 0.000 | 0.000 | 0.000 | 0.000 | 0.000 |
| P₂O₅ | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 |
| Cl | 0.00 | 0.00 | 0.00 | 0.00 | 0.00 | 0.00 | 0.00 |
| MoO₃ | 0.000 | 0.000 | 0.000 | 0.000 | 0.000 | 0.000 | 0.000 |
| Sb₂O₃ | 0.000 | 0.000 | 0.000 | 0.000 | 0.000 | 0.000 | 0.000 |
| Li₂O + Na₂O | 12.0 | 12.0 | 11.9 | 11.9 | 11.9 | 11.9 | 11.0 |
| Li₂O + MgO | 8.1 | 7.1 | 7.6 | 7.1 | 7.6 | 7.1 | 1.0 |
| RO | 2.5 | 1.5 | 4.0 | 4.0 | 4.0 | 4.0 | 4.0 |
| B₂O₃ + MgO + CaO | 2.6 | 1.6 | 4.1 | 4.1 | 4.1 | 4.1 | 4.1 |
| R₂O | 13.9 | 13.9 | 13.8 | 13.8 | 13.8 | 13.8 | 13.9 |
| R₂O/Al₂O₃ | 2.0 | 2.0 | 1.5 | 1.5 | 1.6 | 1.6 | 1.5 |
| RO/R₂O | 0.18 | 0.11 | 0.29 | 0.29 | 0.29 | 0.29 | 0.29 |
| Al₂O₃/(R₂O + RO) | 0.43 | 0.45 | 0.53 | 0.53 | 0.49 | 0.49 | 0.50 |
| Na₂O/Li₂O | 0.97 | 0.97 | 0.95 | 0.95 | 0.95 | 0.95 | — |
| (ZnO + R₂O)/Al₂O₃ | 1.99 | 1.99 | 1.45 | 1.47 | 1.59 | 1.59 | 1.54 |
| MgO/Al₂O₃ | 0.29 | 0.14 | 0.16 | 0.11 | 0.17 | 0.11 | 0.11 |
| (SiO₂ + B₂O₃ + P₂O₅)/ | 0.65 | 0.65 | 0.65 | 0.65 | 0.65 | 0.65 | 0.65 |
| ((100 × SnO₂) × | | | | | | | |
| (R₂O + RO + ZnO + | | | | | | | |
| Al₂O₃)) | | | | | | | |
| SiO₂ + 1.2 × P₂O₅- | 4.66 | 4.66 | 4.66 | 4.66 | 4.66 | 4.66 | 4.66 |
| 3 × Al₂O₃—B₂O₃- | | | | | | | |
| 2 × Li₂O-1.5 × | | | | | | | |
| Na₂O—K₂O | | | | | | | |
| X | 229 | 228 | 310 | 309 | 288 | 289 | −125 |
| W | 210 | 208 | 236 | 228 | 222 | 216 | −184 |
| | Component | No. | No. | No. | No. | No. | No. |
| | (mol %) | 253 | 254 | 255 | 256 | 257 | 258 |
| | SiO₂ | 72.30 | 72.40 | 74.90 | 76.90 | 77.90 | 74.40 |
| | Al₂O₃ | 9.0 | 9.0 | 6.0 | 6.0 | 6.0 | 6.0 |
| | B₂O₃ | 0.1 | 0.1 | 0.1 | 0.1 | 0.1 | 0.1 |
| | Li₂O | 0.1 | 2.0 | 6.1 | 6.1 | 6.1 | 6.1 |
| | Na₂O | 11.0 | 11.0 | 5.9 | 5.9 | 5.9 | 5.9 |
| | K₂O | 2.9 | 0.9 | 1.9 | 1.9 | 1.9 | 1.9 |
| | MgO | 1.0 | 1.0 | 4.0 | 2.0 | 1.0 | 4.5 |
| | CaO | 3.0 | 3.0 | 0.5 | 0.5 | 0.5 | 0.5 |
| | SrO | 0.0 | 0.0 | 0.0 | 0.0 | 0.0 | 0.0 |
| | BaO | 0.0 | 0.0 | 0.0 | 0.0 | 0.0 | 0.0 |
| | ZnO | 0.0 | 0.0 | 0.0 | 0.0 | 0.0 | 0.0 |
| | TiO₂ | 0.000 | 0.000 | 0.000 | 0.000 | 0.000 | 0.000 |
| | ZrO₂ | 0.53 | 0.53 | 0.53 | 0.53 | 0.53 | 0.5 |
| | SnO₂ | 0.1 | 0.1 | 0.1 | 0.1 | 0.1 | 0.1 |
| | Y₂O₃ | 0.0 | 0.0 | 0.0 | 0.0 | 0.0 | 0.0 |
| | Fe₂O₃ | 0.000 | 0.000 | 0.000 | 0.000 | 0.000 | 0.000 |
| | P₂O₅ | 0.0 | 0.0 | 0.0 | 0.0 | 0.0 | 0.0 |
| | SO₃ | 0.000 | 0.000 | 0.000 | 0.000 | 0.000 | 0.000 |
| | Cl | 0.00 | 0.00 | 0.00 | 0.00 | 0.00 | 0.00 |
| | MoO₃ | 0.000 | 0.000 | 0.000 | 0.000 | 0.000 | 0.000 |
| | Sb₂O₃ | 0.000 | 0.000 | 0.000 | 0.000 | 0.000 | 0.000 |
| | Li₂O + Na₂O | 11.1 | 13.0 | 12.0 | 12.0 | 12.0 | 12.0 |
| | Li₂O + MgO | 1.1 | 3.0 | 10.1 | 8.1 | 7.1 | 10.6 |
| | RO | 4.0 | 4.0 | 4.5 | 2.5 | 1.5 | 5.0 |
| | B₂O₃ + MgO + CaO | 4.1 | 4.1 | 4.6 | 2.6 | 1.6 | 5.1 |
| | R₂O | 14.0 | 13.9 | 13.9 | 13.9 | 13.9 | 13.9 |
| | R₂O/Al₂O₃ | 1.6 | 1.5 | 2.3 | 2.3 | 2.3 | 2.3 |
| | RO/R₂O | 0.29 | 0.29 | 0.32 | 0.18 | 0.11 | 0.36 |
| | Al₂O₃/(R₂O + RO) | 0.50 | 0.50 | 0.33 | 0.37 | 0.39 | 0.32 |
| | Na₂O/Li₂O | 110.00 | 5.50 | 0.97 | 0.97 | 0.97 | 0.97 |
| | (ZnO + R₂O)/Al₂O₃ | 1.56 | 1.54 | 2.32 | 2.32 | 2.32 | 2.32 |
| | MgO/Al₂O₃ | 0.11 | 0.11 | 0.67 | 0.33 | 0.17 | 0.75 |
| | (SiO₂ + B₂O₃ + P₂O₅)/ | 0.65 | 0.65 | 0.65 | 0.65 | 0.65 | 0.65 |
| | ((100 × SnO₂) × | | | | | | |
| | (R₂O + RO + ZnO + | | | | | | |
| | Al₂O₃)) | | | | | | |
| | SiO₂ + 1.2 × P₂O₅- | 4.66 | 4.66 | 4.66 | 4.66 | 4.66 | 4.66 |
| | 3 × Al₂O₃—B₂O₃- | | | | | | |
| | 2 × Li₂O-1.5 × | | | | | | |
| | Na₂O—K₂O | | | | | | |
| | X | −120 | −28 | 203 | 201 | 199 | 204 |
| | W | −180 | −101 | 194 | 191 | 190 | 195 |

TABLE 21

| Component | No. | No. | No. | No. | No. | No. | No. | No. | No. | No. | No. | No. | No. |
|---|---|---|---|---|---|---|---|---|---|---|---|---|---|
| (mol %) | 259 | 260 | 261 | 262 | 263 | 264 | 265 | 266 | 267 | 268 | 269 | 270 | 271 |
| SiO₂ | 75.18 | 77.13 | 74.30 | 74.30 | 75.30 | 75.80 | 77.30 | 78.80 | 76.30 | 74.30 | 73.30 | 72.30 | 73.30 |
| Al₂O₃ | 6.3 | 6.0 | 8.5 | 9.5 | 8.6 | 7.0 | 5.5 | 4.0 | 7.5 | 9.0 | 9.0 | 9.5 | 8.5 |
| B₂O₃ | 0.0 | 0.0 | 0.1 | 0.1 | 0.1 | 0.1 | 0.1 | 0.1 | 0.1 | 0.1 | 0.1 | 0.1 | 0.1 |
| Di₂O | 0.0 | 0.0 | 6.1 | 6.1 | 6.1 | 6.1 | 6.1 | 6.1 | 6.1 | 6.1 | 6.1 | 6.1 | 6.1 |
| Na₂O | 12.5 | 11.4 | 5.9 | 5.9 | 5.8 | 5.9 | 5.9 | 5.9 | 5.9 | 5.9 | 5.9 | 5.9 | 5.9 |
| K₂O | 0.1 | 0.1 | 1.9 | 1.9 | 1.9 | 1.9 | 1.9 | 1.9 | 1.9 | 1.9 | 1.9 | 1.9 | 1.9 |
| MgO | 5.1 | 1.8 | 0.0 | 0.0 | 0.0 | 0.0 | 0.0 | 0.0 | 0.0 | 0.0 | 0.0 | 0.0 | 0.0 |
| CaO | 0.7 | 3.5 | 2.6 | 1.6 | 1.6 | 2.6 | 2.6 | 2.6 | 1.6 | 2.1 | 3.1 | 3.6 | 3.6 |
| SrO | 0.0 | 0.0 | 0.0 | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 | 0.0 | 0.0 | 0.0 |
| TiO₂ | 0.000 | 0.000 | 0.000 | 0.000 | 0.000 | 0.000 | 0.000 | 0.000 | 0.000 | 0.000 | 0.000 | 0.000 | 0.000 |
| ZrO₂ | 0 | 0 | 0.5 | 0.5 | 0.5 | 0.5 | 0.5 | 0.5 | 0.5 | 0.5 | 0.5 | 0.5 | 0.5 |
| SnO₂ | 0.06 | 0.09 | 0.1 | 0.1 | 0.1 | 0.1 | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 | 0.0 | 0.0 | 0.0 | 0.0 | 0.0 | 0.0 |
| Fe₂O₃ | 0.000 | 0.000 | 0.000 | 0.000 | 0.000 | 0.000 | 0.000 | 0.000 | 0.000 | 0.000 | 0.000 | 0.000 | 0.000 |
| P₂O₅ | 0.0 | 0.0 | 0.0 | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 | 0.000 | 0.000 | 0.000 |
| Cl | 0.00 | 0.00 | 0.00 | 0.00 | 0.00 | 0.00 | 0.00 | 0.00 | 0.00 | 0.00 | 0.00 | 0.00 | 0.00 |
| MoO₃ | 0.000 | 0.000 | 0.000 | 0.000 | 0.000 | 0.000 | 0.000 | 0.000 | 0.000 | 0.000 | 0.000 | 0.000 | 0.000 |
| Sb₂O₃ | 0.000 | 0.000 | 0.000 | 0.000 | 0.000 | 0.000 | 0.000 | 0.000 | 0.000 | 0.000 | 0.000 | 0.000 | 0.000 |
| Li₂O + Na₂O | 12.5 | 11.4 | 12.0 | 12.0 | 11.9 | 12.0 | 12.0 | 12.0 | 12.0 | 12.0 | 12.0 | 12.0 | 12.0 |
| Li₂O + MgO | 5.1 | 1.8 | 6.1 | 6.1 | 6.1 | 6.1 | 6.1 | 6.1 | 6.1 | 6.1 | 6.1 | 6.1 | 6.1 |
| RO | 5.8 | 5.3 | 2.6 | 1.6 | 1.6 | 2.6 | 2.6 | 2.6 | 1.6 | 2.1 | 3.1 | 3.6 | 3.6 |
| B₂O₃ + MgO + CaO | 5.8 | 5.3 | 2.7 | 1.7 | 1.7 | 2.7 | 2.7 | 2.7 | 1.7 | 2.2 | 3.2 | 3.7 | 3.7 |
| R₂O | 12.7 | 11.5 | 13.9 | 13.9 | 13.8 | 13.9 | 13.9 | 13.9 | 13.9 | 13.9 | 13.9 | 13.9 | 13.9 |
| R₂O/Al₂O₃ | 2.0 | 1.9 | 1.6 | 1.5 | 1.6 | 2.0 | 2.5 | 3.5 | 1.9 | 1.5 | 1.5 | 1.5 | 1.6 |
| RO/R₂O | 0.45 | 0.46 | 0.19 | 0.12 | 0.12 | 0.19 | 0.19 | 0.19 | 0.12 | 0.15 | 0.22 | 0.26 | 0.26 |
| Al₂O₃/(R₂O + RO) | 0.34 | 0.36 | 0.52 | 0.61 | 0.56 | 0.42 | 0.33 | 0.24 | 0.48 | 0.56 | 0.53 | 0.54 | 0.49 |
| Na₂O/Li₂O | — | — | 0.97 | 0.97 | 0.95 | 0.97 | 0.97 | 0.97 | 0.97 | 0.97 | 0.97 | 0.97 | 0.97 |
| (ZnO + R₂O)/Al₂O₃ | 2.00 | 1.93 | 1.64 | 1.46 | 1.60 | 1.99 | 2.53 | 3.48 | 1.85 | 1.54 | 1.54 | 1.46 | 1.64 |
| MgO/Al₂O₃ | 0.80 | 0.31 | 0.00 | 0.00 | 0.00 | 0.00 | 0.00 | 0.00 | 0.00 | 0.00 | 0.00 | 0.00 | 0.00 |
| (SiO₂ + B₂O₃ + P₂O₅)/ | 0.65 | 0.65 | 0.65 | 0.65 | 0.65 | 0.65 | 0.65 | 0.65 | 0.65 | 0.65 | 0.65 | 0.65 | 0.65 |
| ((100 × SnO₂) × | | | | | | | | | | | | | |
| (R₂O + RO + | | | | | | | | | | | | | |
| ZnO + Al₂O₃)) | | | | | | | | | | | | | |
| SiO₂ + 1.2 × P₂O₅- | 4.66 | 4.66 | 4.66 | 4.66 | 4.66 | 4.66 | 4.66 | 4.66 | 4.66 | 4.66 | 4.66 | 4.66 | 4.66 |
| 3 × Al₂O₃-B₂O₃- | | | | | | | | | | | | | |
| 2 × Li₂O- | | | | | | | | | | | | | |
| 1.5 × Na₂O-K₂O | | | | | | | | | | | | | |
| X | −245 | −222 | 278 | 302 | 279 | 236 | 193 | 150 | 246 | 290 | 295 | 311 | 282 |
| W | −246 | −254 | 212 | 241 | 227 | 185 | 158 | 130 | 204 | 226 | 216 | 220 | 201 |

TABLE 22

| Component | No. | No. | No. | No. | No. | No. | No. | No. | No. | No. | No. | No. | No. |
|---|---|---|---|---|---|---|---|---|---|---|---|---|---|
| (mol %) | 272 | 273 | 274 | 275 | 276 | 277 | 278 | 279 | 280 | 281 | 282 | 283 | 284 |
| SiO₂ | 77.20 | 71.30 | 75.30 | 73.30 | 75.10 | 75.10 | 73.70 | 73.70 | 76.80 | 75.80 | 75.80 | 75.80 | 76.60 |
| Al₂O₃ | 6.6 | 8.5 | 6.5 | 6.5 | 8.5 | 8.5 | 7.5 | 7.5 | 7.2 | 7.2 | 7.2 | 7.2 | 7.2 |
| B₂O₃ | 0.1 | 0.1 | 0.1 | 0.1 | 0.1 | 0.1 | 0.1 | 0.1 | 0.1 | 0.1 | 0.1 | 0.1 | 0.1 |
| Di₂O | 6.1 | 6.1 | 6.1 | 6.1 | 6.1 | 7.1 | 6.1 | 9.1 | 4.1 | 4.1 | 5.1 | 3.1 | 4.3 |
| Na₂O | 5.8 | 5.8 | 5.8 | 5.8 | 5.9 | 4.9 | 5.9 | 2.9 | 4.9 | 5.9 | 4.9 | 6.9 | 3.9 |
| K₂O | 1.9 | 1.9 | 1.9 | 1.9 | 2.5 | 2.5 | 2.5 | 2.5 | 2.7 | 2.7 | 2.7 | 2.7 | 3.7 |
| MgO | 0.0 | 0.0 | 0.0 | 0.0 | 0.0 | 0.0 | 0.0 | 0.0 | 0.0 | 0.0 | 0.0 | 0.0 | 0.0 |
| CaO | 1.7 | 5.7 | 3.7 | 5.7 | 1.2 | 1.2 | 3.6 | 3.6 | 3.6 | 3.6 | 3.6 | 3.6 | 3.6 |
| SrO | 0.0 | 0.0 | 0.0 | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 | 0.0 | 0.0 | 0.0 |
| TiO₂ | 0.000 | 0.000 | 0.000 | 0.000 | 0.000 | 0.000 | 0.000 | 0.000 | 0.000 | 0.000 | 0.000 | 0.000 | 0.000 |
| ZrO₂ | 0.5 | 0.5 | 0.5 | 0.5 | 0.5 | 0.5 | 0.5 | 0.5 | 0.5 | 0.5 | 0.5 | 0.5 | 0.5 |
| SnO₂ | 0.1 | 0.1 | 0.1 | 0.1 | 0.1 | 0.1 | 0.1 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 | 0.0 | 0.0 | 0.0 | 0.0 | 0.0 | 0.0 |
| Fe₂O₃ | 0.000 | 0.000 | 0.000 | 0.000 | 0.000 | 0.000 | 0.000 | 0.000 | 0.000 | 0.000 | 0.000 | 0.000 | 0.000 |
| P₂O₅ | 0.0 | 0.0 | 0.0 | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 | 0.000 | 0.000 | 0.000 |
| Cl | 0.00 | 0.00 | 0.00 | 0.00 | 0.00 | 0.00 | 0.00 | 0.00 | 0.00 | 0.00 | 0.00 | 0.00 | 0.00 |
| MoO₃ | 0.000 | 0.000 | 0.000 | 0.000 | 0.000 | 0.000 | 0.000 | 0.000 | 0.000 | 0.000 | 0.000 | 0.000 | 0.000 |
| Sb₂O₃ | 0.000 | 0.000 | 0.000 | 0.000 | 0.000 | 0.000 | 0.000 | 0.000 | 0.000 | 0.000 | 0.000 | 0.000 | 0.000 |
| Li₂O + Na₂O | 11.9 | 11.9 | 11.9 | 11.9 | 12.0 | 12.0 | 12.0 | 12.0 | 9.0 | 10.0 | 10.0 | 10.0 | 8.2 |
| Li₂O + MgO | 6.1 | 6.1 | 6.1 | 6.1 | 6.1 | 7.1 | 6.1 | 9.1 | 4.1 | 4.1 | 5.1 | 3.1 | 4.3 |
| RO | 1.7 | 5.7 | 3.7 | 5.7 | 1.2 | 1.2 | 3.6 | 3.6 | 3.6 | 3.6 | 3.6 | 3.6 | 3.6 |
| B₂O₃ + MgO + CaO | 1.8 | 5.8 | 3.8 | 5.8 | 1.3 | 1.3 | 3.7 | 3.7 | 3.7 | 3.7 | 3.7 | 3.7 | 3.7 |
| R₂O | 13.8 | 13.8 | 13.8 | 13.8 | 14.5 | 14.5 | 14.5 | 14.5 | 11.7 | 12.7 | 12.7 | 12.7 | 11.9 |
| R₂O/Al₂O₃ | 2.1 | 1.6 | 2.1 | 2.1 | 1.7 | 1.7 | 1.9 | 1.9 | 1.6 | 1.8 | 1.8 | 1.8 | 1.7 |
| RO/R₂O | 0.12 | 0.41 | 0.27 | 0.41 | 0.08 | 0.08 | 0.25 | 0.25 | 0.31 | 0.28 | 0.28 | 0.28 | 0.30 |
| Al₂O₃/(R₂O + RO) | 0.43 | 0.44 | 0.37 | 0.33 | 0.54 | 0.54 | 0.41 | 0.41 | 0.47 | 0.44 | 0.44 | 0.44 | 0.46 |
| Na₂O/Li₂O | 0.95 | 0.95 | 0.95 | 0.95 | 0.97 | 0.69 | 0.97 | 0.32 | 1.20 | 1.44 | 0.96 | 2.23 | 0.91 |
| (ZnO + R₂O)/Al₂O₃ | 2.09 | 1.62 | 2.12 | 2.12 | 1.71 | 1.71 | 1.93 | 1.93 | 1.63 | 1.76 | 1.76 | 1.76 | 1.65 |
| MgO/Al₂O₃ | 0.00 | 0.00 | 0.00 | 0.00 | 0.00 | 0.00 | 0.00 | 0.00 | 0.00 | 0.00 | 0.00 | 0.00 | 0.00 |
| (SiO₂ + B₂O₃ + P₂O₅)/ | 0.65 | 0.65 | 0.65 | 0.65 | 0.65 | 0.65 | 0.65 | 0.65 | 0.65 | 0.65 | 0.65 | 0.65 | 0.65 |
| ((100 × SnO₂) × | | | | | | | | | | | | | |
| (R₂O + RO + | | | | | | | | | | | | | |
| ZnO + Al₂O₃)) | | | | | | | | | | | | | |
| SiO₂ + 1.2 × P₂O₅- | 4.66 | 4.66 | 4.66 | 4.66 | 4.66 | 4.66 | 4.66 | 4.66 | 4.66 | 4.66 | 4.66 | 4.66 | 4.66 |
| 3 × Al₂O₃-B₂O₃- | | | | | | | | | | | | | |
| 2 × Li₂O- | | | | | | | | | | | | | |
| 1.5 × Na₂O-K₂O | | | | | | | | | | | | | |
| X | 223 | 294 | 228 | 237 | 273 | 346 | 255 | 473 | 169 | 147 | 219 | 74 | 204 |
| W | 190 | 182 | 167 | 146 | 227 | 297 | 183 | 395 | 125 | 95 | 166 | 24 | 162 |

TABLE 23

| Component | No. | No. | No. | No. | No. | No. | No. | No. | No. | No. | No. | No. | No. |
|---|---|---|---|---|---|---|---|---|---|---|---|---|---|
| (mol %) | 285 | 286 | 287 | 288 | 289 | 290 | 291 | 292 | 293 | 294 | 295 | 296 | 297 |
| SiO₂ | 79.80 | 78.80 | 78.80 | 78.00 | 77.00 | 77.50 | 77.50 | 77.20 | 77.20 | 77.70 | 76.70 | 75.70 | 77.20 |
| Al₂O₃ | 5.0 | 5.0 | 4.5 | 4.5 | 6.0 | 6.0 | 6.0 | 6.2 | 6.1 | 6.0 | 6.0 | 7.0 | 5.5 |
| B₂O₃ | 0.1 | 0.1 | 0.1 | 0.1 | 0.1 | 0.1 | 0.1 | 0.1 | 0.1 | 0.1 | 0.1 | 0.1 | 0.1 |
| Di₂O | 4.8 | 4.8 | 4.8 | 4.8 | 6.1 | 6.2 | 6.1 | 6.3 | 6.1 | 6.1 | 6.1 | 6.1 | 6.1 |
| Na₂O | 3.6 | 4.6 | 4.6 | 4.6 | 5.9 | 5.8 | 5.9 | 5.8 | 4.9 | 5.8 | 5.9 | 5.9 | 5.9 |
| K₂O | 2.7 | 2.7 | 3.2 | 4.0 | 1.9 | 1.5 | 1.5 | 1.5 | 1.9 | 0.0 | 0.0 | 1.9 | 1.9 |
| MgO | 0.0 | 0.0 | 0.0 | 0.0 | 0.0 | 0.0 | 0.0 | 0.0 | 0.0 | 0.0 | 1.5 | 0.0 | 0.0 |
| CaO | 3.4 | 3.4 | 3.4 | 3.4 | 2.4 | 2.3 | 2.3 | 2.3 | 3.1 | 3.6 | 3.0 | 2.6 | 2.6 |
| SrO | 0.0 | 0.0 | 0.0 | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 | 0.0 | 0.0 | 0.0 |
| TiO₂ | 0.000 | 0.000 | 0.000 | 0.000 | 0.000 | 0.000 | 0.000 | 0.000 | 0.000 | 0.000 | 0.000 | 0.000 | 0.000 |
| ZrO₂ | 0.5 | 0.5 | 0.5 | 0.5 | 0.5 | 0.5 | 0.5 | 0.5 | 0.5 | 0.5 | 0.5 | 0.5 | 0.5 |
| SnO₂ | 0.1 | 0.1 | 0.1 | 0.1 | 0.1 | 0.1 | 0.1 | 0.1 | 0.1 | 0.2 | 0.2 | 0.2 | 0.2 |
| Y₂O₃ | 0.0 | 0.0 | 0.0 | 0.0 | 0.0 | 0.0 | 0.0 | 0.0 | 0.0 | 0.0 | 0.0 | 0.0 | 0.0 |
| Fe₂O₃ | 0.000 | 0.000 | 0.000 | 0.000 | 0.000 | 0.000 | 0.000 | 0.000 | 0.000 | 0.000 | 0.000 | 0.000 | 0.000 |
| P₂O₅ | 0.0 | 0.0 | 0.0 | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 | 0.000 | 0.000 | 0.000 |
| Cl | 0.00 | 0.00 | 0.00 | 0.00 | 0.00 | 0.00 | 0.00 | 0.00 | 0.00 | 0.00 | 0.00 | 0.00 | 0.00 |
| MoO₃ | 0.000 | 0.000 | 0.000 | 0.000 | 0.000 | 0.000 | 0.000 | 0.000 | 0.000 | 0.000 | 0.000 | 0.000 | 0.000 |
| Sb₂O₃ | 0.000 | 0.000 | 0.000 | 0.000 | 0.000 | 0.000 | 0.000 | 0.000 | 0.000 | 0.000 | 0.000 | 0.000 | 0.000 |
| Li₂O + Na₂O | 8.4 | 9.4 | 9.4 | 9.4 | 12.0 | 12.0 | 12.0 | 12.1 | 11.0 | 11.9 | 12.0 | 12.0 | 12.0 |
| Li₂O + MgO | 4.8 | 4.8 | 4.8 | 4.8 | 6.1 | 6.2 | 6.1 | 6.3 | 6.1 | 6.1 | 7.6 | 6.1 | 6.1 |
| RO | 3.4 | 3.4 | 3.4 | 3.4 | 2.4 | 2.3 | 2.3 | 2.3 | 3.1 | 3.6 | 4.5 | 2.6 | 2.6 |
| B₂O₃ + MgO + CaO | 3.5 | 3.5 | 3.5 | 3.5 | 2.5 | 2.4 | 2.4 | 2.4 | 3.2 | 3.7 | 4.6 | 2.7 | 2.7 |
| R₂O | 11.1 | 12.1 | 12.6 | 13.4 | 13.9 | 13.5 | 13.5 | 13.6 | 12.9 | 11.9 | 12.0 | 13.9 | 13.9 |
| R₂O/Al₂O₃ | 2.2 | 2.4 | 2.8 | 3.0 | 2.3 | 2.3 | 2.3 | 2.2 | 2.1 | 2.0 | 2.0 | 2.0 | 2.5 |
| RO/R₂O | 0.31 | 0.28 | 0.27 | 0.25 | 0.17 | 0.17 | 0.17 | 0.17 | 0.24 | 0.30 | 0.38 | 0.19 | 0.19 |
| Al₂O₃/(R₂O + RO) | 0.34 | 0.32 | 0.28 | 0.27 | 0.37 | 0.38 | 0.38 | 0.39 | 0.38 | 0.39 | 0.36 | 0.42 | 0.33 |
| Na₂O/Li₂O | 0.75 | 0.96 | 0.96 | 0.96 | 0.97 | 0.94 | 0.97 | 0.92 | 0.80 | 0.95 | 0.97 | 0.97 | 0.97 |
| (ZnO + R₂O)/Al₂O₃ | 2.22 | 2.42 | 2.80 | 2.98 | 2.32 | 2.25 | 2.25 | 2.19 | 2.11 | 1.98 | 2.00 | 1.99 | 2.53 |
| MgO/Al₂O₃ | 0.00 | 0.00 | 0.00 | 0.00 | 0.00 | 0.00 | 0.00 | 0.00 | 0.00 | 0.00 | 0.25 | 0.00 | 0.00 |
| (SiO₂ + B₂O₃ + P₂O₅)/ | 0.65 | 0.65 | 0.65 | 0.65 | 0.65 | 0.65 | 0.65 | 0.65 | 0.65 | 0.65 | 0.65 | 0.65 | 0.65 |
| ((100 × SnO₂) × | | | | | | | | | | | | | |
| (R₂O + RO + | | | | | | | | | | | | | |
| ZnO + Al₂O₃)) | | | | | | | | | | | | | |
| SiO₂ + 1.2 × P₂O₅- | 4.66 | 4.66 | 4.66 | 4.66 | 4.66 | 4.66 | 4.66 | 4.66 | 4.66 | 4.66 | 4.66 | 4.66 | 4.66 |
| 3 × Al₂O₃-B₂O₃- | | | | | | | | | | | | | |
| 2 × Li₂O- | | | | | | | | | | | | | |
| 1.5 × Na₂O-K₂O | | | | | | | | | | | | | |
| X | 171 | 148 | 134 | 135 | 206 | 212 | 205 | 223 | 235 | 211 | 208 | 236 | 193 |
| W | 154 | 125 | 115 | 115 | 169 | 177 | 170 | 185 | 193 | 159 | 165 | 185 | 158 |

TABLE 24

| Component | No. | No. | No. | No. | No. | No. | No. |
|---|---|---|---|---|---|---|---|
| (mol %) | 298 | 299 | 300 | 301 | 302 | 303 | 304 |
| SiO₂ | 78.70 | 75.80 | 73.80 | 73.80 | 73.80 | 75.80 | 75.80 |
| Al₂O₃ | 4.0 | 7.2 | 7.2 | 7.2 | 7.2 | 7.2 | 7.2 |
| B₂O₃ | 0.1 | 0.1 | 0.1 | 0.1 | 0.1 | 0.1 | 0.1 |
| Di₂O | 6.1 | 8.1 | 8.1 | 6.1 | 4.1 | 6.1 | 4.1 |
| Na₂O | 5.9 | 3.8 | 3.8 | 5.8 | 7.8 | 3.8 | 5.8 |
| K₂O | 1.9 | 2.7 | 2.7 | 2.7 | 2.7 | 2.7 | 2.7 |
| MgO | 0.0 | 0.0 | 0.0 | 0.0 | 0.0 | 0.0 | 0.0 |
| CaO | 2.6 | 3.7 | 3.7 | 3.7 | 3.7 | 3.7 | 3.7 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 |
| TiO₂ | 0.000 | 0.000 | 0.000 | 0.000 | 0.000 | 0.000 | 0.000 |
| ZrO₂ | 0.5 | 0.5 | 0.5 | 0.5 | 0.5 | 0.5 | 0.5 |
| SnO₂ | 0.2 | 0.1 | 0.1 | 0.1 | 0.1 | 0.1 | 0.1 |
| Y₂O₃ | 0.0 | 0.0 | 0.0 | 0.0 | 0.0 | 0.0 | 0.0 |
| Fe₂O₃ | 0.000 | 0.000 | 0.000 | 0.000 | 0.000 | 0.000 | 0.000 |
| P₂O₅ | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 |
| Cl | 0.00 | 0.00 | 0.00 | 0.00 | 0.00 | 0.00 | 0.00 |
| MoO₃ | 0.000 | 0.000 | 0.000 | 0.000 | 0.000 | 0.000 | 0.000 |
| Sb₂O₃ | 0.000 | 0.000 | 0.000 | 0.000 | 0.000 | 0.000 | 0.000 |
| Li₂O + | 12.0 | 11.9 | 11.9 | 11.9 | 11.9 | 9.9 | 9.9 |
| Na₂O | | | | | | | |
| Li₂O + | 6.1 | 6.1 | 8.1 | 6.1 | 4.1 | 6.1 | 4.1 |
| MgO | | | | | | | |
| RO | 2.6 | 3.7 | 3.7 | 3.7 | 3.7 | 3.7 | 3.7 |
| B₂O₃ + | 2.7 | 3.8 | 3.8 | 3.8 | 3.8 | 3.8 | 3.8 |
| MgO + | | | | | | | |
| CaO | | | | | | | |
| R₂O | 13.9 | 13.8 | 14.6 | 14.6 | 14.6 | 12.6 | 12.6 |
| R₂O/ | 3.5 | 2.1 | 2.0 | 2.0 | 2.0 | 1.8 | 1.8 |
| Al₂O₃ | | | | | | | |
| RO/R₂O | 0.19 | 0.27 | 0.25 | 0.25 | 0.25 | 0.29 | 0.29 |
| Al₂O₃/ | 0.24 | 0.37 | 0.39 | 0.39 | 0.39 | 0.44 | 0.44 |
| (R₂O + | | | | | | | |
| RO) | | | | | | | |
| Na₂O/ | 0.97 | 0.95 | 0.47 | 0.95 | 1.90 | 1.41 | 1.41 |
| Li₂O | | | | | | | |
| (ZnO + | 3.48 | 2.12 | 2.03 | 2.03 | 2.03 | 1.75 | 1.75 |
| R₂O)/ | | | | | | | |
| Al₂O₃ | | | | | | | |
| MgO/ | 0.00 | 0.00 | 0.00 | 0.00 | 0.00 | 0.00 | 0.00 |
| Al₂O₃ | | | | | | | |
| (SiO₂ + | 0.65 | 0.65 | 0.65 | 0.65 | 0.65 | 0.65 | 0.65 |
| B₂O₃ + | | | | | | | |
| P₂O₅)/ | | | | | | | |
| ((100 × | | | | | | | |
| SnO₂) × | | | | | | | |
| (R₂O + | | | | | | | |
| RO + | | | | | | | |
| ZnO + | | | | | | | |
| Al₂O₃)) | | | | | | | |
| SiO₂ + | 4.66 | 4.66 | 4.66 | 4.66 | 4.66 | 4.66 | 4.66 |
| 1.2 × | | | | | | | |
| P₂O₅- | | | | | | | |
| 3 × | | | | | | | |
| Al₂O₃- | | | | | | | |
| B₂O₃- | | | | | | | |
| 2 × | | | | | | | |
| Li₂O- | | | | | | | |
| 1.5 × | | | | | | | |
| Na₂O- | | | | | | | |
| K₂O | | | | | | | |
| X | 150 | 228 | 395 | 249 | 104 | 295 | 149 |
| W | 130 | 167 | 321 | 180 | 38 | 238 | 97 |
| Component | No. | No. | No. | No. | No. | No. | |
| (mol %) | 305 | 306 | 307 | 308 | 309 | 310 | |
| SiO₂ | 77.80 | 77.70 | 77.80 | 76.80 | 76.70 | 76.80 | |
| Al₂O₃ | 7.2 | 7.2 | 7.2 | 7.2 | 7.2 | 7.2 | |
| B₂O₃ | 0.1 | 0.1 | 0.1 | 0.1 | 0.1 | 0.1 | |
| Di₂O | 6.1 | 4.1 | 2.1 | 3.1 | 4.1 | 4.6 | |
| Na₂O | 1.8 | 3.8 | 5.8 | 5.7 | 4.8 | 4.3 | |
| K₂O | 2.7 | 2.7 | 2.7 | 2.7 | 2.7 | 2.7 | |
| MgO | 0.0 | 0.0 | 0.0 | 0.0 | 0.0 | 0.0 | |
| CaO | 3.7 | 3.7 | 3.6 | 3.7 | 3.7 | 3.7 | |
| SrO | 0.0 | 0.0 | 0.0 | 0.0 | 0.0 | 0.0 | |
| BaO | 0.0 | 0.0 | 0.0 | 0.0 | 0.0 | 0.0 | |
| ZnO | 0.0 | 0.0 | 0.0 | 0.0 | 0.0 | 0.0 | |
| TiO₂ | 0.000 | 0.000 | 0.000 | 0.000 | 0.000 | 0.000 | |
| ZrO₂ | 0.5 | 0.5 | 0.5 | 0.5 | 0.5 | 0.5 | |
| SnO₂ | 0.1 | 0.2 | 0.2 | 0.2 | 0.2 | 0.1 | |
| Y₂O₃ | 0.0 | 0.0 | 0.0 | 0.0 | 0.0 | 0.0 | |
| Fe₂O₃ | 0.000 | 0.000 | 0.000 | 0.000 | 0.000 | 0.000 | |
| P₂O₅ | 0.0 | 0.0 | 0.0 | 0.0 | 0.0 | 0.0 | |
| SO₃ | 0.000 | 0.000 | 0.000 | 0.000 | 0.000 | 0.000 | |
| Cl | 0.00 | 0.00 | 0.00 | 0.00 | 0.00 | 0.00 | |
| MoO₃ | 0.000 | 0.000 | 0.000 | 0.000 | 0.000 | 0.000 | |
| Sb₂O₃ | 0.000 | 0.000 | 0.000 | 0.000 | 0.000 | 0.000 | |
| Li₂O + | 7.9 | 7.9 | 7.9 | 8.8 | 8.9 | 8.9 | |
| Na₂O | | | | | | | |
| Li₂O + | 6.1 | 4.1 | 2.1 | 3.1 | 4.1 | 4.6 | |
| MgO | | | | | | | |
| RO | 3.7 | 3.7 | 3.6 | 3.7 | 3.7 | 3.7 | |
| B₂O₃ + | 3.8 | 3.8 | 3.7 | 3.8 | 3.8 | 3.8 | |
| MgO + | | | | | | | |
| CaO | | | | | | | |
| R₂O | 10.6 | 10.6 | 10.6 | 11.5 | 11.6 | 11.6 | |
| R₂O/ | 1.5 | 1.5 | 1.5 | 1.6 | 1.6 | 1.6 | |
| Al₂O₃ | | | | | | | |
| RO/R₂O | 0.35 | 0.35 | 0.34 | 0.32 | 0.32 | 0.32 | |
| Al₂O₃/ | 0.50 | 0.50 | 0.51 | 0.47 | 0.47 | 0.47 | |
| (R₂O + | | | | | | | |
| RO) | | | | | | | |
| Na₂O/ | 0.30 | 0.93 | 2.76 | 1.84 | 1.17 | 0.93 | |
| Li₂O | | | | | | | |
| (ZnO + | 1.47 | 1.47 | 1.47 | 1.60 | 1.61 | 1.61 | |
| R₂O)/ | | | | | | | |
| Al₂O₃ | | | | | | | |
| MgO/ | 0.00 | 0.00 | 0.00 | 0.00 | 0.00 | 0.00 | |
| Al₂O₃ | | | | | | | |
| (SiO₂ + | 0.65 | 0.65 | 0.65 | 0.65 | 0.65 | 0.65 | |
| B₂O₃ + | | | | | | | |
| P₂O₅)/ | | | | | | | |
| ((100 × | | | | | | | |
| SnO₂) × | | | | | | | |
| (R₂O + | | | | | | | |
| RO + | | | | | | | |
| ZnO + | | | | | | | |
| Al₂O₃)) | | | | | | | |
| SiO₂ + | 4.66 | 4.66 | 4.66 | 4.66 | 4.66 | 4.66 | |
| 1.2 × | | | | | | | |
| P₂O₅- | | | | | | | |
| 3 × | | | | | | | |
| Al₂O₃- | | | | | | | |
| B₂O₃- | | | | | | | |
| 2 × | | | | | | | |
| Li₂O- | | | | | | | |
| 1.5 × | | | | | | | |
| Na₂O- | | | | | | | |
| K₂O | | | | | | | |

| | | | | | | |
|---|---|---|---|---|---|---|
| X | 341 | 195 | 49 | 102 | 172 | 208 |
| W | 297 | 156 | 15 | 59 | 126 | 162 |

TABLE 25

| Component | No. | No. | No. | No. | No. | No. | No. | No. | No. | No. |
|---|---|---|---|---|---|---|---|---|---|---|
| (mol %) | 311 | 312 | 313 | 314 | 315 | 316 | 317 | 318 | 319 | 320 |
| SiO₂ | 76.70 | 76.70 | 76.60 | 75.80 | 75.60 | 76.90 | 78.40 | 79.90 | 79.00 | 79.80 |
| Al₂O₃ | 7.3 | 7.2 | 7.3 | 7.2 | 7.3 | 6.0 | 5.5 | 5.0 | 5.3 | 5.0 |
| B₂O₃ | 0.1 | 0.1 | 0.1 | 0.1 | 0.1 | 0.1 | 0.1 | 0.1 | 0.1 | 0.1 |
| Di₂O | 5.1 | 6.1 | 7.1 | 5.1 | 7.1 | 8.1 | 7.1 | 6.1 | 4.8 | 4.8 |
| Na₂O | 3.8 | 2.9 | 1.9 | 4.8 | 2.9 | 1.9 | 1.9 | 1.9 | 2.7 | 2.7 |
| K₂O | 2.7 | 2.7 | 2.7 | 2.7 | 2.7 | 2.7 | 2.7 | 2.7 | 3.9 | 3.6 |
| MgO | 0.0 | 0.0 | 0.0 | 0.0 | 0.0 | 0.0 | 0.0 | 0.0 | 0.0 | 0.0 |
| CaO | 3.7 | 3.7 | 3.7 | 3.7 | 3.7 | 3.6 | 3.6 | 3.6 | 3.6 | 3.4 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.000 | 0.000 | 0.000 | 0.000 | 0.000 | 0.000 | 0.000 | 0.000 | 0.000 | 0.000 |
| ZrO₂ | 0.5 | 0.5 | 0.5 | 0.5 | 0.5 | 0.5 | 0.5 | 0.5 | 0.5 | 0.5 |
| SnO₂ | 0.1 | 0.1 | 0.1 | 0.1 | 0.1 | 0.2 | 0.2 | 0.2 | 0.1 | 0.1 |
| Y₂O₃ | 0.0 | 0.0 | 0.0 | 0.0 | 0.0 | 0.0 | 0.0 | 0.0 | 0.0 | 0.0 |
| Fe₂O₃ | 0.000 | 0.000 | 0.000 | 0.000 | 0.000 | 0.000 | 0.000 | 0.000 | 0.000 | 0.000 |
| P₂O₅ | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 |
| Cl | 0.00 | 0.00 | 0.00 | 0.00 | 0.00 | 0.00 | 0.00 | 0.00 | 0.00 | 0.00 |
| MoO₃ | 0.000 | 0.000 | 0.000 | 0.000 | 0.000 | 0.000 | 0.000 | 0.000 | 0.000 | 0.000 |
| Sb₂O₃ | 0.000 | 0.000 | 0.000 | 0.000 | 0.000 | 0.000 | 0.000 | 0.000 | 0.000 | 0.000 |
| Li₂O + Na₂O | 8.9 | 9.0 | 9.0 | 9.9 | 10.0 | 10.0 | 9.0 | 8.0 | 7.5 | 7.5 |
| Li₂O + MgO | 5.1 | 6.1 | 7.1 | 5.1 | 7.1 | 8.1 | 7.1 | 6.1 | 4.8 | 4.8 |
| RO | 3.7 | 3.7 | 3.7 | 3.7 | 3.7 | 3.6 | 3.6 | 3.6 | 3.6 | 3.4 |
| B₂O₃ + MgO + CaO | 3.8 | 3.8 | 3.8 | 3.8 | 3.8 | 3.7 | 3.7 | 3.7 | 3.7 | 3.5 |
| R₂O | 11.6 | 11.7 | 11.7 | 12.6 | 12.7 | 12.7 | 11.7 | 10.7 | 11.4 | 11.1 |
| R₂O/Al₂O₃ | 1.6 | 1.6 | 1.6 | 1.8 | 1.7 | 2.1 | 2.1 | 2.1 | 2.2 | 2.2 |
| RO/R₂O | 0.32 | 0.32 | 0.32 | 0.29 | 0.29 | 0.28 | 0.31 | 0.34 | 0.32 | 0.31 |
| Al₂O₃/(R₂O + RO) | 0.48 | 0.47 | 0.47 | 0.44 | 0.45 | 0.37 | 0.36 | 0.35 | 0.35 | 0.34 |
| Na₂O/Li₂O | 0.75 | 0.48 | 0.27 | 0.94 | 0.41 | 0.23 | 0.27 | 0.31 | 0.56 | 0.56 |
| (ZnO + R₂O)/Al₂O₃ | 1.59 | 1.63 | 1.60 | 1.75 | 1.74 | 2.12 | 2.13 | 2.14 | 2.15 | 2.22 |
| MgO/Al₂O₃ | 0.00 | 0.00 | 0.00 | 0.00 | 0.00 | 0.00 | 0.00 | 0.00 | 0.00 | 0.00 |
| (SiO₂ + B₂O₃ + P₂O₅)/ | 0.65 | 0.65 | 0.65 | 0.65 | 0.65 | 0.65 | 0.65 | 0.65 | 0.65 | 0.65 |
| ((100 × SnO₂) × | | | | | | | | | | |
| (R₂O + RO + | | | | | | | | | | |
| ZnO + Al₂O₃)) | | | | | | | | | | |
| SiO₂ + 1.2 × P₂O₅- | 4.66 | 4.66 | 4.66 | 4.66 | 4.66 | 4.66 | 4.66 | 4.66 | 4.66 | 4.66 |
| 3 × Al₂O₃-B₂O₃- | | | | | | | | | | |
| 2 × Li₂O- | | | | | | | | | | |
| 1.5 × Na₂O-K₂O | | | | | | | | | | |
| X | 248 | 316 | 391 | 222 | 368 | 404 | 340 | 275 | 202 | 192 |
| W | 199 | 265 | 337 | 168 | 308 | 356 | 306 | 256 | 184 | 180 |

TABLE 26

| | No. | No. | No. | No. | No. | No. | No. | No. | No. | No. | No. | No. | No. |
|---|---|---|---|---|---|---|---|---|---|---|---|---|---|
| Characteristic | 1 | 2 | 3 | 4 | 5 | 6 | 7 | 8 | 9 | 10 | 11 | 12 | 13 |
| ρ (g/cm³) | 2.442 | 2.446 | 2.451 | 2.426 | 2.432 | 2.416 | 2.422 | 2.436 | 2.429 | 2.452 | 2.436 | 2.448 | 2.457 |
| α_{30-380 °C} (10⁻⁷/°C) | 60 | 49 | 52 | 50 | 53 | 50 | 53 | 69 | 65 | 51 | 56 | 63 | 54 |
| Ts (°C) | 812 | N.A. | N.A. | N.A. | N.A. | N.A. | N.A. | N.A. | N.A. | N.A. | N.A. | N.A. | N.A. |
| 10^{2.5} dPa · s (°C) | 1,457 | 1,484 | 1,511 | 1,512 | 1,546 | 1,454 | 1,476 | 1,465 | 1,445 | 1,450 | 1,446 | 1,486 | 1,474 |
| E (GPa) | 87 | 89 | 88 | 87 | 86 | 85 | 84 | 85 | 86 | 89 | 88 | 85 | 88 |
| Klc (MPa · m^{0.5}) | 0.82 | N.A. | N.A. | N.A. | N.A. | N.A. | N.A. | N.A. | N.A. | N.A. | N.A. | N.A. | N.A. |
| Transmittance | 91.2 | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | 534 | 585 | 386 | 520 | 389 | 535 | 363 | 523 | 683 | 586 | 739 | 394 | 391 |
| CS30 (MPa) | 149 | 61 | 103 | 105 | 118 | 70 | 99 | 180 | 181 | 48 | 91 | 133 | 95 |
| DOC (μm) | 55 | 40 | 53 | 48 | 56 | 43 | 54 | 60 | 53 | 38 | 42 | 60 | 51 |
| CT_{CV} (MPa) | 47 | 35 | 34 | 39 | 37 | 33 | 33 | 55 | 62 | 33 | 47 | 42 | 32 |
| Acid resistance | 0.00 | 0.05 | 0.07 | 0.00 | 0.00 | 0.04 | 0.09 | 0.00 | 0.00 | 0.00 | 0.00 | 0.00 | 0.01 |
| (mg/cm²) | | | | | | | | | | | | | |
| Alkali | 0.40 | 0.57 | 0.55 | 0.48 | 0.53 | 0.62 | 0.59 | 0.40 | 0.39 | 0.50 | 0.42 | 0.47 | 0.48 |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg /cm²) | | | | | | | | | | | | | |

TABLE 27

| | | No. | No. | No. | No. | No. | No. | No. | No. | No. | No. | No. | No. |
|---|---|---|---|---|---|---|---|---|---|---|---|---|---|
| Characteristic | | 14 | 15 | 16 | 17 | 18 | 19 | 20 | 21 | 22 | 23 | 24 | 25 |
| ρ (g/cm³) | | 2.469 | 2.493 | 2.550 | 2.657 | 2.621 | 2.798 | 2.438 | 2.434 | 2.442 | 2.444 | 2.401 | 2.547 |
| α_{30-380 °C} (10⁻⁷/°C) | | N.A. | N.A. | 65 | 70 | 66 | 72 | 57 | 57 | 57 | 59 | 74 | 86 |
| Ts (°C) | | N.A. | 775 | N.A. | 753 | 792 | 743 | N.A. | N.A. | N.A. | N.A. | 908 | N.A. |
| 10^{2.5} dPa · s (°C) | | 1,440 | 1,414 | 1,453 | 1,404 | 1,462 | 1,410 | 1,481 | 1,493 | 1,482 | 1,474 | 1,575 | 1,215 |
| E (GPa) | | 86 | 86 | 86 | 85 | 84 | 82 | 87 | 86 | 87 | 87 | 74 | N.A. |
| Klc (MPa · m^{0.5}) | | N.A. | N.A. | N.A. | N.A. | N.A. | N.A. | N.A. | N.A. | N.A. | N.A. | 0.76 | N.A. |
| Transmittance | | N.A. | N.A. | N.A. | N.A. | N.A. | N.A. | 91.3 | 91.4 | 91.3 | 91.3 | 91.3 | N.A. |
| at 400 nm | | | | | | | | | | | | | |
| CS (MPa) | | 569 | 578 | 581 | 630 | 636 | 715 | 449 | 488 | 503 | 469 | 252 | N.A. |
| CS30 (MPa) | | 75 | N.A. | 39 | N.A. | 29 | N.A. | 126 | 124 | 110 | 122 | 157 | N.A. |
| DOC (μm) | | 45 | 35 | 37 | 30 | 35 | 25 | 54 | 52 | 49 | 53 | 107 | N.A. |
| CT_{CV} (MPa) | | 42 | 20 | 32 | 24 | 31 | 25 | 41 | 42 | 40 | 41 | 38 | N.A. |
| Acid resistance | | 0.01 | 0.01 | 0.01 | 0.02 | 0.02 | 0.03 | 0.00 | 0.00 | 0.01 | 0.01 | 19.90 | N.A. |
| (mg/cm²) | | | | | | | | | | | | | |
| Alkali | | 0.20 | 0.20 | 0.45 | 0.53 | 0.48 | 0.68 | 0.42 | 0.43 | 0.43 | 0.43 | 1.50 | N.A. |
| resistance | | | | | | | | | | | | | |
| (mg/cm²) | | | | | | | | | | | | | |
| Hydrofluoric | | N.A. | N.A. | N.A. | N.A. | N.A. | N.A. | N.A. | N.A. | N.A. | N.A. | 27.6 | N.A. |
| acid resistance | | | | | | | | | | | | | |
| (mg /cm²) | | | | | | | | | | | | | |
| After | E (GPa) | N.A. | N.A. | N.A. | N.A. | N.A. | N.A. | N.A. | N.A. | N.A. | N.A. | N.A. | 100 |
| crystallization | Klc (MPa · m^{0.5}) | N.A. | N.A. | N.A. | N.A. | N.A. | N.A. | N.A. | N.A. | N.A. | N.A. | N.A. | 1.8 |
| | Transmittance | N.A. | N.A. | N.A. | N.A. | N.A. | N.A. | N.A. | N.A. | N.A. | N.A. | N.A. | 72.5 |
| | at 400 nm | | | | | | | | | | | | |

TABLE 28

| | No. | No. | No. | No. | No. | No. | No. | No. | No. | No. | No. | No. | No. |
|---|---|---|---|---|---|---|---|---|---|---|---|---|---|
| Characteristic | 26 | 27 | 28 | 29 | 30 | 31 | 32 | 33 | 34 | 35 | 36 | 37 | 38 |
| ρ (g/cm³) | 2.452 | 2.456 | 2.441 | 2.466 | 2.453 | 2.459 | 2.478 | 2.469 | 2.471 | 2.480 | 2.456 | 2.464 | 2.454 |
| α_{30-380 °C} (10⁻⁷/°C) | 55 | 62 | 81 | 68 | 85 | 99 | 71 | 88 | 105 | 120 | 67 | 75 | 94 |
| Ts (°C) | 1,012 | 962.5 | 948 | 895.5 | 845 | 758.5 | 834.5 | 770.5 | 703.5 | 650.5 | 1,007 | N.A. | 907.5 |
| 10^{2.5} dPa · s (°C) | 1,644 | 1,606 | 1,652 | 1,521 | 1,501 | 1,434 | 1,404 | 1,364 | 1,302 | 1,240 | 1,640 | 1,596 | 1,614 |
| E (GPa) | 80 | 78 | N.A. | 77 | N.A. | N.A. | 77 | N.A. | N.A. | N.A. | 78 | 77 | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | 811 | 868 | 1,273 | 845 | 1,115 | 831 | N.A. | 947 | 725 | N.A. | 828 | 863 | 1,167 |
| CS30 (MPa) | N.A. | N.A. | N.A. | N.A. | N.A. | N.A. | N.A. | N.A. | N.A. | N.A. | N.A. | N.A. | N.A. |
| DOC (μm) | 6 | 6 | 17 | 6 | N.A. | 1.9 | N.A. | N.A. | N.A. | N.A. | 11 | N.A. | 23 |
| CT_{CV} (MPa) | 10 | 62 | 18 | 72 | N.A. | 25 | N.A. | N.A. | N.A. | N.A. | 70 | N.A. | 30 |
| Acid resistance | 0.23 | 0.04 | 0.12 | 0.01 | 0.03 | 0.07 | 0.04 | 0.03 | 0.02 | 0.09 | 15.26 | 0.25 | 3.70 |
| (mg/cm²) | | | | | | | | | | | | | |
| Alkali | 0.78 | 0.63 | 0.61 | 0.49 | 0.54 | 0.68 | 0.47 | 0.52 | 0.61 | 0.86 | 0.80 | 0.62 | 0.66 |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg /cm²) | | | | | | | | | | | | | |

TABLE 29

| | No. | No. | No. | No. | No. | No. | No. | No. | No. | No. | No. | No. | No. |
|---|---|---|---|---|---|---|---|---|---|---|---|---|---|
| Characteristic | 39 | 40 | 41 | 42 | 43 | 44 | 45 | 46 | 47 | 48 | 49 | 50 | 51 |
| ρ (g/cm³) | 2.475 | 2.464 | 2.473 | 2.489 | 2.481 | 2.484 | 2.491 | 2.434 | 2.448 | 2.436 | 2.463 | 2.449 | 2.448 |
| α_{30-380 °C} (10⁻⁷/°C) | 79 | 96 | 110 | 82 | 101 | 117 | 131 | 54 | 63 | 85 | 72 | 87 | 101 |
| Ts (°C) | 872.5 | 812.5 | 725 | 807 | 742.5 | 674.5 | 625 | 1,008 | 972.5 | 983.5 | N.A. | 858.5 | 800 |
| 10^{2.5} dPa · s (°C) | 1,487 | 1,462 | 1,393 | 1,371 | 1,330 | 1,267 | 1,209 | 1,658 | 1,604 | 1,643 | 1,529 | 1,508 | 1,442 |
| E (GPa) | 77 | N.A. | N.A. | 77 | N.A. | N.A. | N.A. | 76 | 76 | N.A. | 75 | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | 812 | 1,018 | 728 | 770 | 896 | 640 | N.A. | 780 | 833 | 1,169 | 783 | 1,001 | 786 |
| CS30 (MPa) | N.A. | N.A. | N.A. | N.A. | N.A. | N.A. | N.A. | N.A. | N.A. | N.A. | N.A. | N.A. | N.A. |
| DOC (μm) | 9 | 18 | 26 | 5 | 12 | 24 | N.A. | 6 | 10 | 25 | 15 | 15 | 23 |
| CT_{CV} (MPa) | 7 | 20 | 22 | 133 | 3 | 9 | N.A. | 46 | 22 | 49 | 2 | 2 | 23 |
| Acid resistance | 0.03 | 0.10 | 0.15 | 0.03 | 0.04 | 0.04 | 0.25 | 1.42 | 0.09 | 0.10 | 0.06 | 0.09 | 0.09 |
| (mg/cm²) | | | | | | | | | | | | | |
| Alkali | 0.61 | 0.64 | 0.93 | 0.51 | 0.62 | 0.76 | 1.17 | 1.19 | 0.93 | 0.82 | 1.02 | 0.87 | 0.86 |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg /cm²) | | | | | | | | | | | | | |

TABLE 30

| | No. | No. | No. | No. | No. | No. | No. | No. | No. | No. | No. | No. | No. | No. |
|---|---|---|---|---|---|---|---|---|---|---|---|---|---|---|
| Characteristic | 52 | 53 | 54 | 55 | 56 | 57 | 58 | 59 | 60 | 61 | 62 | 63 | 64 | 65 |
| ρ (g/cm³) | 2.473 | 2.463 | 2.463 | 2.471 | 2.441 | 2.460 | 2.450 | 2.475 | 2.457 | 2.465 | 2.486 | 2.475 | 2.477 | 2.485 |
| α_{30-380 °C} | 72 | 90 | 106 | 122 | 67 | 78 | 96 | 83 | 98 | 114 | 83 | 102 | 118 | 135 |
| (10⁻⁷/°C) | | | | | | | | | | | | | | |
| Ts (°C) | 822.5 | 756 | 727 | 676 | 999 | 979 | 935.5 | N.A. | 826.5 | 769.5 | 790.5 | 728 | 702.5 | 651 |
| 10^{2.5} dPa · s | 1,416 | 1,368 | 1,308 | 1,244 | 1,640 | 1,592 | 1,612 | 1,496 | 1,468 | 1,409 | 1,376 | 1,332 | 1,270 | 1,205 |
| (°C) | | | | | | | | | | | | | | |
| E (GPa) | 75 | N.A. | N.A. | N.A. | 75 | 75 | N.A. | 75 | N.A. | N.A. | 75 | N.A. | N.A. | N.A. |
| Klc | N.A. | N.A. | N.A. | N.A. | N.A. | N.A. | N.A. | N.A. | N.A. | N.A. | N.A. | N.A. | N.A. | N.A. |
| (MPa · m^{0.5}) | | | | | | | | | | | | | | |
| Transmittance | N.A. | N.A. | N.A. | N.A. | N.A. | N.A. | N.A. | N.A. | N.A. | N.A. | N.A. | N.A. | N.A. | N.A. |
| at 400 nm | | | | | | | | | | | | | | |
| CS (MPa) | N.A. | 839 | 593 | N.A. | 788 | 825 | 1,066 | 744 | 918 | 709 | 659 | 774 | 536 | N.A. |
| CS30 (MPa) | N.A. | N.A. | N.A. | N.A. | N.A. | N.A. | N.A. | N.A. | N.A. | N.A. | N.A. | N.A. | N.A. | N.A. |
| DOC (μm) | N.A. | 9 | 23 | N.A. | N.A. | 24 | 29 | N.A. | 21 | 31 | 5 | N.A. | 30 | N.A. |
| CT_{CV} (MPa) | N.A. | 78 | 2 | N.A. | N.A. | 6 | 37 | N.A. | 6 | 26 | 98 | N.A. | 14 | N.A. |
| Acid | 0.03 | 0.05 | 0.06 | 0.17 | 5.31 | 0.13 | 0.21 | 0.04 | 0.11 | 0.15 | 0.07 | 0.12 | 0.16 | 0.60 |
| resistance | | | | | | | | | | | | | | |
| (mg/cm²) | | | | | | | | | | | | | | |
| Alkali | 0.66 | 0.71 | 0.84 | 1.14 | 1.33 | 1.07 | 0.98 | 0.92 | 0.75 | 0.94 | 0.56 | 0.65 | 0.82 | 1.13 |
| resistance | | | | | | | | | | | | | | |
| (mg/cm²) | | | | | | | | | | | | | | |
| Hydrofluoric | N.A. | N.A. | N.A. | N.A. | N.A. | N.A. | N.A. | N.A. | N.A. | N.A. | N.A. | N.A. | N.A. | N.A. |
| acid | | | | | | | | | | | | | | |
| resistance | | | | | | | | | | | | | | |
| (mg /cm²) | | | | | | | | | | | | | | |

TABLE 31

| | No. | No. | No. | No. | No. | No. | No. | No. | No. | No. |
|---|---|---|---|---|---|---|---|---|---|---|
| Characteristic | 66 | 67 | 68 | 69 | 70 | 71 | 72 | 73 | 74 | 75 |
| ρ (g/cm³) | 2.411 | 2.412 | 2.413 | 2.414 | 2.410 | 2.409 | 2.410 | 2.408 | 2.407 | 2.404 |
| α_{30-380 °C} (10⁻⁷/°C) | 75 | 76 | 75 | 76 | 76 | 75 | 75 | 75 | 76 | 74 |
| Ts (°C) | 837 | 854 | 869 | 883 | 856 | 824 | 838 | 793 | 911 | 790 |
| 10^{2.5} dPa · s (°C) | 1,582 | 1,598 | 1,606 | 1,610 | 1,608 | 1,571 | 1,590 | 1,544 | 1,676 | 1,542 |
| E (GPa) | N.A. | N.A. | N.A. | N.A. | N.A. | N.A. | N.A. | 70 | N.A. | N.A. |
| Klc (MPa · m^{0.5}) | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | 91.3 | N.A. | N.A. |
| at 400 nm | | | | | | | | | | |
| CS (MPa) | N.A. | N.A. | N.A. | N.A. | N.A. | N.A. | N.A. | 899 | N.A. | N.A. |
| CS30 (MPa) | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | 12 | N.A. | N.A. |
| CT_{CV} (MPa) | N.A. | N.A. | N.A. | N.A. | N.A. | N.A. | N.A. | 15 | N.A. | N.A. |
| Acid resistance | N.A. | N.A. | N.A. | N.A. | N.A. | N.A. | N.A. | 0.06 | N.A. | N.A. |
| (mg/cm²) | | | | | | | | | | |
| Alkali | N.A. | N.A. | N.A. | N.A. | N.A. | N.A. | N.A. | 0.53 | N.A. | N.A. |
| resistance | | | | | | | | | | |
| (mg/cm²) | | | | | | | | | | |
| Hydrofluoric | N.A. | N.A. | N.A. | N.A. | N.A. | N.A. | N.A. | 3.4 | N.A. | N.A. |
| acid resistance | | | | | | | | | | |
| (mg /cm²) | | | | | | | | | | |

TABLE 32

| | No. | No. | No. | No. | No. | No. | No. | No. | No. | No. | No. | No. | No. |
|---|---|---|---|---|---|---|---|---|---|---|---|---|---|
| Characteristic | 76 | 77 | 78 | 79 | 80 | 81 | 82 | 83 | 84 | 85 | 86 | 87 | 88 |
| ρ (g/cm³) | 2.377 | 2.401 | 2.402 | 2.450 | 2.466 | 2.391 | 2.391 | 2.394 | 2.390 | 2.387 | 2.380 | 2.412 | 2.416 |
| α_{30-380 °C} (10⁻⁷/°C) | 64 | 76 | 77 | 90 | 90 | 69 | 71 | 72 | 68 | 70 | 67 | 76 | 78 |
| Ts (°C) | 897 | 901 | 901 | 879 | 883 | 824 | 866 | 916 | 789 | 808 | 762 | 788 | 815 |
| 10^{2.5} dPa · s (°C) | 1,656 | 1,616 | 1,655 | 1,579 | 1,580 | 1,608 | 1,663 | 1,683 | 1,562 | 1,582 | 1,523 | 1,558 | 1,585 |
| E (GPa) | N.A. | N.A. | N.A. | N.A. | N.A. | 70 | N.A. | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | N.A. | N.A. | N.A. | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. | N.A. | N.A. | N.A. |
| Acid resistance | N.A. | N.A. | N.A. | N.A. | N.A. | N.A. | N.A. | N.A. | N.A. | N.A. | N.A. | N.A. | N.A. |
| (mg/cm²) | | | | | | | | | | | | | |
| Alkali | N.A. | N.A. | N.A. | N.A. | N.A. | N.A. | N.A. | N.A. | N.A. | N.A. | N.A. | N.A. | N.A. |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg /cm²) | | | | | | | | | | | | | |

TABLE 33

| | No. | No. | No. | No. | No. | No. | No. | No. | No. | No. | No. | No. | No. |
|---|---|---|---|---|---|---|---|---|---|---|---|---|---|
| Characteristic | 89 | 90 | 91 | 92 | 93 | 94 | 95 | 96 | 97 | 98 | 99 | 100 | 101 |
| ρ (g/cm³) | 2.417 | 2.413 | 2.413 | 2.403 | 2.441 | 2.375 | 2.373 | 2.372 | 2.370 | 2.395 | 2.389 | 2.381 | 2.417 |
| α_{30-380 °C} (10⁻⁷/°C) | 79 | 74 | 77 | 72 | N.A. | 65 | 66 | 67 | 67 | 77 | 77 | 77 | 84 |
| Ts (°C) | 861 | 770 | 776 | 752 | N.A. | 911 | 907 | 909 | 915 | 853 | 818 | 817 | 797 |
| 10^{2.5} dPa · s (°C) | 1,622 | 1,504 | 1,526 | 1,465 | N.A. | 1,656 | 1,666 | 1,670 | 1,671 | 1,652 | 1,622 | 1,594 | 1,614 |
| E (GPa) | N.A. | N.A. | N.A. | N.A. | N.A. | N.A. | N.A. | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | N.A. | N.A. | N.A. | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. | N.A. | N.A. | N.A. |
| Acid resistance | N.A. | N.A. | N.A. | N.A. | N.A. | N.A. | N.A. | N.A. | N.A. | N.A. | N.A. | N.A. | N.A. |
| (mg/cm²) | | | | | | | | | | | | | |
| Alkali | N.A. | N.A. | N.A. | N.A. | N.A. | N.A. | N.A. | N.A. | N.A. | N.A. | N.A. | N.A. | N.A. |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg /cm²) | | | | | | | | | | | | | |

TABLE 34

| | No. | No. | No. | No. | No. | No. | No. | No. | No. | No. | No. | No. | No. | No. |
|---|---|---|---|---|---|---|---|---|---|---|---|---|---|---|
| Characteristic | 102 | 103 | 104 | 105 | 106 | 107 | 108 | 109 | 110 | 111 | 112 | 113 | 114 | 1.15 |
| ρ (g/cm³) | 2.418 | 2.442 | 2.396 | 2.391 | 2.385 | 2.395 | 2.392 | 2.390 | 2.399 | 2.395 | 2.398 | 2.403 | 2.392 | 2.391 |
| α_{30-380 °C} | 84 | 91 | 70 | 72 | 67 | 71 | 69 | 71 | 76 | 77 | 77 | 76 | 76 | 74 |
| (10⁻⁷/°C) | | | | | | | | | | | | | | |
| Ts (°C) | 777 | 771 | 782 | 903 | 760 | 789 | 770 | 775 | 781 | 874 | 833 | 802 | 804 | 766 |
| 10^{2.5} dPa · s | 1,542 | 1,529 | 1,551 | 1,574 | 1,512 | 1,545 | 1,511 | 1,526 | 1,595 | 1,628 | 1,641 | 1,551 | 1,578 | 1,527 |
| (°C) | | | | | | | | | | | | | | |
| E (GPa) | N.A. | N.A. | N.A. | N.A. | N.A. | N.A. | N.A. | N.A. | N.A. | N.A. | N.A. | N.A. | N.A. | N.A. |
| Klc | N.A. | N.A. | N.A. | N.A. | N.A. | N.A. | N.A. | N.A. | N.A. | N.A. | N.A. | N.A. | N.A. | N.A. |
| (MPa · m^{0.5}) | | | | | | | | | | | | | | |
| Transmittance | N.A. | N.A. | N.A. | N.A. | N.A. | N.A. | N.A. | N.A. | N.A. | N.A. | N.A. | N.A. | N.A. | N.A. |
| at 400 nm | | | | | | | | | | | | | | |
| CS (MPa) | N.A. | N.A. | N.A. | N.A. | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. | N.A. | N.A. | N.A. | N.A. |
| Acid | N.A. | N.A. | N.A. | N.A. | N.A. | N.A. | N.A. | N.A. | N.A. | N.A. | N.A. | N.A. | N.A. | N.A. |
| resistance | | | | | | | | | | | | | | |
| (mg/cm²) | | | | | | | | | | | | | | |
| Alkali | N.A. | N.A. | N.A. | N.A. | N.A. | N.A. | N.A. | N.A. | N.A. | N.A. | N.A. | N.A. | N.A. | N.A. |
| resistance | | | | | | | | | | | | | | |
| (mg/cm²) | | | | | | | | | | | | | | |
| Hydrofluoric | N.A. | N.A. | N.A. | N.A. | N.A. | N.A. | N.A. | N.A. | N.A. | N.A. | N.A. | N.A. | N.A. | N.A. |
| acid | | | | | | | | | | | | | | |
| resistance | | | | | | | | | | | | | | |
| (mg /cm²) | | | | | | | | | | | | | | |

TABLE 35

| | No. | No. | No. | No. | No. | No. | No. | No. | No. | No. | No. | No. | No. |
|---|---|---|---|---|---|---|---|---|---|---|---|---|---|
| Characteristic | 116 | 117 | 118 | 119 | 120 | 121 | 122 | 123 | 124 | 1.25 | 126 | 127 | 128 |
| ρ (g/cm³) | 2.374 | 2.370 | 2.376 | 2.371 | 2.364 | 2.363 | 2.402 | 2.400 | 2.395 | 2.394 | 2.401 | 2.397 | 2.393 |
| α_{30-380 °C} (10⁻⁷/°C) | 68 | 69 | 69 | 69 | 69 | 68 | 76 | 76 | 76 | 77 | 77 | 76 | 75 |
| Ts (°C) | 841 | 890 | 926 | 808 | 851 | 790 | 790 | 799 | 815 | 835 | 813 | 788 | 781 |
| 10^{2.5} dPa · s (°C) | 1,668 | 1,693 | 1,682 | 1,623 | 1,641 | 1,592 | 1,577 | 1,579 | 1,591 | 1,610 | 1,607 | 1,562 | 1,548 |
| E (GPa) | N.A. | N.A. | N.A. | N.A. | N.A. | N.A. | N.A. | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | N.A. | N.A. | N.A. | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. | N.A. | N.A. | N.A. |
| Acid resistance | N.A. | N.A. | N.A. | N.A. | N.A. | N.A. | 0.06 | 0.12 | 0.34 | 0.75 | 0.07 | 0.20 | 0.44 |
| (mg/cm²) | | | | | | | | | | | | | |
| Alkali | N.A. | N.A. | N.A. | N.A. | N.A. | N.A. | N.A. | N.A. | N.A. | N.A. | N.A. | N.A. | N.A. |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg /cm²) | | | | | | | | | | | | | |

TABLE 36

| | No. | No. | No. | No. | No. | No. | No. | No. | No. | No. | No. | No. | No. |
|---|---|---|---|---|---|---|---|---|---|---|---|---|---|
| Characteristic | 129 | 130 | 131 | 132 | 133 | 134 | 135 | 136 | 137 | 1.38 | 139 | 140 | 141 |
| ρ (g/cm³) | 2.374 | 2.371 | 2.368 | 2.367 | 2.374 | 2.367 | 2.364 | 2.361 | 2.357 | 2.353 | 2.346 | 2.432 | 2.385 |
| α_{30-380 °C} | 69 | 70 | 69 | 70 | 68 | 69 | 69 | 69 | 68 | 69 | 68 | 89 | 72 |
| (10⁻⁷/°C) | | | | | | | | | | | | | |
| Ts (°C) | 824 | 843 | 869 | 892 | 859 | 830 | 816 | 862 | 796 | 837 | 785 | 908 | 862 |
| 10^{2.5} dPa · s (°C) | 1,648 | 1,663 | 1,681 | 1,678 | 1,687 | 1,645 | 1,636 | 1,632 | 1,598 | 1,614 | 1,590 | 1,586 | 1,647 |
| E (GPa) | N.A. | N.A. | N.A. | N.A. | N.A. | N.A. | N.A. | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | N.A. | N.A. | N.A. | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. | N.A. | N.A. | N.A. |
| Acid resistance | 0.04 | 0.07 | 0.12 | 0.28 | 0.03 | 0.10 | 0.17 | N.A. | N.A. | N.A. | N.A. | N.A. | N.A. |
| (mg/cm²) | | | | | | | | | | | | | |
| Alkali | N.A. | N.A. | N.A. | N.A. | N.A. | N.A. | N.A. | N.A. | N.A. | N.A. | N.A. | N.A. | N.A. |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg/cm²) | | | | | | | | | | | | | |

TABLE 37

| | No. | No. | No. | No. | No. | No. | No. | No. | No. | No. | No. | No. | No. |
|---|---|---|---|---|---|---|---|---|---|---|---|---|---|
| Characteristic | 142 | 143 | 144 | 145 | 146 | 147 | 148 | 149 | 150 | 151 | 152 | 153 | 154 |
| ρ (g/cm³) | 2.385 | 2.395 | 2.377 | 2.379 | 2.371 | 2.373 | 2.383 | 2.396 | 2.364 | 2.374 | 2.356 | 2.383 | 2.391 |
| α_{30-380 °C} | 71 | 69 | 72 | 72 | 71 | 68 | 66 | 63 | 68 | 66 | 67 | 71 | 72 |
| (10⁻⁷/°C) | | | | | | | | | | | | | |
| Ts (°C) | 907 | 931 | 871 | 828 | 807 | 917 | 941 | 950 | 882 | 908 | 856 | 864 | 855 |
| 10^{2.5} dPa · s (°C) | 1,669 | 1,645 | 1,625 | 1,615 | 1,588 | 1,693 | 1,675 | 1,648 | 1,655 | 1,635 | 1,621 | 1,610 | 1,609 |
| E (GPa) | N.A. | N.A. | N.A. | N.A. | N.A. | N.A. | N.A. | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | N.A. | N.A. | N.A. | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. | N.A. | N.A. | N.A. |
| Acid resistance | N.A. | N.A. | N.A. | N.A. | N.A. | N.A. | N.A. | N.A. | N.A. | N.A. | N.A. | N.A. | N.A. |
| (mg/cm²) | | | | | | | | | | | | | |
| Alkali | N.A. | N.A. | N.A. | N.A. | N.A. | N.A. | N.A. | N.A. | N.A. | N.A. | N.A. | N.A. | N.A. |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg/cm²) | | | | | | | | | | | | | |

TABLE 38

| | No. | No. | No. | No. | No. | No. | No. | No. | No. | No. | No. | No. | No. |
|---|---|---|---|---|---|---|---|---|---|---|---|---|---|
| Characteristic | 1.55 | 156 | 157 | 158 | 159 | 1.60 | 161 | 162 | 163 | 1.64 | 165 | 166 | 167 |
| ρ (g/cm³) | 2.385 | 2.393 | N.A. | N.A. | N.A. | N.A. | N.A. | N.A. | N.A. | N.A. | N.A. | N.A. | N.A. |
| α_{30-380 °C} | 71 | 72 | N.A. | N.A. | N.A. | N.A. | N.A. | N.A. | N.A. | N.A. | N.A. | N.A. | N.A. |
| (10⁻⁷/°C) | | | | | | | | | | | | | |
| Ts (°C) | 831 | 816 | 835 | 855 | 875 | 865 | 833 | 845 | 863 | 828 | 836 | 834 | 850 |
| 10^{2.5} dPa · s (°C) | 1,606 | 1,601 | N.A. | N.A. | N.A. | N.A. | N.A. | N.A. | N.A. | N.A. | N.A. | N.A. | N.A. |
| E (GPa) | N.A. | N.A. | N.A. | N.A. | N.A. | N.A. | N.A. | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | N.A. | N.A. | N.A. | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. | N.A. | N.A. | N.A. |
| Acid resistance | N.A. | N.A. | N.A. | N.A. | N.A. | N.A. | N.A. | N.A. | N.A. | N.A. | N.A. | N.A. | N.A. |
| (mg/cm²) | | | | | | | | | | | | | |
| Alkali | N.A. | N.A. | N.A. | N.A. | N.A. | N.A. | N.A. | N.A. | N.A. | N.A. | N.A. | N.A. | N.A. |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg/cm²) | | | | | | | | | | | | | |

TABLE 39

| | No. | No. | No. | No. | No. | No. | No. | No. | No. | No. | No. | No. | No. |
|---|---|---|---|---|---|---|---|---|---|---|---|---|---|
| Characteristic | 168 | 169 | 170 | 171 | 172 | 173 | 174 | 175 | 176 | 177 | 178 | 179 | 180 |
| ρ (g/cm³) | N.A. | N.A. | N.A. | N.A. | N.A. | N.A. | N.A. | N.A. | N.A. | N.A. | N.A. | N.A. | N.A. |
| α_{30-380 °C} | N.A. | N.A. | N.A. | N.A. | N.A. | N.A. | N.A. | N.A. | N.A. | N.A. | N.A. | N.A. | N.A. |
| (10⁻⁷/°C) | | | | | | | | | | | | | |
| Ts (°C) | 847 | 837 | 744 | 748 | 757 | 786 | 796 | 833 | 845 | 863 | 828 | 820 | 817 |
| 10^{2.5} dPa · s (°C) | N.A. | N.A. | N.A. | N.A. | N.A. | N.A. | N.A. | N.A. | N.A. | N.A. | N.A. | N.A. | N.A. |
| E (GPa) | N.A. | N.A. | N.A. | N.A. | N.A. | N.A. | N.A. | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | N.A. | N.A. | N.A. | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. | N.A. | N.A. | N.A. |
| Acid resistance | N.A. | N.A. | N.A. | N.A. | N.A. | N.A. | N.A. | N.A. | N.A. | N.A. | N.A. | N.A. | N.A. |
| (mg/cm²) | | | | | | | | | | | | | |
| Alkali | N.A. | N.A. | N.A. | N.A. | N.A. | N.A. | N.A. | N.A. | N.A. | N.A. | N.A. | N.A. | N.A. |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg/cm²) | | | | | | | | | | | | | |

TABLE 40

| | No. | No. | No. | No. | No. | No. | No. | No. | No. | No. | No. | No. | No. |
|---|---|---|---|---|---|---|---|---|---|---|---|---|---|
| Characteristic | 181 | 182 | 183 | 184 | 185 | 186 | 187 | 188 | 189 | 190 | 191 | 192 | 193 |
| ρ (g/cm³) | N.A. | N.A. | N.A. | N.A. | N.A. | N.A. | N.A. | N.A. | N.A. | N.A. | N.A. | N.A. | N.A. |
| α_{30-380 °C} | N.A. | N.A. | N.A. | N.A. | N.A. | N.A. | N.A. | N.A. | N.A. | N.A. | N.A. | N.A. | N.A. |
| (10⁻⁷/°C) | | | | | | | | | | | | | |
| Ts (°C) | 814 | 810 | 807 | 790 | 784 | N.A. | N.A. | N.A. | N.A. | 824 | 824 | 826 | 836 |
| 10^{2.5} dPa · s (°C) | N.A. | N.A. | N.A. | N.A. | N.A. | N.A. | N.A. | N.A. | N.A. | N.A. | N.A. | N.A. | N.A. |
| E (GPa) | N.A. | N.A. | N.A. | N.A. | N.A. | N.A. | N.A. | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | N.A. | N.A. | N.A. | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. | N.A. | N.A. | N.A. |
| Acid resistance | N.A. | N.A. | N.A. | N.A. | N.A. | N.A. | N.A. | N.A. | N.A. | N.A. | N.A. | N.A. | N.A. |
| (mg/cm²) | | | | | | | | | | | | | |
| Alkali | N.A. | N.A. | N.A. | N.A. | N.A. | N.A. | N.A. | N.A. | N.A. | N.A. | N.A. | N.A. | N.A. |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg/cm²) | | | | | | | | | | | | | |

TABLE 41

| | No. | No. | No. | No. | No. | No. | No. | No. | No. | No. | No. | No. | No. |
|---|---|---|---|---|---|---|---|---|---|---|---|---|---|
| Characteristic | 194 | 195 | 196 | 197 | 198 | 199 | 200 | 201 | 202 | 203 | 204 | 205 | 206 |
| ρ (g/cm³) | N.A. | N.A. | N.A. | N.A. | N.A. | N.A. | N.A. | N.A. | N.A. | N.A. | N.A. | N.A. | N.A. |
| α_{30-380 °C} | N.A. | N.A. | N.A. | N.A. | N.A. | N.A. | N.A. | N.A. | N.A. | N.A. | N.A. | N.A. | N.A. |
| (10⁻⁷/°C) | | | | | | | | | | | | | |
| Ts (°C) | 834 | 850 | 847 | 837 | 813 | 806 | 803 | 789 | N.A. | N.A. | N.A. | N.A. | N.A. |
| 10^{2.5} dPa · s (°C) | N.A. | N.A. | N.A. | N.A. | N.A. | N.A. | N.A. | N.A. | N.A. | N.A. | N.A. | N.A. | N.A. |
| E (GPa) | N.A. | N.A. | N.A. | N.A. | N.A. | N.A. | N.A. | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | N.A. | N.A. | N.A. | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. | N.A. | N.A. | N.A. |
| Acid resistance | N.A. | N.A. | N.A. | N.A. | N.A. | N.A. | N.A. | N.A. | N.A. | N.A. | N.A. | N.A. | N.A. |
| (mg/cm²) | | | | | | | | | | | | | |
| Alkali | N.A. | N.A. | N.A. | N.A. | N.A. | N.A. | N.A. | N.A. | N.A. | N.A. | N.A. | N.A. | N.A. |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg/cm²) | | | | | | | | | | | | | |

TABLE 42

| | No. | No. | No. | No. | No. | No. | No. | No. | No. | No. | No. | No. | No. |
|---|---|---|---|---|---|---|---|---|---|---|---|---|---|
| Characteristic | 207 | 208 | 209 | 210 | 211 | 212 | 213 | 214 | 215 | 216 | 217 | 218 | 219 |
| ρ (g/cm³) | N.A. | N.A. | N.A. | N.A. | N.A. | N.A. | N.A. | N.A. | N.A. | N.A. | N.A. | N.A. | N.A. |
| α_{30-380 °C} | N.A. | N.A. | N.A. | N.A. | N.A. | N.A. | N.A. | N.A. | N.A. | N.A. | N.A. | N.A. | N.A. |
| (10⁻⁷/°C) | | | | | | | | | | | | | |
| Ts (°C) | N.A. | N.A. | N.A. | N.A. | 758 | 758 | 758 | 767 | 779 | 782 | 753 | 755 | 777 |
| 10^{2.5} dPa · s (°C) | N.A. | N.A. | N.A. | N.A. | N.A. | N.A. | N.A. | N.A. | N.A. | N.A. | N.A. | N.A. | N.A. |
| E (GPa) | N.A. | N.A. | N.A. | N.A. | N.A. | N.A. | N.A. | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | N.A. | N.A. | N.A. | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. | N.A. | N.A. | N.A. |
| Acid resistance | N.A. | N.A. | N.A. | N.A. | N.A. | N.A. | N.A. | N.A. | N.A. | N.A. | N.A. | N.A. | N.A. |
| (mg/cm²) | | | | | | | | | | | | | |
| Alkali | N.A. | N.A. | N.A. | N.A. | N.A. | N.A. | N.A. | N.A. | N.A. | N.A. | N.A. | N.A. | N.A. |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg/cm²) | | | | | | | | | | | | | |

TABLE 43

| | No. | No. | No. | No. | No. | No. | No. | No. | No. | No. | No. | No. | No. |
|---|---|---|---|---|---|---|---|---|---|---|---|---|---|
| Characteristic | 220 | 221 | 222 | 223 | 224 | 225 | 226 | 227 | 228 | 229 | 230 | 231 | 232 |
| ρ (g/cm³) | N.A. | N.A. | N.A. | N.A. | N.A. | N.A. | N.A. | N.A. | N.A. | N.A. | N.A. | N.A. | N.A. |
| α_{30-380 °C} | N.A. | N.A. | N.A. | N.A. | N.A. | N.A. | N.A. | N.A. | N.A. | N.A. | N.A. | N.A. | N.A. |
| (10⁻⁷/°C) | | | | | | | | | | | | | |
| Ts (°C) | 778 | 861 | N.A. | N.A. | N.A. | N.A. | 807 | 823 | 779 | 787 | 806 | 799 | 793 |
| 10^{2.5} dPa · s (°C) | N.A. | N.A. | N.A. | N.A. | N.A. | N.A. | N.A. | N.A. | N.A. | N.A. | N.A. | N.A. | N.A. |
| E (GPa) | N.A. | N.A. | N.A. | N.A. | N.A. | N.A. | N.A. | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | N.A. | N.A. | N.A. | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. | N.A. | N.A. | N.A. |
| Acid resistance | N.A. | N.A. | N.A. | N.A. | N.A. | N.A. | N.A. | N.A. | N.A. | N.A. | N.A. | N.A. | N.A. |
| (mg/cm²) | | | | | | | | | | | | | |
| Alkali | N.A. | N.A. | N.A. | N.A. | N.A. | N.A. | N.A. | N.A. | N.A. | N.A. | N.A. | N.A. | N.A. |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg/cm²) | | | | | | | | | | | | | |

TABLE 44

| | No. | No. | No. | No. | No. | No. | No. | No. | No. | No. | No. | No. | No. |
|---|---|---|---|---|---|---|---|---|---|---|---|---|---|
| Characteristic | 233 | 234 | 235 | 236 | 237 | 238 | 239 | 240 | 241 | 242 | 243 | 244 | 245 |
| ρ (g/cm³) | N.A. | N.A. | N.A. | N.A. | N.A. | N.A. | N.A. | N.A. | N.A. | N.A. | N.A. | N.A. | N.A. |
| α_{30-380 °C} | N.A. | N.A. | N.A. | N.A. | N.A. | N.A. | N.A. | N.A. | N.A. | N.A. | N.A. | N.A. | N.A. |
| (10⁻⁷/°C) | | | | | | | | | | | | | |
| Ts (°C) | 785 | N.A. | N.A. | N.A. | N.A. | N.A. | N.A. | N.A. | N.A. | N.A. | N.A. | N.A. | N.A. |
| 10^{2.5} dPa · s (°C) | N.A. | N.A. | N.A. | N.A. | N.A. | N.A. | N.A. | N.A. | N.A. | N.A. | N.A. | N.A. | N.A. |
| E (GPa) | N.A. | N.A. | N.A. | N.A. | N.A. | N.A. | N.A. | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | N.A. | N.A. | N.A. | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. | N.A. | N.A. | N.A. |
| Acid resistance | N.A. | N.A. | N.A. | N.A. | N.A. | N.A. | N.A. | N.A. | N.A. | N.A. | N.A. | N.A. | N.A. |
| (mg/cm²) | | | | | | | | | | | | | |
| Alkali | N.A. | N.A. | N.A. | N.A. | N.A. | N.A. | N.A. | N.A. | N.A. | N.A. | N.A. | N.A. | N.A. |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg/cm²) | | | | | | | | | | | | | |

TABLE 45

| | No. | No. | No. | No. | No. | No. | No. | No. | No. | No. | No. | No. | No. |
|---|---|---|---|---|---|---|---|---|---|---|---|---|---|
| Characteristic | 246 | 247 | 248 | 249 | 250 | 251 | 252 | 253 | 254 | 255 | 256 | 257 | 258 |
| ρ (g/cm³) | N.A. | N.A. | N.A. | N.A. | N.A. | N.A. | N.A. | N.A. | N.A. | N.A. | N.A. | N.A. | N.A. |
| α_{30-380 °C} | N.A. | N.A. | N.A. | N.A. | N.A. | N.A. | N.A. | N.A. | N.A. | N.A. | N.A. | N.A. | N.A. |
| (10⁻⁷/°C) | | | | | | | | | | | | | |
| Ts (°C) | N.A. | N.A. | N.A. | N.A. | N.A. | N.A. | N.A. | N.A. | N.A. | N.A. | N.A. | N.A. | 769 |
| 10^{2.5} dPa · s (°C) | N.A. | N.A. | N.A. | N.A. | N.A. | N.A. | N.A. | N.A. | N.A. | N.A. | N.A. | N.A. | N.A. |
| E (GPa) | N.A. | N.A. | N.A. | N.A. | N.A. | N.A. | N.A. | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | N.A. | N.A. | N.A. | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. | N.A. | N.A. | N.A. |
| Acid resistance | N.A. | N.A. | N.A. | N.A. | N.A. | N.A. | N.A. | N.A. | N.A. | N.A. | N.A. | N.A. | N.A. |
| (mg/cm²) | | | | | | | | | | | | | |
| Alkali | N.A. | N.A. | N.A. | N.A. | N.A. | N.A. | N.A. | N.A. | N.A. | N.A. | N.A. | N.A. | N.A. |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg/cm²) | | | | | | | | | | | | | |

TABLE 46

| | No. | No. | No. | No. | No. | No. | No. | No. | No. | No. | No. | No. | No. |
|---|---|---|---|---|---|---|---|---|---|---|---|---|---|
| Characteristic | 259 | 260 | 261 | 262 | 263 | 264 | 265 | 266 | 267 | 268 | 269 | 270 | 271 |
| ρ (g/cm³) | N.A. | N.A. | N.A. | N.A. | N.A. | N.A. | N.A. | N.A. | N.A. | N.A. | N.A. | N.A. | N.A. |
| α_{30-380 °C} | N.A. | N.A. | N.A. | N.A. | N.A. | N.A. | N.A. | N.A. | N.A. | N.A. | N.A. | N.A. | N.A. |
| (10⁻⁷/°C) | | | | | | | | | | | | | |
| Ts (°C) | 876 | 847 | 784 | 809 | 793 | N.A. | N.A. | N.A. | N.A. | N.A. | N.A. | N.A. | N.A. |
| 10^{2.5} dPa · s (°C) | N.A. | N.A. | N.A. | N.A. | N.A. | N.A. | N.A. | N.A. | N.A. | N.A. | N.A. | N.A. | N.A. |
| E (GPa) | N.A. | N.A. | N.A. | N.A. | N.A. | N.A. | N.A. | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | N.A. | N.A. | N.A. | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. | N.A. | N.A. | N.A. |
| Acid resistance | N.A. | N.A. | N.A. | N.A. | N.A. | N.A. | N.A. | N.A. | N.A. | N.A. | N.A. | N.A. | N.A. |
| (mg/cm²) | | | | | | | | | | | | | |
| Alkali | N.A. | N.A. | N.A. | N.A. | N.A. | N.A. | N.A. | N.A. | N.A. | N.A. | N.A. | N.A. | N.A. |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg/cm²) | | | | | | | | | | | | | |

TABLE 47

| | No. | No. | No. | No. | No. | No. | No. | No. | No. | No. | No. | No. | No. |
|---|---|---|---|---|---|---|---|---|---|---|---|---|---|
| Characteristic | 272 | 273 | 274 | 275 | 276 | 277 | 278 | 279 | 280 | 281 | 282 | 283 | 284 |
| ρ (g/cm³) | N.A. | N.A. | N.A. | N.A. | N.A. | N.A. | N.A. | N.A. | N.A. | N.A. | N.A. | N.A. | N.A. |
| α_{30-380 °C} | N.A. | N.A. | N.A. | N.A. | N.A. | N.A. | N.A. | N.A. | N.A. | N.A. | N.A. | N.A. | N.A. |
| (10⁻⁷/°C) | | | | | | | | | | | | | |
| Ts (°C) | 765 | 763 | 753 | 745 | N.A. | N.A. | N.A. | N.A. | N.A. | N.A. | N.A. | N.A. | N.A. |
| 10^{2.5} dPa · s (°C) | N.A. | N.A. | N.A. | N.A. | N.A. | N.A. | N.A. | N.A. | N.A. | N.A. | N.A. | N.A. | N.A. |
| E (GPa) | N.A. | N.A. | N.A. | N.A. | N.A. | N.A. | N.A. | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | N.A. | N.A. | N.A. | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. | N.A. | N.A. | N.A. |
| Acid resistance | N.A. | N.A. | N.A. | N.A. | N.A. | N.A. | N.A. | N.A. | N.A. | N.A. | N.A. | N.A. | N.A. |
| (mg/cm²) | | | | | | | | | | | | | |
| Alkali | N.A. | N.A. | N.A. | N.A. | N.A. | N.A. | N.A. | N.A. | N.A. | N.A. | N.A. | N.A. | N.A. |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg/cm²) | | | | | | | | | | | | | |

TABLE 48

| | No. | No. | No. | No. | No. | No. | No. | No. | No. | No. | No. | No. | No. |
|---|---|---|---|---|---|---|---|---|---|---|---|---|---|
| Characteristic | 285 | 286 | 287 | 288 | 289 | 290 | 291 | 292 | 293 | 294 | 295 | 296 | 297 |
| ρ (g/cm³) | N.A. | N.A. | N.A. | N.A. | N.A. | N.A. | N.A. | N.A. | N.A. | N.A. | N.A. | N.A. | N.A. |
| α_{30-380 °C} | N.A. | N.A. | N.A. | N.A. | N.A. | N.A. | N.A. | N.A. | N.A. | N.A. | N.A. | N.A. | N.A. |
| (10⁻⁷/°C) | | | | | | | | | | | | | |
| Ts (°C) | N.A. | N.A. | N.A. | N.A. | N.A. | 758 | 758 | 758 | 767 | 779 | 777 | N.A. | N.A. |
| 10^{2.5} dPa · s (°C) | N.A. | N.A. | N.A. | N.A. | N.A. | N.A. | N.A. | N.A. | N.A. | N.A. | N.A. | N.A. | N.A. |
| E (GPa) | N.A. | N.A. | N.A. | N.A. | N.A. | N.A. | N.A. | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. | N.A. | N.A. | N.A. |
| at 400 nm | | | | | | | | | | | | | |
| CS (MPa) | N.A. | N.A. | N.A. | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. | N.A. | N.A. | N.A. |
| Acid resistance | N.A. | N.A. | N.A. | N.A. | N.A. | N.A. | N.A. | N.A. | N.A. | N.A. | N.A. | N.A. | N.A. |
| (mg/cm²) | | | | | | | | | | | | | |
| Alkali | N.A. | N.A. | N.A. | N.A. | N.A. | N.A. | N.A. | N.A. | N.A. | N.A. | N.A. | N.A. | N.A. |
| resistance | | | | | | | | | | | | | |
| (mg/cm²) | | | | | | | | | | | | | |
| Hydrofluoric | N.A. | N.A. | N.A. | N.A. | N.A. | N.A. | N.A. | N.A. | N.A. | N.A. | N.A. | N.A. | N.A. |
| acid resistance | | | | | | | | | | | | | |
| (mg/cm²) | | | | | | | | | | | | | |

TABLE 49

| | No. | No. | No. | No. | No. | No. | No. | No. | No. | No. | No. | No. | No. |
|---|---|---|---|---|---|---|---|---|---|---|---|---|---|
| Characteristic | 298 | 299 | 300 | 301 | 302 | 303 | 304 | 305 | 306 | 307 | 308 | 309 | 310 |
| ρ (g/cm³) | N.A. | N.A. | N.A. | N.A. | N.A. | N.A. | 2.419 | N.A. | N.A. | N.A. | N.A. | N.A. | N.A. |
| α_{30-380 °C} | N.A. | N.A. | N.A. | N.A. | N.A. | N.A. | 74.7 | N.A. | N.A. | N.A. | N.A. | N.A. | N.A. |
| (10⁻⁷/°C) | | | | | | | | | | | | | |
| Ts (°C) | N.A. | 753 | 744 | 748 | 757 | 786 | 796 | 833 | 845 | 863 | 828 | 820 | 817 |
| 10^{2.5} dPa · s (°C) | N.A. | N.A. | N.A. | N.A. | N.A. | N.A. | 1,596 | N.A. | N.A. | N.A. | N.A. | N.A. | N.A. |
| E (GPa) | N.A. | N.A. | N.A. | N.A. | N.A. | N.A. | 75.5 | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. | N.A. | N.A. | N.A. |
| Transmittance | N.A. | N.A. | N.A. | N.A. | N.A. | N.A. | 91.3 | N.A. | N.A. | N.A. | N.A. | N.A. | N.A. |
| at 400 nm | | | | | | | | | | | | | |
| CS (MPa) | N.A. | N.A. | N.A. | N.A. | N.A. | N.A. | 590 | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | 10 | N.A. | N.A. | N.A. | N.A. | N.A. | N.A. |
| CT_{CV} (MPa) | N.A. | N.A. | N.A. | N.A. | N.A. | N.A. | 9 | N.A. | N.A. | N.A. | N.A. | N.A. | N.A. |
| Acid resistance | N.A. | N.A. | N.A. | N.A. | N.A. | N.A. | 0.01 | N.A. | N.A. | N.A. | N.A. | N.A. | N.A. |
| (mg/cm²) | | | | | | | | | | | | | |
| Alkali | N.A. | N.A. | N.A. | N.A. | N.A. | N.A. | 0.25 | N.A. | N.A. | N.A. | N.A. | N.A. | N.A. |
| resistance | | | | | | | | | | | | | |
| (mg/cm²) | | | | | | | | | | | | | |
| Hydrofluoric | N.A. | N.A. | N.A. | N.A. | N.A. | N.A. | 2.8 | N.A. | N.A. | N.A. | N.A. | N.A. | N.A. |
| acid resistance | | | | | | | | | | | | | |
| (mg/cm²) | | | | | | | | | | | | | |

TABLE 50

| | No. | No. | No. | No. | No. | No. | No. | No. | No. | No. |
|---|---|---|---|---|---|---|---|---|---|---|
| Characteristic | 311 | 312 | 313 | 314 | 315 | 316 | 317 | 318 | 319 | 320 |
| ρ (g/cm³) | N.A. | N.A. | N.A. | N.A. | N.A. | N.A. | N.A. | N.A. | N.A. | N.A. |
| α_{30-380 °C} | N.A. | N.A. | N.A. | N.A. | N.A. | N.A. | N.A. | N.A. | N.A. | N.A. |
| (10⁻⁷/°C) | | | | | | | | | | |
| Ts (°C) | 814 | 810 | 807 | 790 | 784 | N.A. | N.A. | N.A. | 812 | 814 |
| 10^{2.5} dPa · s (°C) | N.A. | N.A. | N.A. | N.A. | N.A. | N.A. | N.A. | N.A. | N.A. | N.A. |
| E (GPa) | N.A. | N.A. | N.A. | N.A. | N.A. | N.A. | N.A. | N.A. | N.A. | N.A. |
| Klc (MPa · m^{0.5}) | N.A. | N.A. | N.A. | N.A. | N.A. | N.A. | N.A. | N.A. | N.A. | N.A. |
| Transmittance | N.A. | N.A. | N.A. | N.A. | N.A. | N.A. | N.A. | N.A. | N.A. | N.A. |
| at 400 nm | | | | | | | | | | |
| CS (MPa) | N.A. | N.A. | N.A. | N.A. | N.A. | N.A. | N.A. | N.A. | N.A. | N.A. |
| CS30 (MPa) | N.A. | N.A. | N.A. | N.A. | N.A. | N.A. | N.A. | N.A. | N.A. | N.A. |
| DOC (μm) | N.A. | N.A. | N.A. | N.A. | N.A. | N.A. | N.A. | N.A. | N.A. | N.A. |
| CT_{CV} (MPa) | N.A. | N.A. | N.A. | N.A. | N.A. | N.A. | N.A. | N.A. | N.A. | N.A. |
| Acid resistance | N.A. | N.A. | N.A. | N.A. | N.A. | N.A. | N.A. | N.A. | N.A. | N.A. |
| (mg/cm²) | | | | | | | | | | |
| Alkali | N.A. | N.A. | N.A. | N.A. | N.A. | N.A. | N.A. | N.A. | N.A. | N.A. |
| resistance | | | | | | | | | | |
| (mg/cm²) | | | | | | | | | | |
| Hydrofluoric | N.A. | N.A. | N.A. | N.A. | N.A. | N.A. | N.A. | N.A. | N.A. | N.A. |
| acid resistance | | | | | | | | | | |
| (mg/cm²) | | | | | | | | | | |

Samples Nos. 1 to 320 shown in Tables 1 to 50 were each produced as described below. First, glass raw materials were blended so as to give each of glass compositions of Samples Nos. 1 to 320 shown in Tables 1 to 25, and were melted at 1,600° C. for 21 hours with a platinum pot. Subsequently, the resultant molten glass was poured out on a carbon sheet to be formed into a flat sheet shape, and was then cooled in a temperature region of from an annealing point to a strain point at a rate of 3° C./min. Thus, a glass sheet (glass sheet to be tempered) was obtained. The resultant glass sheet was evaluated for various characteristics shown in Tables 26 to 50.

The density (ρ) is a value measured by a well-known Archimedes method.

The thermal expansion coefficient (α_{30-380° C.}) at from 30° C. to 380° C. is a value measured for an average thermal expansion coefficient with a dilatometer.

The softening point (Ts) is a value measured based on a method of ASTM C338.

The temperature (10^{2.5} dPa·s) at a viscosity at high temperature of 10^{2.5} dPa·s is a value measured by a platinum sphere pull up method.

The Young's modulus (E) is a value calculated by a method in conformity with JIS R 1602-1995 “Testing methods for elastic modulus of fine ceramics.”

Subsequently, each of Samples Nos. 1 to 24 and 26 to 320 was subjected to optical polishing on both surfaces so as to give a sheet thickness of 0.6 mm, and then the transmittance thereof was measured.

The transmittance at a wavelength of 400 nm is a value obtained by measuring a linear transmittance in a thickness direction of a tempered glass sheet having a thickness of 0.6 mm with a UV-Visible/NIR spectrophotometer (UH4150, manufactured by Hitachi High-Tech Science Corporation).

Further, each of the resultant glass sheets to be tempered of Samples Nos. 1 to 24 was immersed in a NaNO₃ molten salt at 380° C. for 1 hour to perform ion exchange treatment. After the ion exchange treatment, surfaces of each sample were washed. Subsequently, the compressive stress value (CS) on the outermost surface, the compressive stress value (CS30) at a depth of 30 μm therefrom, the depth of compression (DOC), and the internal tensile stress value (CT_{CV}) were calculated from a retardation distribution curve observed with a scattered light photoelastic stress meter SLP-2000 (manufactured by Orihara Industrial Co., Ltd.). Herein, the “DOC” is a depth at which the stress value becomes zero. In addition, each of the resultant glass sheets to be tempered of Samples Nos. 26 to 320 was immersed in a KNO₃ molten salt at 380° C. for 4 hours to perform ion exchange treatment. After the ion exchange treatment, surfaces of each sample were washed. Subsequently, the compressive stress value (CS) on the outermost surface, the compressive stress value (CS30) at a depth of 30 μm therefrom, the depth of compression (DOC), and the internal tensile stress value (CT_{CV}) were calculated from a retardation distribution curve observed with a surface stress meter FSM-6000 (manufactured by Orihara Industrial Co., Ltd.). Herein, the “DOC” is a depth at which the stress value becomes zero. In the calculation, a refractive index of 1.53 and a photoelastic constant of 29.0 [(nm/cm)/MPa] were used for each sample. Before and after the ion exchange treatment, the glass composition in a surface layer of the glass differs microscopically, but the glass composition of the glass as a whole is substantially the same.

In addition, Sample No. 25 was subjected to optical polishing on both surfaces so as to give a sheet thickness of 0.6 mm, and was then subjected to heat treatment at 615° C. for 12 hours and at 850° C. for 3 hours, to thereby precipitate crystals to form crystallized glass. The resultant crystallized glass was measured for the Young's modulus and the transmittance under the above-mentioned conditions. Then, the crystallized glass was immersed in a NaNO₃ a molten salt at 430° C. for 6 hours to perform ion exchange treatment. After the ion exchange treatment, surfaces of the sample were washed.

Each of the tempered glass sheets of Samples Nos. 1 to 320 thus obtained was evaluated for the acid resistance, the alkali resistance, the hydrofluoric acid resistance, and the fracture toughness value (K1c).

In an acid resistance test, the acid resistance was evaluated as described below. A glass sample having been subjected to mirror polishing treatment on both surfaces so as to give dimensions of 50 mm×10 mm×1.0 mm was used as a measurement sample. The sample was sufficiently washed with a neutral detergent and pure water, and was then immersed in a 5 mass' HCl aqueous solution warmed to 80° C. for 24 hours, and a mass loss (mg/cm²) per unit surface area before and after the immersion was calculated.

In an alkali resistance test, the alkali resistance was evaluated as described below. A glass sample having been subjected to mirror polishing treatment on both surfaces so as to give dimensions of 50 mm×10 mm×1.0 mm was used as a measurement sample. The sample was sufficiently washed with a neutral detergent and pure water, and was then immersed in a 5 mass' NaOH aqueous solution warmed to 80° C. for 6 hours, and a mass loss (mg/cm²) per unit surface area before and after the immersion was calculated.

In a hydrofluoric acid resistance test, the hydrofluoric acid resistance was evaluated as described below. A glass sample having been subjected to mirror polishing treatment on both surfaces so as to give dimensions of 50 mm×10 mm×1.0 mm was used as a measurement sample. The sample was sufficiently washed with a neutral detergent and pure water, and was then immersed in a 10 mass % HF aqueous solution held at 20° C. for 20 minutes, and a mass loss (mg/cm²) per unit surface area before and after the immersion was calculated.

The fracture toughness value (K1c) is a value measured by a SEPB method based on JIS R 1607 “Testing methods for fracture toughness of fine ceramics.” The fracture toughness value of each sample was determined as an average for 3 points.

As apparent from Tables 1 to 30, each of Samples Nos. 1 to 23 and 26 to 65 had a high Young's modulus, in particular, Sample No. 1 had a fracture toughness value of 0.82 MPa·m^{0.5}, and thus glass having high mechanical characteristics was obtained. Meanwhile, Sample No. 24 serving as Comparative Example had a low RO content, and thus had a low Young's modulus of 74 GPa and a low fracture toughness value of 0.76 MPa·m^{0.5}. In addition, each of Samples Nos. 1 to 23 had a high transmittance of 91.2% or more. Meanwhile, Sample No. 25, which was a crystallized tempered glass sheet, had a low transmittance of 72.5% after the crystallization.

### Example 2

Table 51 shows the glass characteristics of the tempered glass sheets of Example A of the present invention and Comparative Example B. Herein, “SPP-4PB” represents abraded four-point bending strength, and “N.A.” means not applicable.

TABLE 51

| Example | A | B |
|---|---|---|
| Composition | No. 1 | No. 24 |
| E (GPa) | 87 | 74 |
| K1c (MPa · m^{0.5}) | 0.82 | 0.76 |
| CS (MPa) | 425 | 830 |
| CS30 (MPa) | 244 | 120 |
| DOC (μm) | 89 | 130 |
| CT_{CV} (MPa) | 90 | N.A. |
| SPP-4PB (MPa) | 290 | 172 |

The tempered glass sheets of Example A and Comparative Example B shown in Table 51 were each produced as described below. First, glass raw materials were blended so as to give each of glass compositions of Samples Nos. 1 and 24 shown in Tables 1 and 2, and were melted at 1,600° C. for 21 hours with a platinum pot. Then, the resultant molten glass was poured out on a carbon sheet to be formed into a flat sheet shape, and was then annealed. The resultant glass sheet was evaluated for the Young's modulus by the same method as in Example 1. Then, the resultant flat sheet-shaped glass was subjected to grinding and polishing so as to give a glass sheet to be tempered having a thickness of 0.6 mm. Next, the resultant glass sheet to be tempered was cut into a predetermined size. Further, the glass sheet to be tempered of Example A was immersed in a mixed molten salt including 15 mass % of NaNO₃ and 85 mass % of KNO₃ at 430° C. for 1 hour to perform ion exchange treatment so as to give a tempered glass sheet. In addition, the glass sheet to be tempered of Comparative Example B was immersed in a NaNO₃ molten salt at 380° C. for 3 hours to perform ion exchange treatment, and was then immersed in a mixed molten salt including 95 mass % of KNO₃ and 5 mass % of NaNO₃ at 380° C. for 45 minutes to perform ion exchange treatment so as to give a tempered glass sheet.

Each of the resultant tempered glass sheets was measured for the fracture toughness value and the abraded four-point bending strength.

The fracture toughness value (K1c) was evaluated by the same method as in Example 1.

The abraded four-point bending strength was measured by the following procedure. First, the glass was abraded by the following procedure. The tempered glass sheet having been processed into a size of 35 mm×35 mm and a thickness of 0.6 mm was fixed to a SUS plate having a thickness of 1.5 mm under a state in which the tempered glass sheet was turned vertically, and the tip of a pendular arm was caused to collide with the glass sheet through P180 grid sandpaper to abrade the glass sheet. The tip of the arm is an iron-made cylinder of φ5 mm, and the arm has a weight of 550 g. The height from which the arm was swung down was set to 100 mm from a collision point. Next, the abraded sample was measured for the “abraded four-point bending strength” by being subjected to a four-point bending test according to JIS R 1601 (1995). The test was performed on six sheets for each Example, and an average of measured values thereof was used as an evaluation result.

As apparent from Table 51, the tempered glass sheet of Example A had high mechanical characteristics, that is, a Young's modulus of 87 GPa and a fracture toughness value of 0.82 MPa·m^{0.5}. The tempered glass sheet of Example A also had a high compressive stress value (CS30) at a depth of 30 μm from the outermost surface of the compressive stress layer of 244 MPa, and thus the high abraded four-point bending strength was as high as 290 MPa. Meanwhile, the tempered glass sheet of Comparative Example B had a Young's modulus of 74 GPa and a fracture toughness value of 0.76 MPa·m^{0.5}, which were lower than those of the tempered glass sheet of Example A. The tempered glass sheet of Comparative Example B also had a low CS30 of 120 MPa, and thus the abraded four-point bending strength was as low as 172 MPa.

### Example 3

Glass raw materials were blended so as to give each of glass compositions of Samples Nos. 73 and 304 shown in the tables, and were melted at 1,600° C. for 21 hours with a platinum pot. Then, the resultant molten glass was poured out on a carbon sheet to be formed into a flat sheet shape, and was then annealed. The resultant flat sheet-shaped glass was subjected to grinding and polishing so as to give a glass sheet having a thickness of 0.3 mm, and then the glass sheet was subjected to slimming through an etching process with hydrofluoric acid to give a glass sheet to be tempered having a thickness of 31 μm. Next, the resultant glass sheet to be tempered was cut into a size of 50 mm×50 mm. Further, the glass sheet to be tempered of Sample No. 73 was immersed in a KNO₃ molten salt at 380° C. for 1 hour and 10 minutes to perform ion exchange treatment so as to give a tempered glass sheet. In addition, the glass sheet to be tempered of Sample No. 304 was immersed in a KNO₃ molten salt at 380° C. for 1 hour and 45 minutes to perform ion exchange treatment so as to give a tempered glass sheet. Further, the resultant tempered glass sheet was subjected to slimming through an etching process with hydrofluoric acid to give a measurement sample having a thickness of 30 μm. Sample No. 73 serving as a measurement sample had a compressive stress value of 698 MPa and a depth of the compressive stress layer of 5.5 μm, and Sample No. 304 serving as a measurement sample had a compressive stress value of 418 MPa and a depth of the compressive stress layer of 4.8 μm.

Each of the measurement samples was measured for the surface roughness and the impact resistance strength.

The surface roughness is an “arithmetical mean height” obtained by measurement with a white-light scanning interferometer (NewView 7300, manufactured by Zygo Corporation) and calculation in conformity with ISO 25178. Detailed measurement conditions are as described below.
Apparatus name: NewView 7300, manufactured by Zygo Corporation
Range of field of view: 73.55 μm by 55.16 μm
Objective lens: magnification of 50
Zoom lens: magnification of 2
Analysis software: MetroPro (manufactured by Zygo Corporation)
Shape correction: Plane (first order)
Filter type: Gauss Spline
Filter low wavelength (high pass): 13.8 μm
Filter high wavelength (low pass): 0.345 μm

The impact resistance strength was measured by the following impact resistance test. First, the resultant measurement sample (plan-view dimensions of 50 mm×50 mm) was placed on a stone surface plate, and the test was performed by dropping a tip of a colliding object having a spherical rod tip (a ballpoint pen: Orange EG0.7, manufactured by Bic Japan; a spherical diameter of a ballpoint tip of 0.7 mm and a total mass of 5.4 g) on a glass sample. In this case, the colliding object was dropped through an inner hole of a guide cylinder held perpendicularly to the glass sample so that the tip of the colliding object dropped perpendicularly thereto. The height of the tip of the colliding object before the dropping was adopted as a dropping height, and an initial value thereof was set to 1.0 cm for dropping. When the glass sample did not break by the dropping of the colliding object, the height was raised by 0.5 cm, and the colliding object was dropped again. In this way, the trial including raising of the dropping height and dropping of the colliding object was repeated until the glass sample broke, and a dropping height at which the glass sample broke was determined as a breaking height.

Sample No. 73 had a surface roughness of 0.24 nm and a breaking height of 10.5 cm. In addition, Sample No. 304 had a surface roughness of 0.31 nm and a breaking height of 10.7 cm.

### INDUSTRIAL APPLICABILITY

The tempered glass sheet of the present invention is suitable as a cover glass for a touch panel display of a cellular phone, a digital camera, a personal digital assistant (PDA), or the like. In addition, the tempered glass sheet of the present invention is expected to find applications for which high mechanical strength is required, for example, a window glass, a substrate for a magnetic disk, a substrate for a flat panel display, a substrate for a flexible display, a cover glass for a solar cell, a cover glass for a solid state image sensor, and a cover glass for an automobile, in addition to the above-mentioned applications.

1. A tempered glass sheet having a compressive stress layer in a surface thereof,
the tempered glass sheet comprising as a glass composition, in terms of mol %, 50% to 85% of SiO₂, 1% to 25% of Al₂O₃, 0% to 15% of B₂O₃, 0% to 20% of Li₂O, 0% to 25% of Na₂O, 0% to 20% of K₂O, 0% to 10% of ZnO, 0% to 15% of P₂O₅, 0% to 10% of ZrO₂, and 0% to 0.30% of SnO₂, having a value of [Li₂O]+[Na₂O] of from 1% to 30%, having a value of [Li₂O]+[MgO] of from 1% to 25%, and having a value of [MgO]+[CaO]+[SrO]+[BaO] of from 0.5% to 30%.

2. The tempered glass sheet according to claim 1, wherein the tempered glass sheet is a tempered glass sheet having a compressive stress layer in a surface thereof,
the tempered glass sheet comprising as a glass composition, in terms of mol %, 52% to 80% of SiO₂, 11.5% to 25% of Al₂O₃, 0% to 15% of B₂O₃, 7% to 20% of Li₂O, 0.5% to 25% of Na₂O, 0% to 20% of K₂O, 0% to 20% of MgO, 0% to 10% of CaO, 0% to 10% of SrO, 0% to 10% of BaO, 0% to 10% of ZnO, 0% to 15% of P₂O₅, 0% to 10% of ZrO₂, and 0% to 0.30% of SnO₂, and having a value of [MgO]+[CaO]+[SrO]+[BaO] of from 6.5% to 30%.

3. The tempered glass sheet according to claim 2, wherein the tempered glass sheet comprises MgO as the glass composition and has a content of MgO of from 6.5 mol % to 20 mol %.

4. The tempered glass sheet according to claim 1, wherein the tempered glass sheet has a molar ratio [RO]/[R₂O] of from 0.5 to 1.5.

5. The tempered glass sheet according to claim 1,
wherein the tempered glass sheet is substantially free of crystals and has a transmittance of 85% or more at a wavelength of 400 nm in terms of a thickness of 0.6 mm.

6. The tempered glass sheet according to claim 1, wherein the tempered glass sheet has a fracture toughness K1c of 0.78 MPa·m^{0.5} or more.

7. The tempered glass sheet according to claim 1, wherein the tempered glass sheet has a Young's modulus of 76 GPa or more.

8. The tempered glass sheet according to claim 1,
wherein the tempered glass sheet has a sheet shape having a thickness of from 0.01 mm to 2.0 mm,
wherein a compressive stress value CS of the compressive stress layer on an outermost surface is from 200 MPa to 1,200 MPa, and
wherein a depth of compression DOC of the compressive stress layer is from 3 m to 200 μm.

9. The tempered glass sheet according to claim 8,
wherein the tempered glass sheet has a sheet shape having a thickness of from 0.35 mm to 2.0 mm,
wherein the depth of compression DOC of the compressive stress layer is from 50 m to 170 μm, and
wherein a compressive stress value CS30 of the compressive stress layer at a depth of 30 μm from the outermost surface is from 25 MPa to 400 MPa.

10. The tempered glass sheet according to claim 1, wherein the tempered glass sheet has a temperature at a viscosity at high temperature of 10^{2.5} dPa·s of 1,680° C. or less.

11. The tempered glass sheet according to claim 1, wherein the tempered glass sheet comprises Cl as the glass composition and has a content of Cl of 0.02 mol % or more.

12. The tempered glass sheet according to claim 1, wherein the tempered glass sheet comprises MoO₃ as the glass composition and has a content of MoO₃ of 0.0001 mol % or more.

13. The tempered glass sheet according to claim 1, wherein the tempered glass sheet is a tempered glass sheet having a compressive stress layer in a surface thereof,
the tempered glass sheet comprising as a glass composition, in terms of mol %, 60% to 70% of SiO₂, 3% to 20% of Al₂O₃, 0% to 1% of B₂O₃, 0% to 10% of Li₂O, 10% to 25% of Na₂O, 0% to 5% of K₂O, 5% to 20% of MgO, 0% to 1% of CaO, 0% to 10% of SrO, 0% to 10% of BaO, 0% to 10% of ZnO, and 0% to 4.7% of P₂O₅, and having a value of [MgO]+[CaO]+[SrO]+[BaO] of from 5% to 30%.

14. The tempered glass sheet according to claim 1, wherein the tempered glass sheet is a tempered glass sheet having a compressive stress layer in a surface thereof,
the tempered glass sheet comprising as a glass composition, in terms of mol %, 65% to 82% of SiO₂, 5% to 16% of Al₂O₃, 0% to 10% of B₂O₃, 0% to 10% of Li₂O, 5% to 25% of Na₂O, 0% to 5% of K₂O, 0% to 10% of MgO, 0% to 6% of CaO, 0% to 5% of SrO, 0% to 5% of BaO, 0% to 10% of ZnO, and 0% to 4.7% of P₂O₅, having a value of [Li₂O]+[Na₂O] of from 5% to 20%, and having a value of [MgO]+[CaO]+[SrO]+[BaO] of from 1% to 10%.

15. A method of manufacturing a tempered glass sheet, comprising:
a preparation step of preparing a glass sheet to be tempered including as a glass composition, in terms of mol %, 50% to 85% of SiO₂, 1% to 25% of Al₂O₃, 0% to 15% of B₂O₃, 0% to 20% of Li₂O, 0% to 25% of Na₂O, 0% to 20% of K₂O, 0% to 10% of ZnO, 0% to 15% of P₂O₅, 0% to 10% of ZrO₂, and 0% to 0.30% of SnO₂, having a value of [Li₂O]+[Na₂O] of from 1% to 30%, having a value of [Li₂O]+[MgO] of from 1% to 25%, and having a value of [MgO]+[CaO]+[SrO]+[BaO] of from 0.5% to 30%; and
an ion exchange step of subjecting the glass sheet to be tempered to ion exchange treatment to provide a tempered glass sheet having a compressive stress layer in a surface thereof.

16. A glass sheet to be tempered, comprising as a glass composition, in terms of mol %, 50% to 85% of SiO₂, 1% to 25% of Al₂O₃, 0% to 15% of B₂O₃, 0% to 20% of Li₂O, 0% to 25% of Na₂O, 0% to 20% of K₂O, 0% to 10% of ZnO, 0% to 15% of P₂O₅, 0% to 10% of ZrO₂, and 0% to 0.30% of SnO₂, having a value of [Li₂O]+[Na₂O] of from 1% to 30%, having a value of [Li₂O]+[MgO] of from 1% to 25%, and having a value of [MgO]+[CaO]+[SrO]+[BaO] of from 0.5% to 30%.
